(19) United States
(12) Patent Application Publication
(10) Pub. No.: US 2024/0117647 A1
(43) Pub. Date: Apr. 11, 2024

(54) GAZEBO

(71) Applicant: Zhenjiang Zhengte Co., Ltd., Linhai (CN)

(72) Inventor: Patrick van Lierop, Linhai (CN)

(21) Appl. No.: 18/211,060

(22) Filed: Jun. 16, 2023

Related U.S. Application Data
(60) Provisional application No. 63/353,502, filed on Jun. 17, 2022.

(51) Int. Cl. E04H 1/12; E04D 13/04; E04F 10/10

(52) U.S. Cl. CPC E04H 1/12; E04D 13/04; E04F 10/10

(57) ABSTRACT

Disclosed are example embodiments of an improved gazebo. The gazebo can be a louvered gazebo. The gazebo can comprise a gutter-beam system, a louver-slat system(s), a control system, and a multi-angle-allowing-coupling-post post-leveling base system. The gazebo can include one or more of the following: side gutter beams, end gutter beams, gutters, securing bars, reversible spacers, securing screws, louver slats, louver-slat-rotation receiving holes, cradle axels, and open cradles, to name a few. The gazebo can be economical to produce, easy to ship, and easily and quickly assembled.

### RELATED APPLICATION

This application claims priority to U.S. Provisional Application No. 63/353,502, filed Jun. 17, 2022, which is herein expressly incorporated by reference in its entirety for all purposes. The application is related to U.S. Pat. No. 10,851,544 “Multi-function wind-directing leaf-separating-and-discharging rainwater-sealing automatic-multi-screen-raising-and-lowering multi-screen-securing fruit-drying-and-sorting truck-tonneau-covering rainwater-channeling-and-collecting leaf-filtering height-and-angle-adjustable louvered pergola” filed Jan. 7, 2020, and assigned to the assignee hereof and hereby expressly incorporated by reference herein.

### BACKGROUND

The present disclosure relates generally to gazebo systems. More particularly, the present disclosure related to gazebo systems comprising a louvered gazebo.

Traditional gazebo systems suffer from several drawbacks. For example, traditional gazebo systems are not configured to be robot-assembled so as to save production time and costs. In particular, no prior louvered gazebos have robot-assembled gutter-beam reversible spacers. Therefore, the prior louvered gazebos are not capable of connecting multiple robot-assembled gazebo. Indeed, gazebo systems are not configured to connect one or more gazebos to one another.

As such, prior louvered gazebos are not capable of connecting multiple robot-assembled gazebos in a straight line, perpendicular configuration, or in a cluster formation.

Gazebo systems comprising a louvered gazebo fail to provide a means to connect the louvered gazebo to other gazebos at multiple angles. Additionally, the louvered gazebos do not have side gutter beams or end gutter beams that drain and channel rainwater passing therethrough and provide horizontal support for adjacently connected gazebos. Moreover, traditional louvered gazebos are not capable of providing horizontal support for connecting multiple gazebos to one another.

Prior louvered gazebos are not capable of hiding gutters that channel and/or drain rainwater. Louvered gazebos are not capable of supporting a louver-slat system that allows for automatic lowering and/or raising of an awning attached to the gazebo.

Further, traditional louvered gazebos are not capable of providing horizontal support between two corner posts. Traditional louvered gazebos do not have a multi-louver-slat-control bar. Traditional louvered gazebos are not capable of allowing robot-assembled louver slats that can automatically raise and/or lower awnings to be controlled so as to transition the louver slats simultaneously between an open and closed configuration. In particular, louvered gazebos are not capable of allowing robot-assembled louver slats to be simultaneously closed to protect from weather conditions. Additionally, louvered gazebos are not capable of allowing robot-assembled louver slats to be simultaneously opened and closed so as to direct and/or redirect wind-flow. Louvered gazebos are not capable of allowing robot-assembled louver slats to be simultaneously opened and/or closed to deploy and/or retract an awning.

Traditional louvered gazebos do not have double-wide multi-gazebo-connecting multi-angle-allowing coupling posts. In this regard, traditional louvered gazebos are not capable of connecting two or more robot-assembled gazebos in multiple configurations.

Traditional louvered gazebos do not have sleeve screws which allow the gazebo's height and angle to be adjusted. Therefore, the prior louvered gazebos are not capable of leveling robot-assembled gazebos when on an uneven or slanted surface. Traditional louvered gazebos are not capable of providing a means to interactively level the gazebo(s) once the gazebo(s) are deployed.

### SUMMARY

Provided herein are example embodiments of a gazebo system and device configured to be robotically assembled. The gazebo is capable of directing wind-flow, and channeling and/or draining rainwater. The gazebo and the components thereof can each be robot-assembled. The gazebo can comprise one or more projector screens that can raise and/or lower in an automatic fashion. In some embodiments, the gazebo is configured to deploy and/or retract an awning.

In some embodiments, the gazebo can deploy and/or retract the awning in an automatic fashion. The gazebo system described herein is configured for use in all seasons. In some embodiments, the gazebo comprises one or more side gutter beams and/or one or more end gutter beams. The gutter beams can include a plurality of securing bars. Further, the gutter beams can include a plurality of reversible spacers. In some embodiments, the reversible spacers can be configured to adjust the angles of the gutter beams. In some embodiments, a plurality of securing screws can be inserted through reversible spacers. The securing screws can be robot-assembled onto the reversible spacers.

Specifically, the gazebo can include a plurality of louver slats which are configured to deploy and/or retract the awning. The louver slats are configured to channel and/or drain the rainwater, and direct and/or redirect the wind. In some embodiments, a plurality of end caps are secured onto the louver slats. Further, a plurality of insertion axels can be inserted into the louver slats for support.

In some embodiments, the gutter beam is secured to one or more of the following: a plurality of louver-slat rotation receiving holes, a plurality of louver-slat rotation cradle axels, and a plurality of louver-slat-rotation open cradles. Specifically, a plurality of louver-slat-rotation-cradle caps are secured to open cradles. The louver-slat rotation cradle axels are rotatably attached between the louver-slat-rotation open cradles and louver-slat-rotation-cradle caps. In some embodiments, the gutter beams are also secured to a plurality of louver-slat-rotation closed cradles comprising louver-slat rotation receiving holes. In some embodiments, a plurality of multi-louver-slat-control axels are secured to the louver slats.

Further, a plurality of multi-louver-slat-control-axel cotter-pin holes can be drilled into the multi-louver-slat-control axels. In some embodiments, a plurality of multi-louver-slat-control-bar axel-insertion holes are drilled into the multi-louver-slat-control bar, wherein the multi-louver-slat-control axels are rotatably inserted into said multi-louver-slat-control-bar axel-insertion holes. Specifically, a multi-louver-slat-control first linkage arm is rotatably secured to the louver slats. More specifically, a multi-louver-slat-control second linkage arm is rotatably secured to said multi-louver-slat-control first linkage arm. Even more specifically, a linkage-arm gear is secured to said multi-louver-slat-control second linkage arm and a worm gear is secured to said linkage-arm gear. Further, a worm-gear axel is rotatably secured to said worm gear. In some embodiments, a multi-louver-slat-control adjustable coupling ring is secured to said worm-gear axel. In some embodiments, the multi-louver-slat-control adjustable coupling ring is removably hooked to a crank tool. The crank tool is configured to be stowable, removable, and raise and/or lower multiple screens. Further the crank tool can deploy and/or retract awning(s), e.g., automatically.

In some embodiments, a plurality of double-wide multi-gazebo-connecting multi-angle-allowing coupling posts are secured to the side gutter beams. Further, a plurality of T-shaped coupling-post caps are secured to said coupling posts. A plurality of corner posts are secured to the side gutter beams and/or end gutter beams. Further, a plurality of L-shaped corner-post caps are secured to said corner posts. In some embodiments, a plurality of gutter-beam coupling caps are secured between at least two side gutter beams or at least two end gutter beams. In some embodiments, a plurality of gutter-beam-securing-bar receivers slidably surround said multi-louver-slat-control bar. Further, a plurality of coupling-post base-plate covers can be slidably installed around said coupling posts.

In some embodiments, a plurality of coupling-post base-plates can be secured to said coupling posts. A plurality of discrete rainwater drains can be formed into said corner post. Moreover, the gazebo can comprise a plurality of sleeve screws so as to allow the height and/or angle of the gazebo to be adjusted. The sleeve screws can be internally and externally threaded. The sleeve screws are threadedly inserted into said coupling-post base-plates, or said corner post. Further, a plurality of sleeve-screw holes allow the height and/or angle of the gazebo to be adjusted, and are internally and externally threaded. The sleeve-screw holes are drilled into said coupling-post base-plates, or said corner post. In some embodiments, a plurality of anchoring-screw holes are formed into said sleeve screws. Further, a plurality of anchoring screws can be threadedly inserted into said anchoring-screw holes.

Other gazebo systems, apparatuses, methods, features and advantages of the subject matter described herein will be or will become apparent to one with skill in the art upon examination of the following figures and detailed description. It is intended that all such additional systems, apparatuses, methods, features, and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 is a top cross-sectional view of an exemplar embodiment of the gutter beam system.

FIG. 2 is a top cross-sectional view of an exemplar embodiment of the gutter beam system.

FIG. 3 is top cross-sectional view of an exemplar embodiment of the gutter beam system.

FIG. 4 is a top cross-sectional view of an exemplar embodiment of the gutter beam system.

FIG. 5 is a top cross-sectional view of an exemplar embodiment of the gutter beam system.

FIG. 6 is a top view of an exemplar embodiment of multiple gazebos connected to one another.

FIG. 7 is a top view of an exemplar embodiment of multiple gazebos connected to one another.

FIG. 8 is a top view of an exemplar embodiment of an exemplar embodiment of multiple gazebos connected to one another.

FIG. 9 is a top view of an exemplar embodiment of multiple gazebos connected to one another.

FIG. 10 is a top view of an exemplar embodiment of multiple gazebos connected to one another.

FIG. 11 is a top view of an exemplar embodiment of multiple gazebos connected to one another, further illustrating the post-leveling base system(s).

FIG. 12 is a top view of an exemplar embodiment of multiple gazebos connected to one another, further illustrating the post-leveling base system(s).

FIG. 13 is a side view demonstrating how the louver-slat system(s) can expand and contract a cord by opening and closing the louver slats.

FIG. 14 is a side view demonstrating how the louver-slat system(s) can expand and contract a cord by opening and closing the louver slats.

FIG. 15 is a side view demonstrating how leading edges can secure multiple projector screens.

FIG. 16 is a perspective view demonstrating how a projector screen can be deployed.

FIG. 17 is a perspective view demonstrating how multiple projector screens can be deployed.

FIG. 18 is a perspective view demonstrating how an awning can be deployed.

FIG. 19 is a perspective view demonstrating how an awning can be retracted.

FIG. 20 is a perspective view demonstrating how the louver-slat system(s) can be closed.

FIG. 21 is a perspective view demonstrating the louver-slat system(s) can be opened.

FIG. 22 is a perspective view demonstrating how the louver-slat system(s) or its components thereof can be robotically assembled.

FIG. 23 is a perspective view demonstrating how the gutter-beam system(s) 101 can be robotically assembled.

FIG. 24 is a side cross-sectional view illustrating the securing screws 108 causing threads to heat and expand, the subsequently cool and lock when robotically installed.

FIG. 25 is a side cross-sectional view of the securing screws 108 causing the tip to expand and lock when robotically installed.

FIG. 26 is a side view demonstrating how the louver-slat system(s) can direct wind when installed in opposing configuration.

FIG. 27 is a side view the louver-slat system(s) can direct wind when installed in opposing configuration.

FIG. 28 is a side view demonstrating the louver-slat system(s) can redirect wind when installed in opposing configuration.

FIG. 29 is a side view demonstrating how the louver-slat system(s) can redirect wind when installed in opposing configuration.

FIG. 30 is a diagram a side view demonstrating how the louver-slat system(s) can direct wind.

FIG. 31 is a side view demonstrating how the louver-slat system(s) can direct wind when connected together.

FIG. 32 is a perspective view demonstrating how a slidable retractable door can be installed.

FIG. 33 is a perspective view demonstrating how a louvered wall can be installed.

FIG. 34 is a perspective view of cranking mechanism assembly.

FIG. 35 is a perspective view of cranking mechanism assembly.

FIG. 36 is a perspective view of an exemplar embodiment of a coupling ring.

FIG. 37 is a perspective view of an exemplar embodiment of a worm gear.

FIG. 38 is a perspective view of an exemplar embodiment of a linkage-arm gear.

FIG. 39 is a perspective view of linkage component.

FIG. 40 is a perspective view of an exemplar embodiment of a multi-louver-slat-control first linkage arm.

FIG. 41 is a perspective view of an exemplar embodiment of a multi-louver-slat-control second linkage arm.

FIG. 42 is a perspective view of an exemplar embodiment of a cranking mechanism housing.

FIG. 43 is a perspective view of an exemplar embodiment of a cranking mechanism housing.

FIG. 44 is a perspective view of an exemplar embodiment of a control system(s).

FIG. 45 is a perspective view of an exemplar embodiment of a control system(s).

FIG. 46 is a perspective view of an exemplar embodiment of coupling posts.

FIG. 47 is a close-up perspective view of an exemplar embodiment of coupling posts.

FIG. 48 is a top view of an exemplar embodiment of coupling posts.

FIG. 49 is a perspective view of an exemplar embodiment of corner posts.

FIG. 50 is a close-up perspective view of an exemplar embodiment of corner posts.

FIG. 51 is a perspective view of an exemplar embodiment of a center post.

FIG. 52 is a top view of an exemplar embodiment of center posts and corner posts.

FIG. 53 is a close-up perspective view of an exemplar embodiment of a center post.

FIG. 54 is a perspective view of an exemplar embodiment of a center post, illustrating the center-and-corner-post base-plate cover installed thereon.

FIG. 55 is a close-up perspective view of an exemplar embodiment of a center post and center-and-corner-post base-plate cover.

FIG. 56 is a perspective view of an exemplar embodiment of gutter-beam coupling caps.

FIG. 57 is a perspective view of an exemplar embodiment of a center-post cap.

FIG. 58 is a perspective view of an exemplar embodiment of an L-shaped corner-post cap.

FIG. 59 is a perspective view of an exemplar embodiment of a T-shaped coupling-post cap.

FIG. 60 is a perspective view of an exemplar embodiment of a coupling-post base-plate cover.

FIG. 61 is a perspective view of an exemplar embodiment of a center-and-corner-post base-plate cover.

FIG. 62 is a perspective view of an exemplar embodiment of a coupling-post base-plate.

FIG. 63 is a perspective view of an exemplar embodiment of a corner-and-central-post base plate.

FIG. 64 is a perspective view of an exemplar embodiment of a gutter-beam-securing bar.

FIG. 65A is a perspective view of an exemplar embodiment of a louver-slat-rotation open cradle.

FIG. 65B is a perspective view of an exemplar embodiment of a louver-slat-rotation-cradle cap.

FIG. 66 is a perspective view of an exemplar embodiment of optional battery compartment cover.

FIG. 67 is a perspective view of an exemplar embodiment of optional battery compartment housing.

FIG. 68 is a perspective view of an exemplar embodiment of a louver-slat end cap.

FIG. 69 is a side view of an exemplar embodiment of a louver-slat end cap.

FIG. 70 is a perspective view of an exemplar embodiment of louver slats.

FIG. 71 is a perspective view of an exemplar embodiment of louver slats of the louver-slat system.

FIG. 72 is a perspective view an exemplar embodiment of the louver slats of the louver-slat system.

FIG. 73 is a side view of an exemplar embodiment of the louver slats.

FIG. 74 is a side view of an exemplar embodiment of the louver-slat system, further illustrating the louver-slat insulation strips.

FIG. 75 is a close-up perspective view of an exemplar embodiment of the louver slats.

FIG. 76 is a close-up perspective view of an exemplar embodiment of the louver slats.

FIG. 77 is a close-up perspective view of an exemplar embodiment of a multi-louver-slat-control-axel cotter-pin being installed onto a multi-louver-slat-control-axel cotter-pin hole.

FIG. 78 is a close-up perspective view of an exemplar embodiment of louver slats.

FIG. 79 is a close-up perspective view of an exemplar embodiment of a louver-slat-supporting insertion axels being inserted into a louver-slat-rotation receiving hole.

FIG. 80 is a close-up perspective view of an exemplar embodiment of a louver-slat-rotation cradle axel being installed into a louver-slat-rotation open cradle.

FIG. 81 is a close-up perspective view of an exemplar embodiment of a louver-slat-rotation cradle axel 117 being installed into a louver-slat-rotation open cradle.

FIG. 82 is a close-up perspective view of an exemplar embodiment of a louver-slat-rotation-cradle cap 119 being installed onto a louver-slat-rotation open cradle.

FIG. 83 is an exploded view of an exemplar embodiment of louver slats.

FIG. 84 is an exploded view of an exemplar embodiment of louver slats.

FIG. 85 is an exploded view of an exemplar embodiment of louver slats with optional installed LED lights.

FIG. 86A is a front view of an exemplar embodiment of an insulation strip.

FIG. 86B is a perspective view of an exemplar embodiment of an insulation strip.

FIG. 87 is a side view demonstrating an exemplar embodiment of how multiple louver slats can rotate and interlock with each other.

FIG. 88 is a side view demonstrating an exemplar embodiment of how multiple louver slats can rotate and interlock with each other.

FIG. 89 is a perspective view of an exemplar embodiment of a crank tool.

FIG. 90 is a side view demonstrating an exemplar embodiment of how a crank tool is rotated and a louver-slat system(s) is closed.

FIG. 91 is a side view demonstrating an exemplar embodiment of how a crank tool is rotated and a louver-slat system(s) is opened.

FIG. 92 is a perspective view demonstrating an exemplar embodiment of how a crank tool is rotated and a louver-slat system(s) is opened.

FIG. 93 is a side cross-sectional view demonstrating an exemplar embodiment of how a multi-louver-slat-control first linkage arm, a multi-louver-slat-control second linkage arm, a linkage-arm gear, and worm gear, a worm-gear axel and a multi-louver-slat-control adjustable coupling ring interact with each other.

FIG. 94 is a side cross-sectional view demonstrating an exemplar embodiment of how a multi-louver-slat-control first linkage arm, a multi-louver-slat-control second linkage arm, a linkage-arm gear, and worm gear, a worm-gear axel and a multi-louver-slat-control adjustable coupling ring interact with each other.

FIG. 95 is a side view demonstrating an exemplar embodiment of how awning(s) can be secured to leading edges.

FIG. 96 is a perspective view demonstrating an exemplar embodiment of how a projector screen can be deployed.

FIG. 97 is a perspective view demonstrating an exemplar embodiment of how multiple projector screens can be deployed.

FIG. 98 is a side view demonstrating an exemplar embodiment of how a canopy can be secured to multiple leading edges.

FIG. 99 is a side view demonstrating an exemplar embodiment of a louver-slat system(s) can expand and contract a cord by opening and closing louver slats.

FIG. 100 is a side view demonstrating an exemplar embodiment of how a louver-slat system(s) can expand and contract a cord by opening and closing louver slats.

FIG. 101 is a perspective view demonstrating an exemplar embodiment of how an awning can be deployed.

FIG. 102 is a perspective view demonstrating an exemplar embodiment of how an awning can be retracted.

FIG. 103 is a perspective view of an exemplar embodiment of a multi-louver-slat-control bar.

FIG. 104 is a side view of an exemplar embodiment of a side gutter beam.

FIG. 105 is a perspective view of an exemplar embodiment of a side gutter beam.

FIG. 106 is a perspective view of an exemplar embodiment of a side gutter beam.

FIG. 107 is a close-up perspective view of an exemplar embodiment of a side gutter beam.

FIG. 108 is a perspective view of an exemplar embodiment of a reversible spacer.

FIG. 109 is a perspective view of an exemplar embodiment of a reversible spacer.

FIG. 110A is a top view of an exemplar embodiment of a reversible spacer.

FIG. 110B is a front view of an exemplar embodiment of a reversible spacer.

FIG. 110C is a back view of an exemplar embodiment of a reversible spacer.

FIG. 110D is a side view of an exemplar embodiment of a reversible spacer.

FIG. 111 is a perspective view of an exemplar embodiment of a gutter-beam securing bar.

FIG. 112 is a perspective view demonstrating an exemplar embodiment of how gutter-beam-securing bars are installed into gutter-beam-securing-bar receivers.

FIG. 113 is a perspective view demonstrating an exemplar embodiment of how gutter-beam-securing bars are installed into gutter-beam-securing-bar receivers.

FIG. 114 is a perspective view demonstrating an exemplar embodiment of how L-shaped corner-post caps are installed onto corner posts.

FIG. 115 is a side view demonstrating an exemplar embodiment of how rainwater is directed from louver slats into leading edges.

FIG. 116A is a cross-sectional front view demonstrating an exemplar embodiment of how rainwater is directed from louver slats to side gutter beams, into ejecting tunnels, and out of rainwater drains.

FIG. 116B is a cross-sectional side view demonstrating an exemplar embodiment of how rainwater is directed from louver slats to side gutter beams, into ejecting tunnels, and out of rainwater drains.

FIG. 117 is a perspective view demonstrating direction of rainwater flow within rainwater-channeling-and-draining gutters.

FIG. 118 is a perspective view demonstrating how rainwater is directed from louver slats to side gutter beams, and into ejecting tunnels.

FIG. 119 is a top cross-sectional view of an exemplar embodiment of coupling posts.

FIG. 120 is a top cross-sectional view of an exemplar embodiment coupling posts.

FIG. 121 is a top cross-sectional view of an exemplar embodiment coupling posts.

FIG. 122 is a top cross-sectional view of an exemplar embodiment coupling posts.

FIG. 123 is a top cross-sectional view of an exemplar embodiment coupling posts.

FIG. 124 is a top view of an exemplar embodiment of a gazebo.

FIG. 125 is a perspective view demonstrating an exemplar embodiment of two gazebos connected together.

FIG. 126 is an exploded perspective view of an example embodiment of a louver-slat system(s) with a solar panel installed.

FIG. 127 is an exploded perspective view of an example embodiment of a louver-slat system(s) with a solar panel installed.

FIG. 128 is a partially-exploded perspective view of an example embodiment of a louver-slat system(s) with a solar panel installed.

FIG. 129 is an exploded perspective view of an example embodiment of a louver-slat system(s) with a solar panel installed.

FIG. 130 is an exploded view of an example embodiment of a louver-slat system(s) with a solar panel installed.

FIG. 131 is an exploded perspective view of an example embodiment of optional batteries and battery compartment housing.

FIG. 132A is a perspective view of an example embodiment of an optional battery compartment cover.

FIG. 132B is a perspective view of an example embodiment of an optional battery compartment bottom.

FIG. 133 is an exploded view of an example embodiment of a louver-slat system(s) with a solar panel installed.

FIG. 134 is a perspective view of an example embodiment of a louver-slat system(s) with a solar panel installed on a louver-slat.

FIG. 135 is an exploded perspective view of an example embodiment of a louver-slat system(s) illustrating the reservoir for the battery compartment housing.

FIG. 136 is an exploded perspective view of an example embodiment of a louver-slat system(s) with LED lights installed.

FIG. 137A is a side view of an exemplar embodiment of a control system.

FIG. 137B is side view of an exemplar embodiment of a control system.

FIG. 138 is a close-up perspective view of an exemplar embodiment of corner posts, center-and-corner-post base-plate covers, and corner-and-central-post base plates.

FIG. 139 is a perspective view demonstrating installation and operation of sleeve-screw holes, anchoring-screw holes, and anchoring screws.

FIG. 140 is a perspective view demonstrating installation and operation of sleeve-screw holes, anchoring-screw holes, and anchoring screws.

FIG. 141 is a perspective view demonstrating installation and operation of sleeve-screw holes, anchoring-screw holes, and anchoring screws.

FIG. 142A is a top view of an exemplar embodiment of a gutter-beam-securing bar.

FIG. 142B is a side view of an exemplar embodiment of a gutter-beam-securing bar.

FIG. 142C is a side view of an exemplar embodiment of a securing screw.

FIG. 142D is a side view of an exemplar embodiment of a securing screw.

FIG. 143 is a perspective view of a louver mounting shaft.

FIG. 144A is a perspective view of a positioning pin.

FIG. 144B is a perspective view of a spacer ring.

FIG. 144C is a perspective view of a press-fit spacer.

FIG. 144D is a perspective view of a threaded spacer.

FIG. 145A is a perspective view of a threaded spacer.

FIG. 145B is a perspective view of a gearbox activation rod.

FIG. 146 is a perspective view of a multi-louver-slat-control axel with a multi-louver-slat-control-axel cotter-pin hole.

FIG. 147A is a perspective view of an exemplar embodiment of a multi-louver-slat-control-axel cotter-pin.

FIG. 147B is a perspective view of an exemplar embodiment of a rivet.

FIG. 147C is a perspective view of an exemplar embodiment of a rivet.

FIG. 148A is a perspective view of an exemplar embodiment of a self-positioning fastener.

FIG. 148B is a perspective view of an exemplar embodiment of a spacer plate washer.

FIG. 149A is a top view of an exemplar embodiment of a side gutter beam.

FIG. 149B is a top view of an exemplar embodiment of a side gutter beam.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

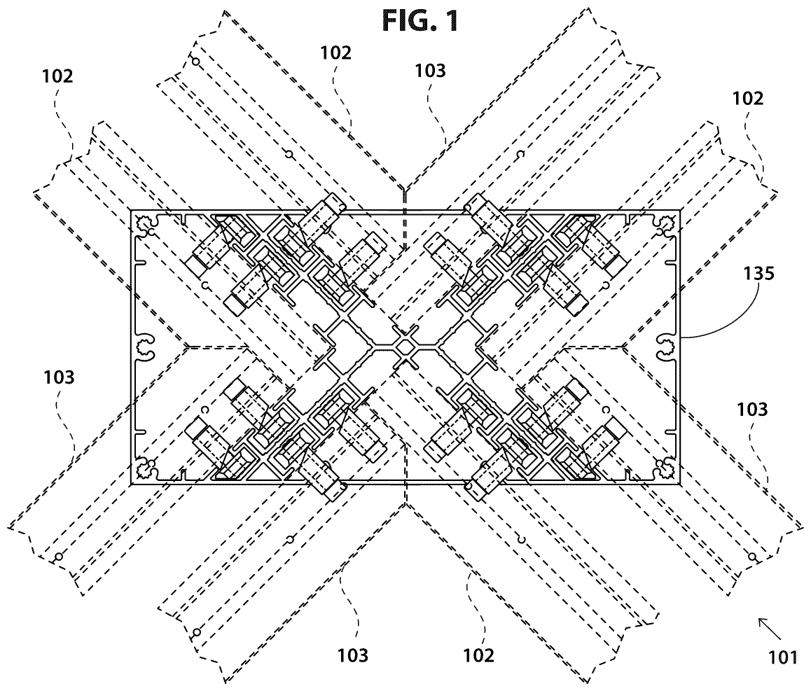

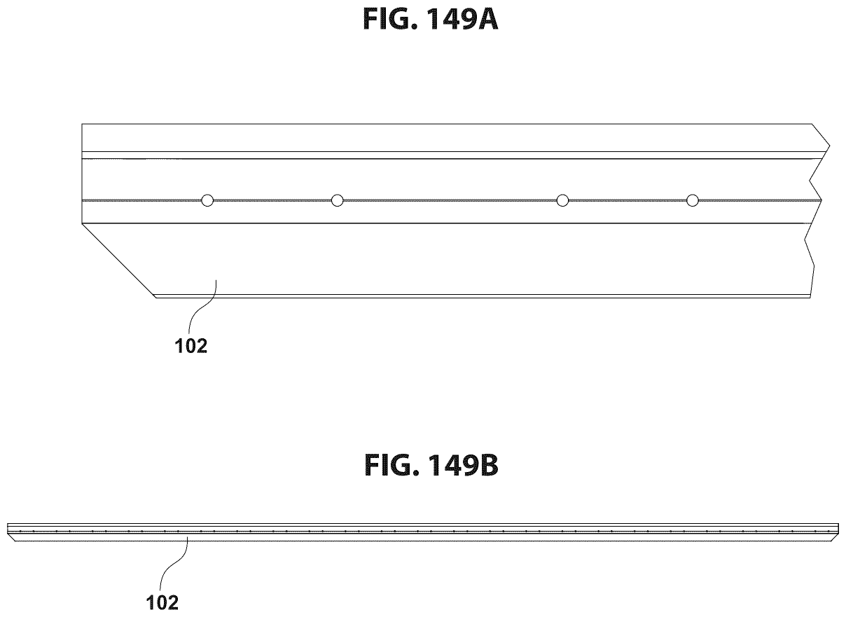

With reference to FIGS. 1-149B, exemplar embodiments of a gazebo and features related thereto are shown. In some embodiments, the gazebo 1 is a louvered gazebo 1. According to an aspect of the embodiments, the gazebo 1 is capable of directing wind, and channeling and/or draining rainwater. According to another aspect of the embodiments, the gazebo 1 is configured for use in all seasons. The gazebo 1 can comprise one or more projector screens 167a configured to raise and/or lower. In some embodiments, the projector screens 167a are configured to raise and/or lower in an automatic fashion. In some embodiments, the gazebo 1 is configured to deploy and/or retract an awning 160. Particularly, in some embodiments, the gazebo 1 can deploy and/or retract the awning 160 in an automatic fashion.

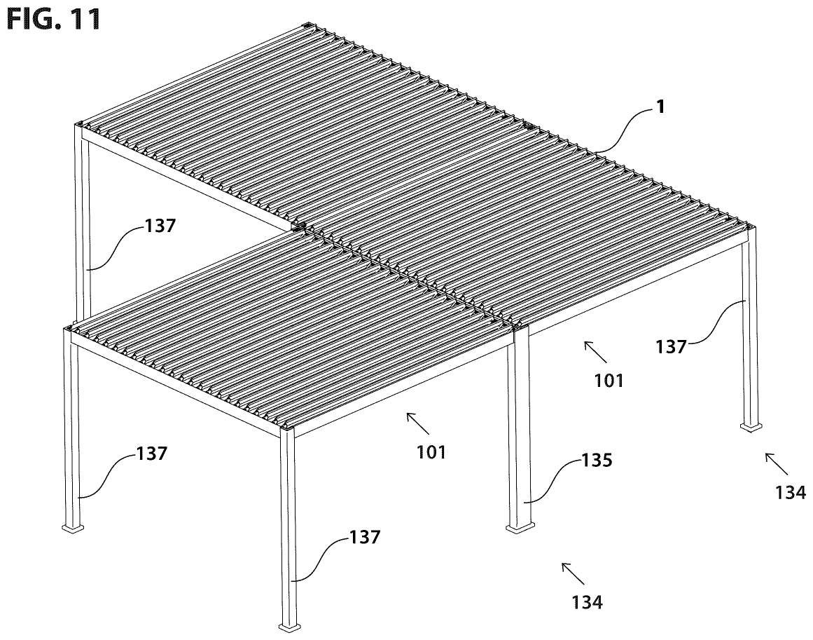

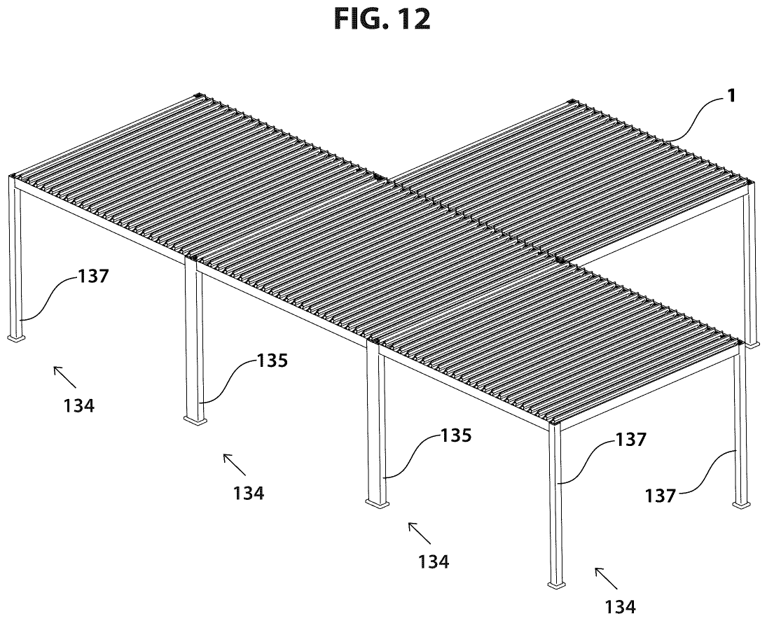

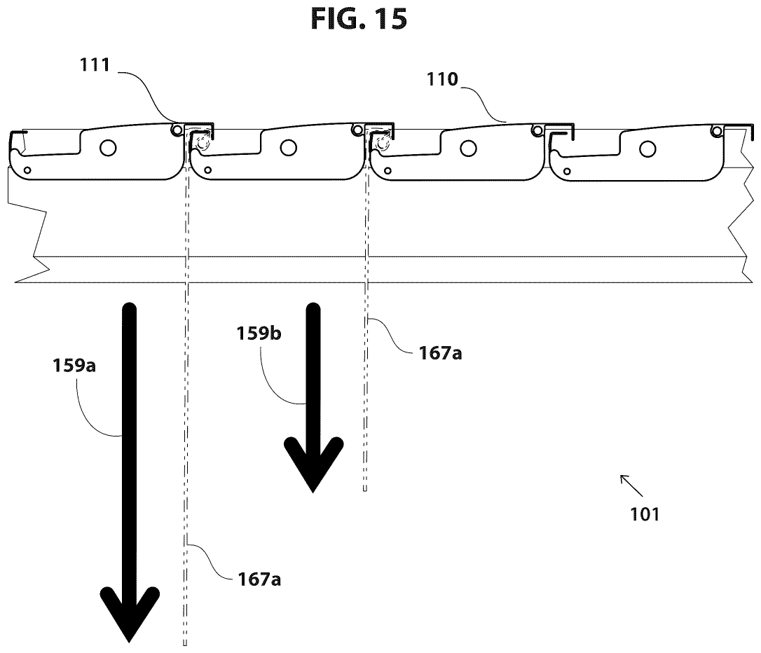

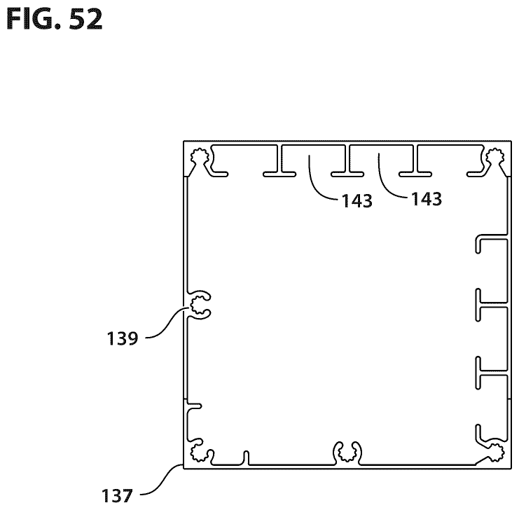

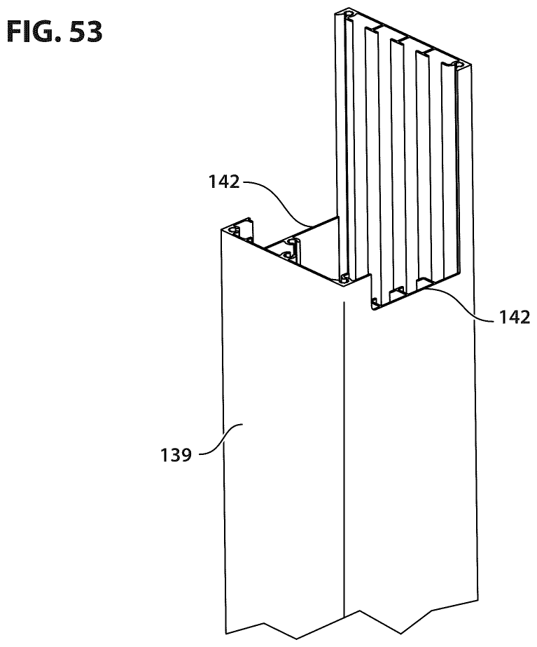

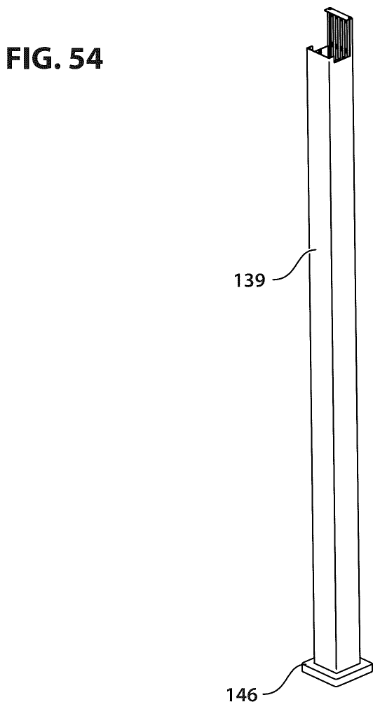

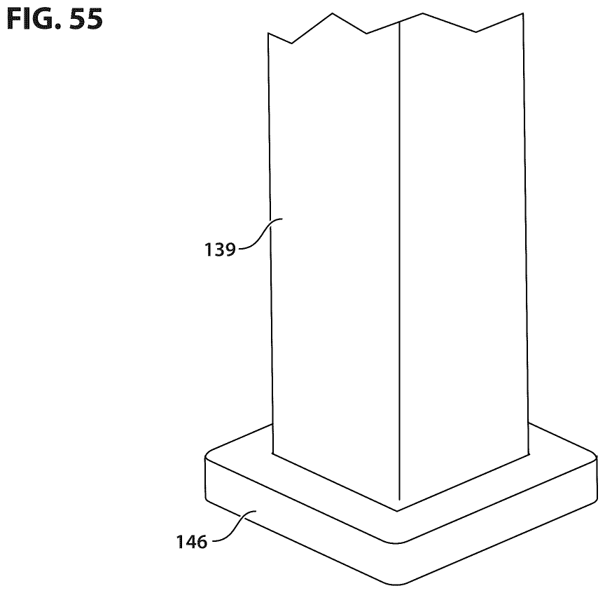

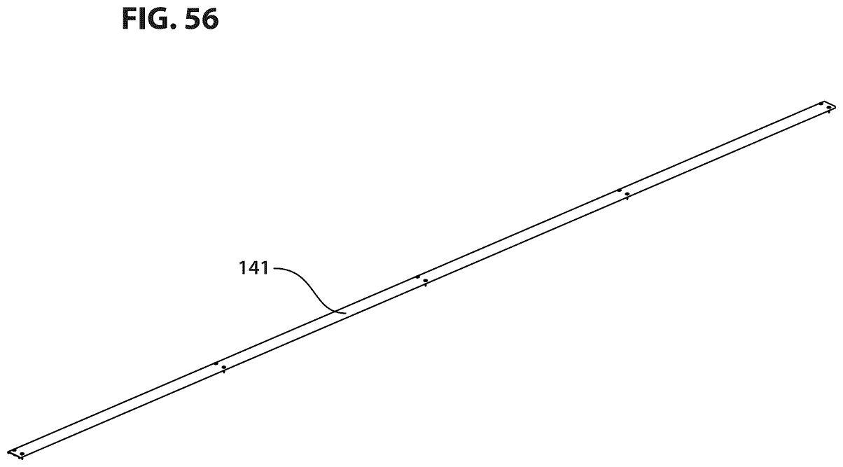

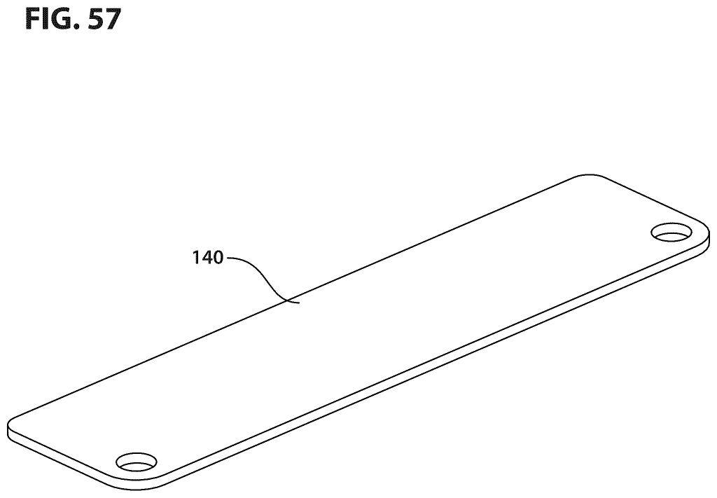

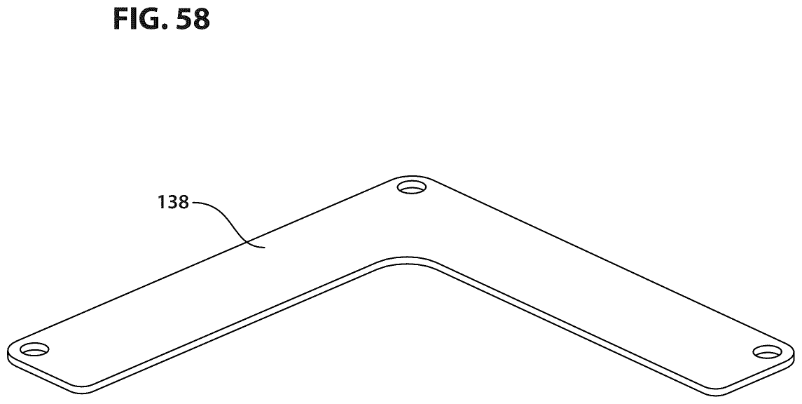

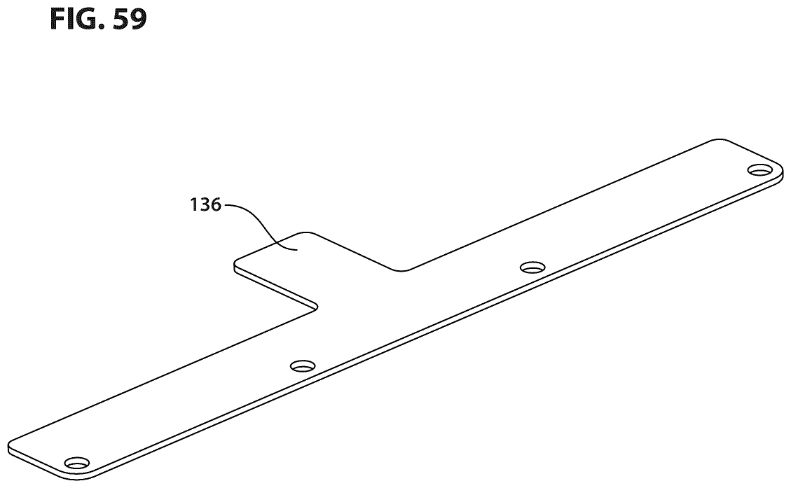

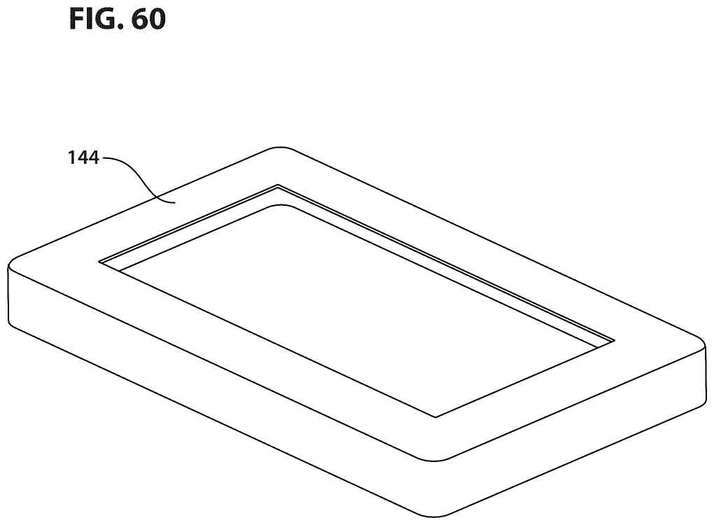

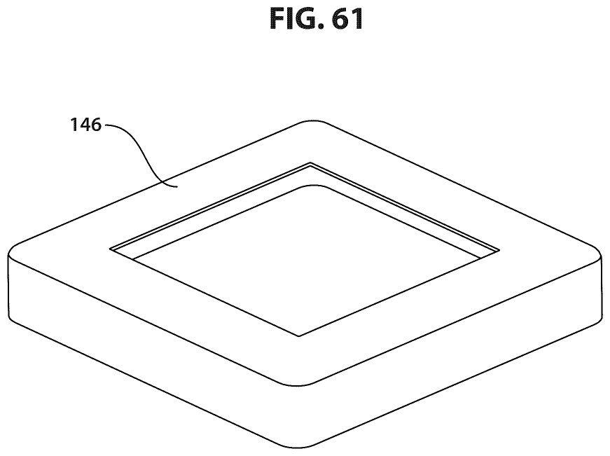

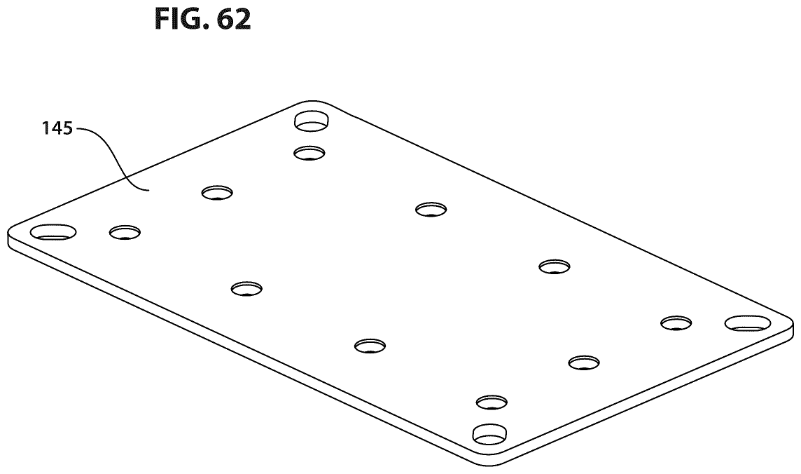

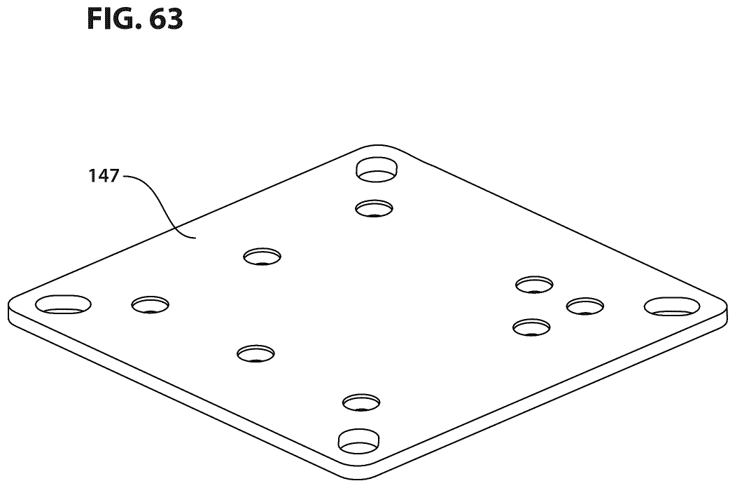

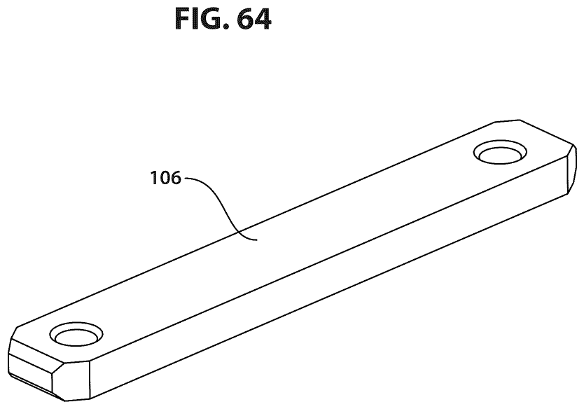

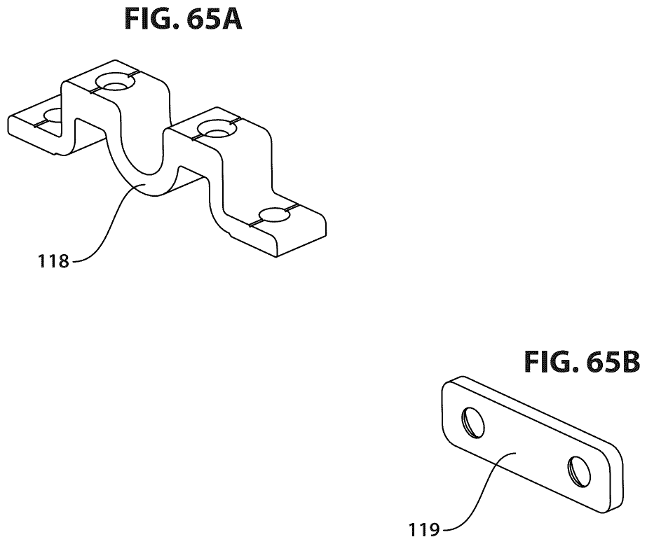

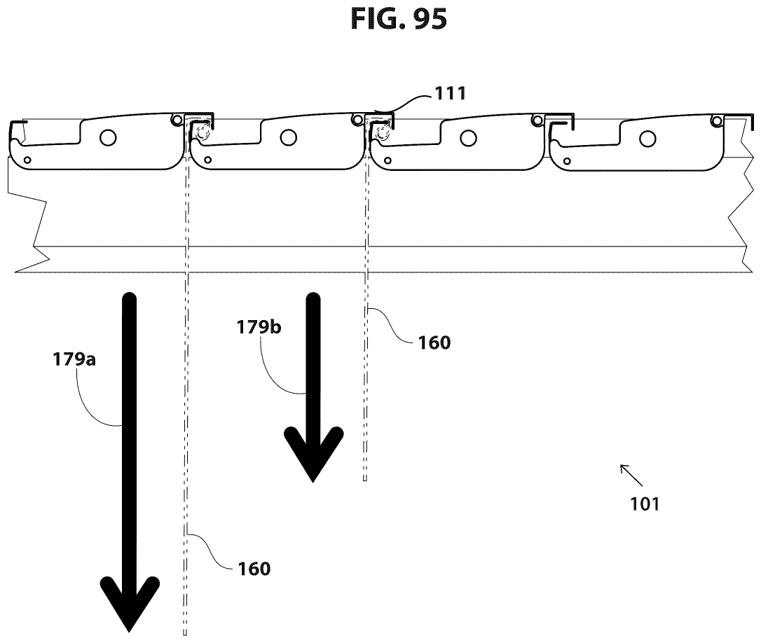

In some embodiments, the gazebo 1 comprises a gutter beam system 101. The gutter beam system 101 can comprise one or more side gutter beams 102 (FIGS. 149A-149B) and one or more end gutter beams 103. Further, the gazebo 1 can comprise and support one or more louver-slat systems 109. The louver-slat system 109 can be robot-assembled. The louver-slat system 109 can be wind directing. The louver slat system 109 can be configured to seal the gazebo 1 from rainwater or the like. The louver-slat system 109 can be configured to automatically deploy and/or retract the awning 160, e.g., in an automatic fashion (FIG. 95). The louver-slat system 109 can raise and lower multiple screens 167a, e.g., in an automatic fashion (FIGS. 15, 16, and 96). Further, the gazebo(s) 1 can be capable of providing horizontal support between one or more corner posts 137 (e.g., FIGS. 11, 12, 52)

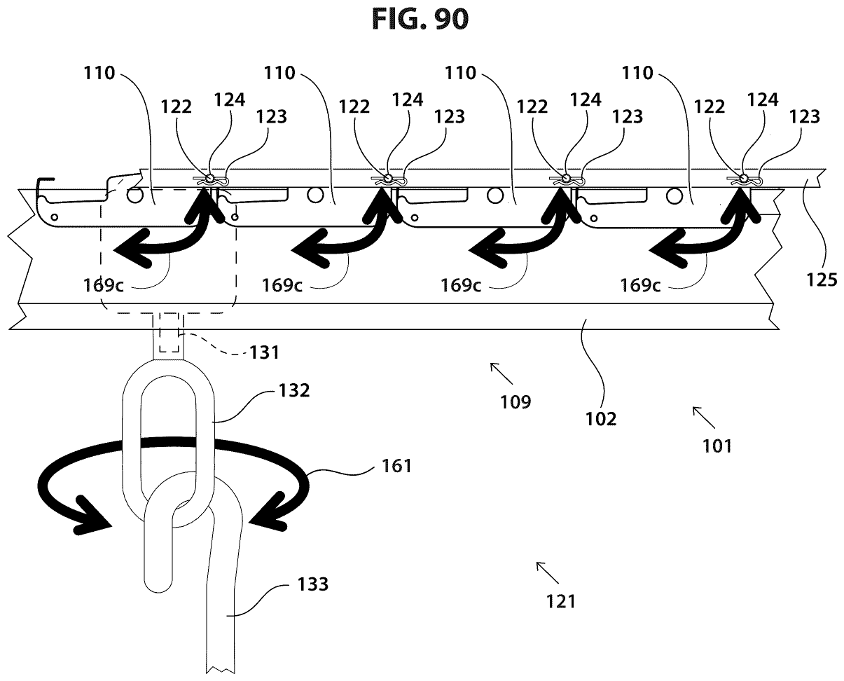

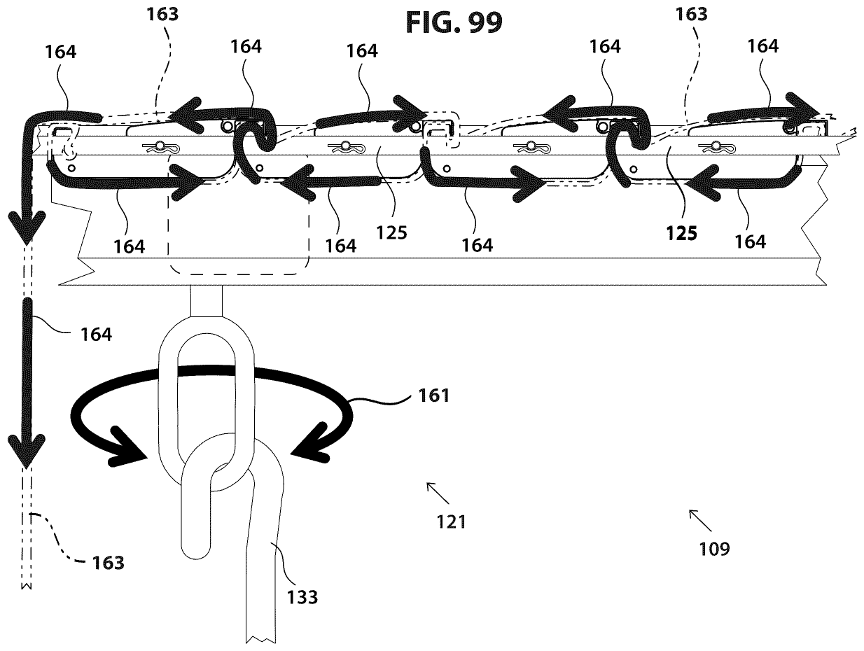

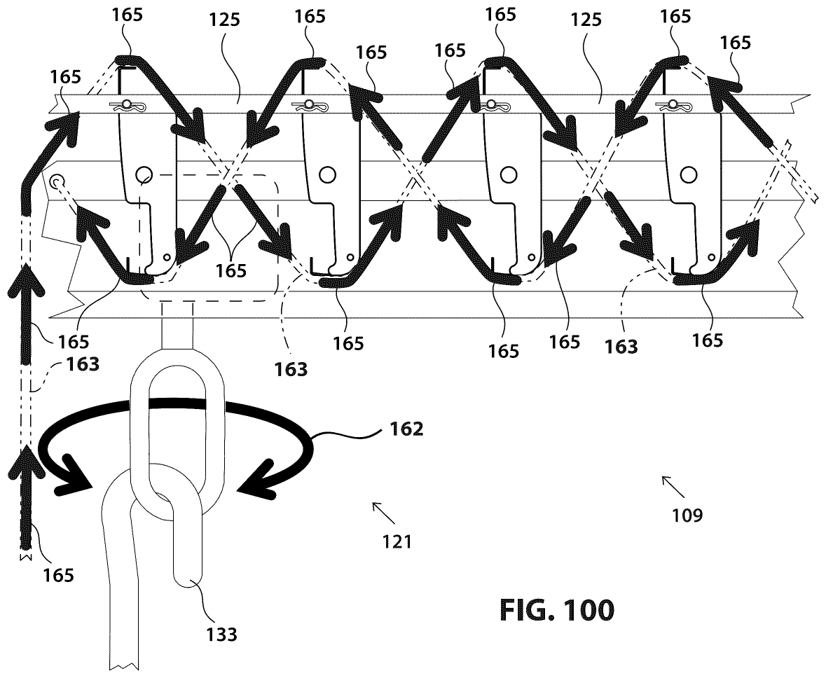

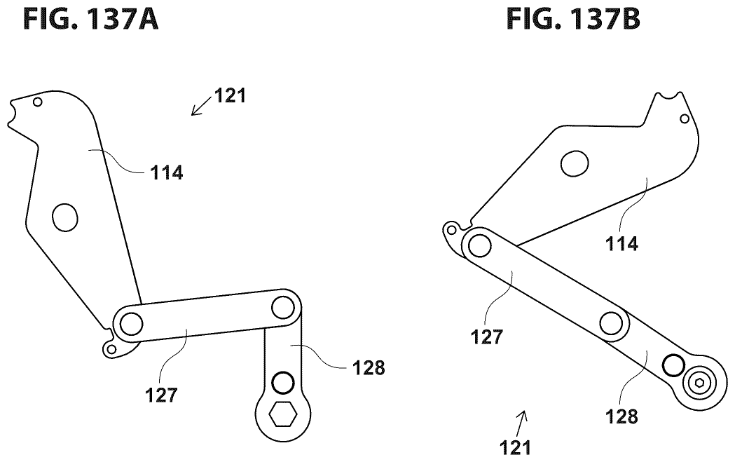

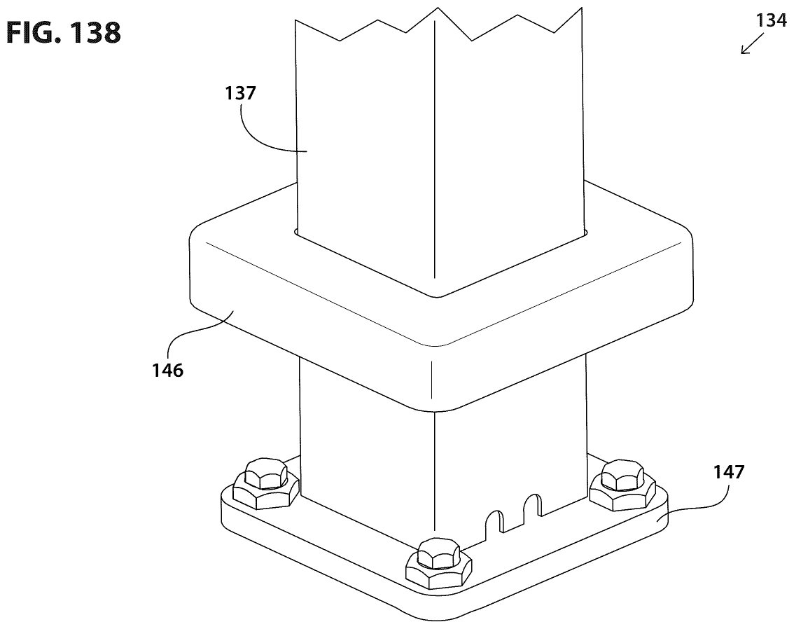

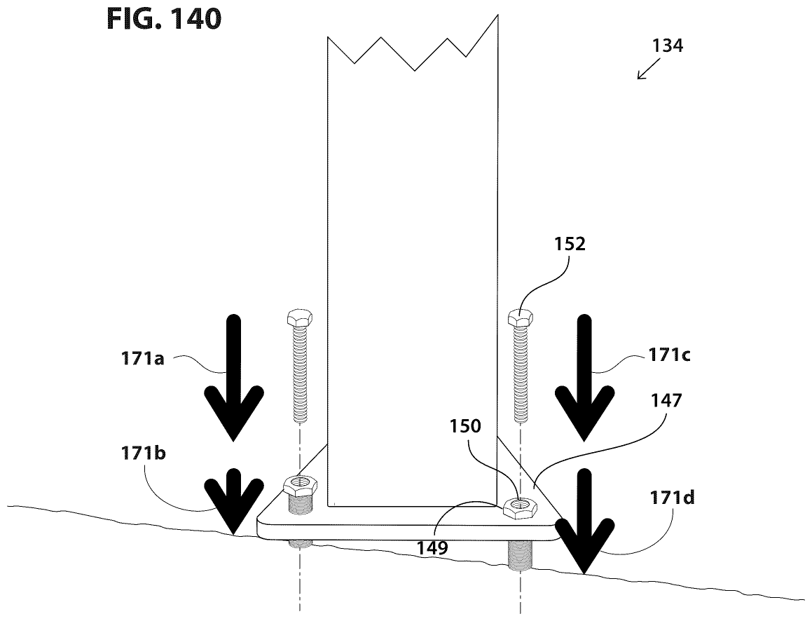

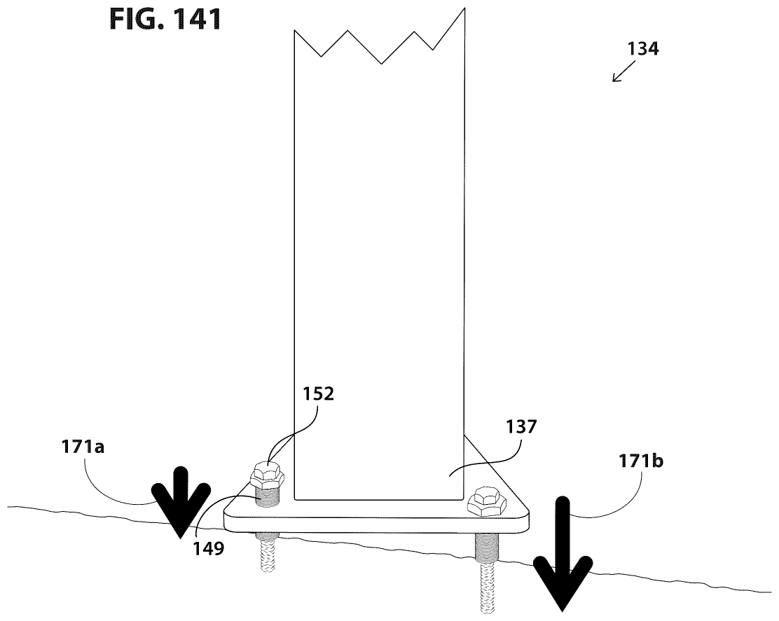

In some embodiments, and as shown in FIGS. 90, 99, 100, and 137A-137B, the gazebo 1 further comprises a control system 121. Further, and as best shown in FIGS. 11, 12, and 138-141. The gazebo 1 can include a multi-angle allowing-coupling-post post-leveling base system 134 (also referred to as a post-leveling base system 134) that allows a user to adjust the height and angle of the gazebo 1. The multi-angle allowing-coupling-post post-leveling base system 134 is further configured to connect multiple gazebos 1.

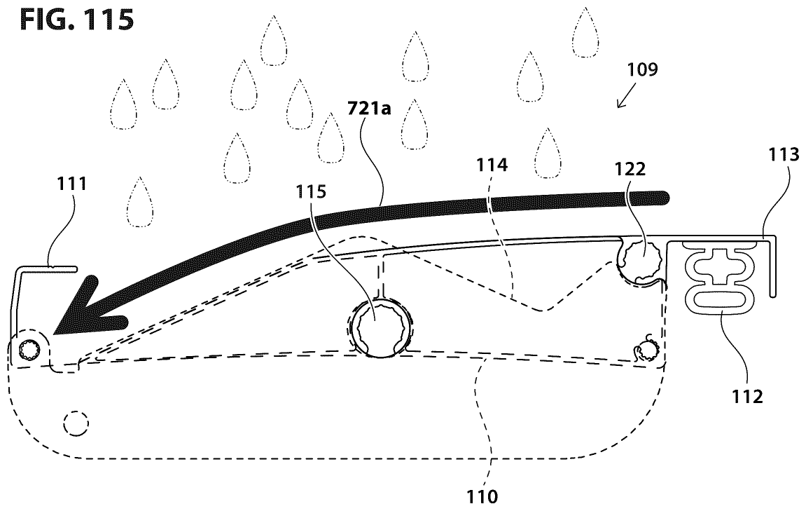

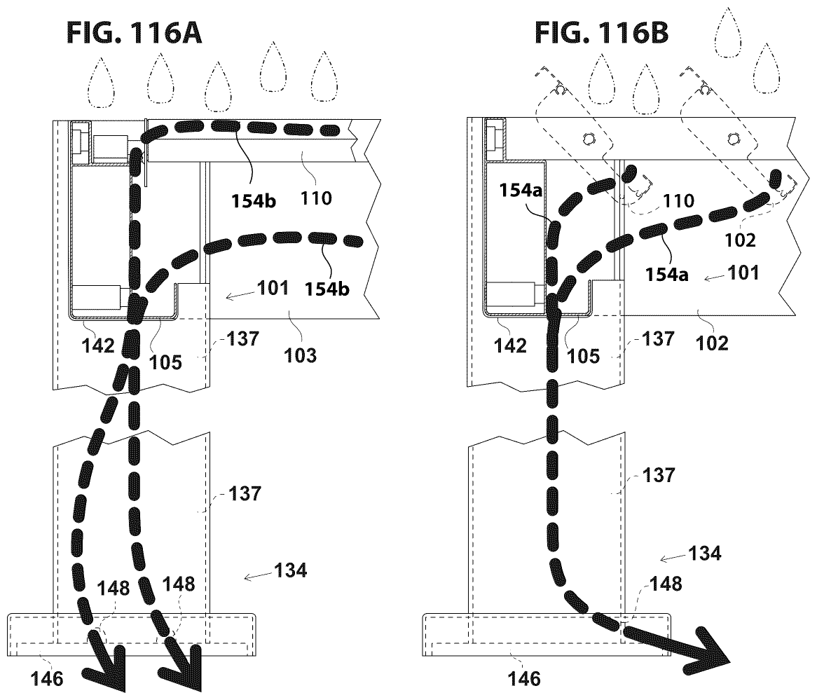

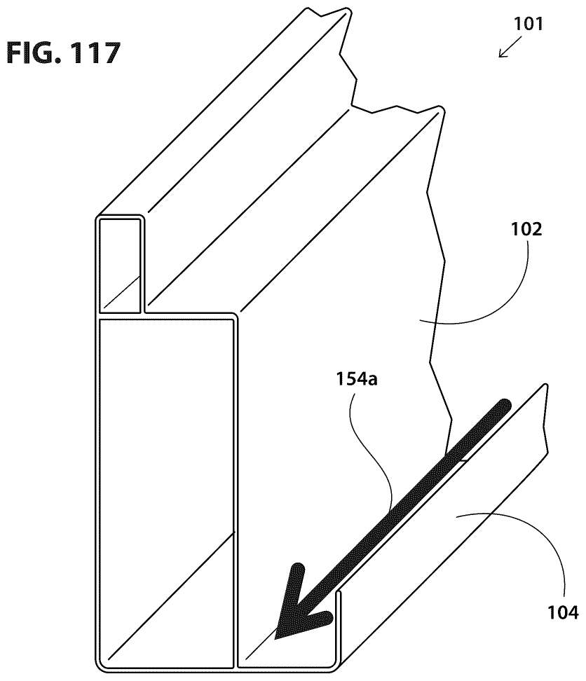

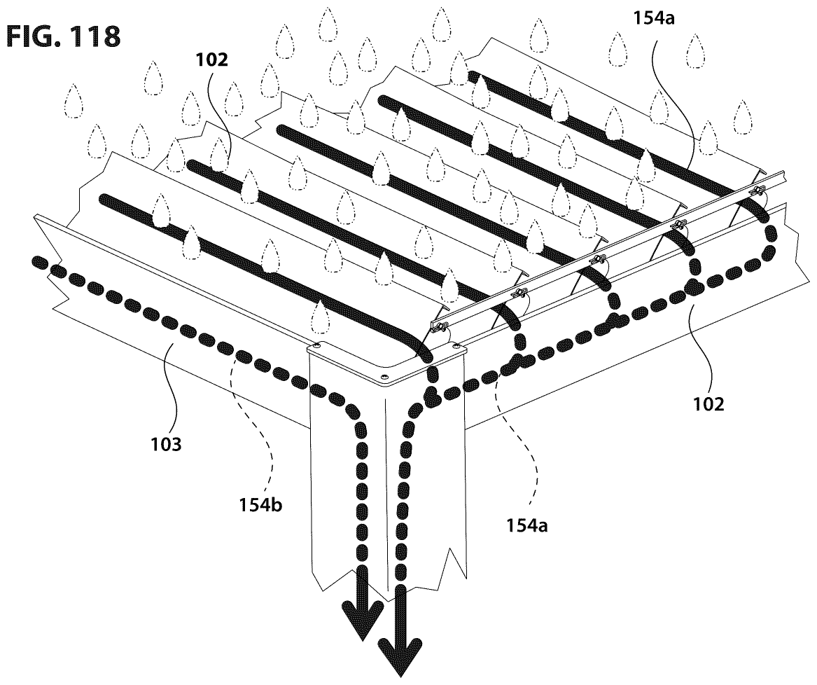

In some embodiments, the gazebo 1 comprises the one or more side gutter beams 102 (FIGS. 149A-149B). The side gutter beams 102 can be robot assembled. The side gutter beams 102 can be configured to direct the wind-flow, channel and drain rainwater, and connect multiple gazebos 1. In this manner, the gazebo 1 can provide horizontal support for connecting gazebos 1 (e.g., connecting a first gazebo 1 to a second gazebo 1). Further, the gazebo 1 is configured to hide gutters 104 (best shown in FIG. 117) in the directions or arrows 721a, 154a, and 154b (see, e.g., FIGS. 115-118). The gutters 104 can be configured to channel and drain rainwater.

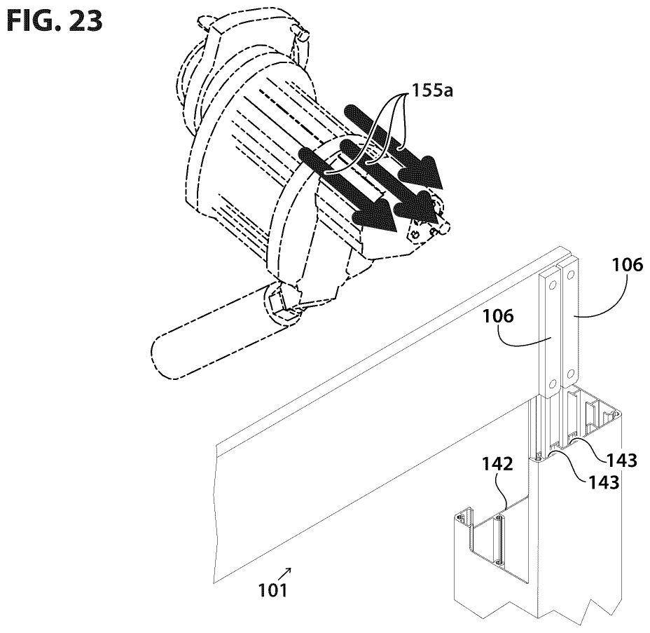

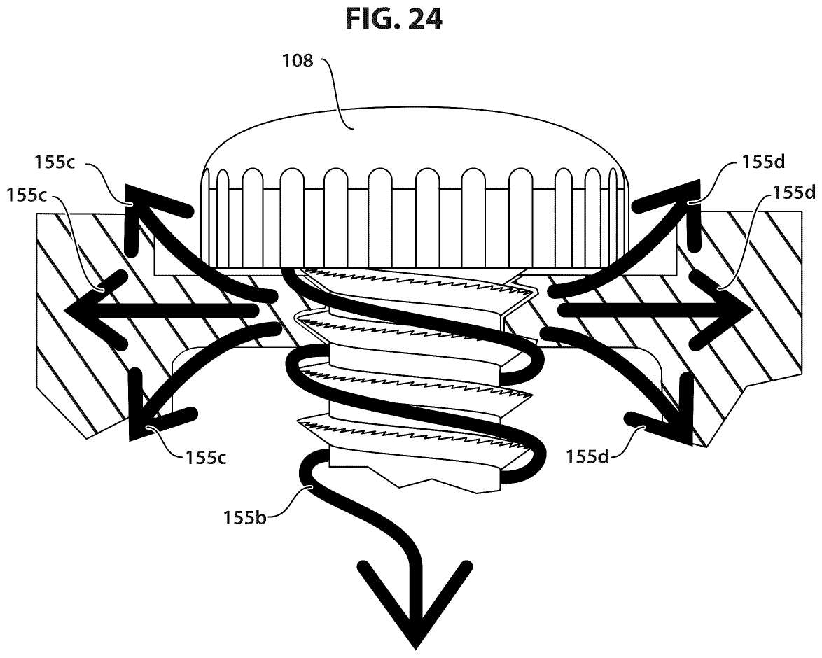

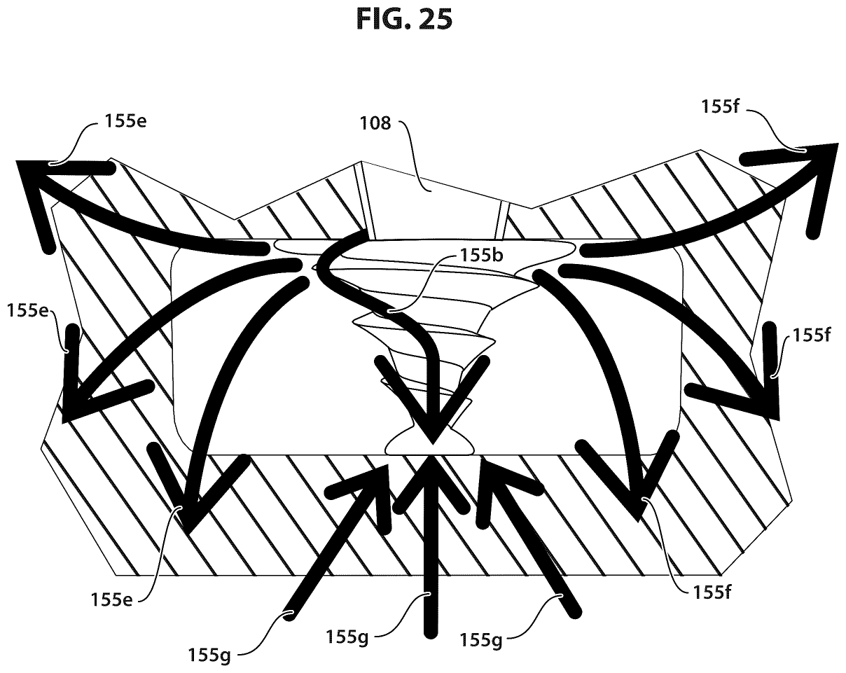

In some embodiments, the gazebo 1 and its features can be capable of being robotically assembled so as to save production time and costs. With particular reference to FIGS. 23-25, the gazebo 1 can be capable of providing robotically installed screws 108, in the directions of arrows 155a and 155b. In this way, the installed screws 108 can automatically create friction heat, cut threads in the direction of arrows 155c, 155d, expand screw-tip on impact, in the direction of arrows 155e, 155f, and 155g, so as to lock in place when the thread-walls cool and contract.

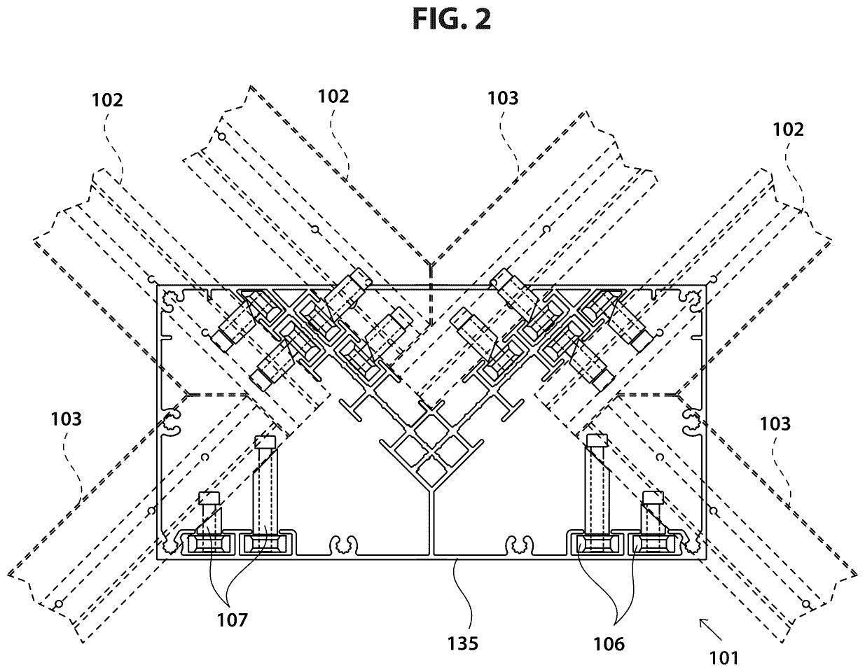

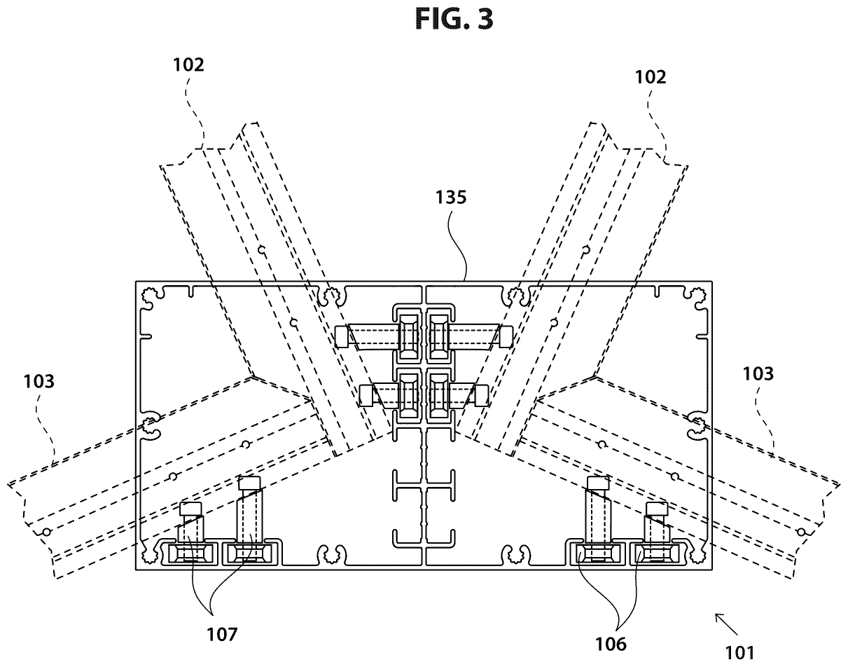

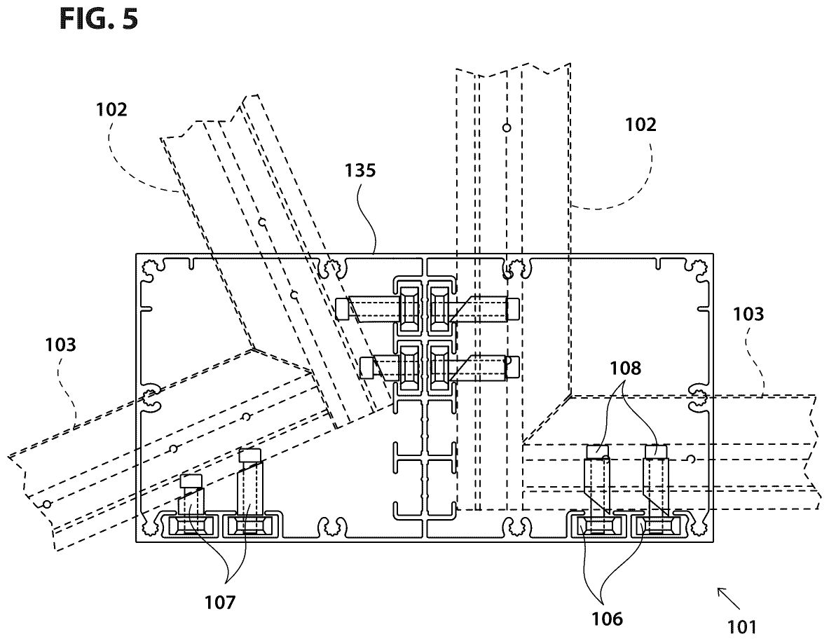

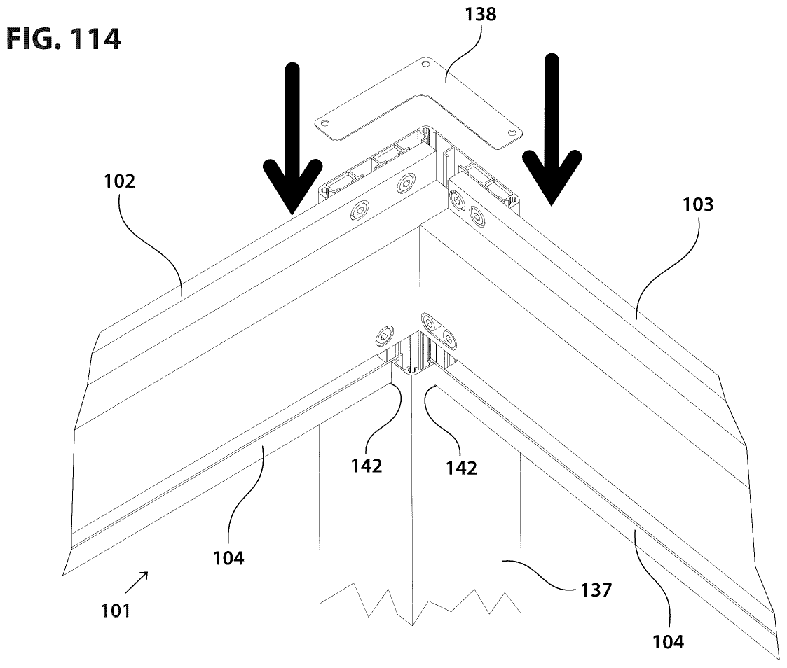

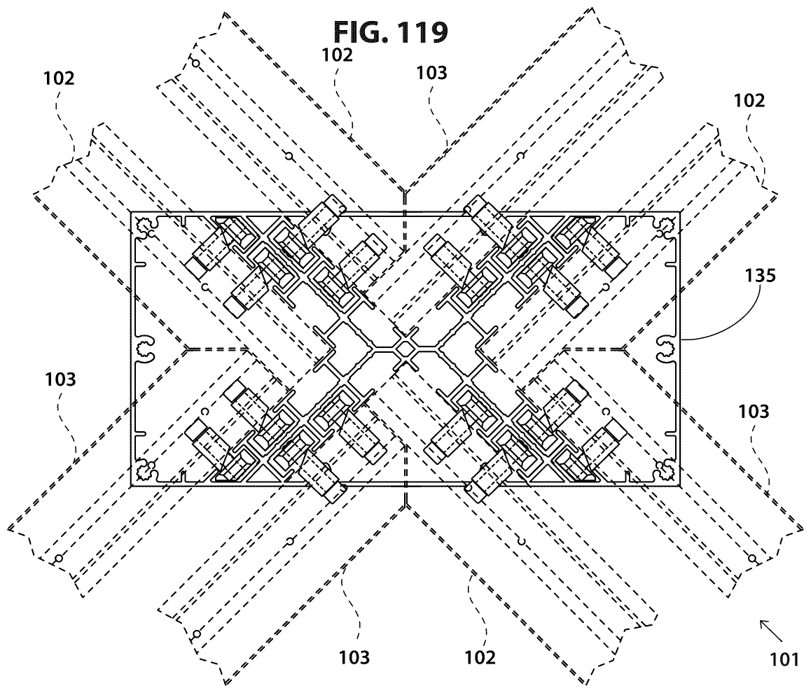

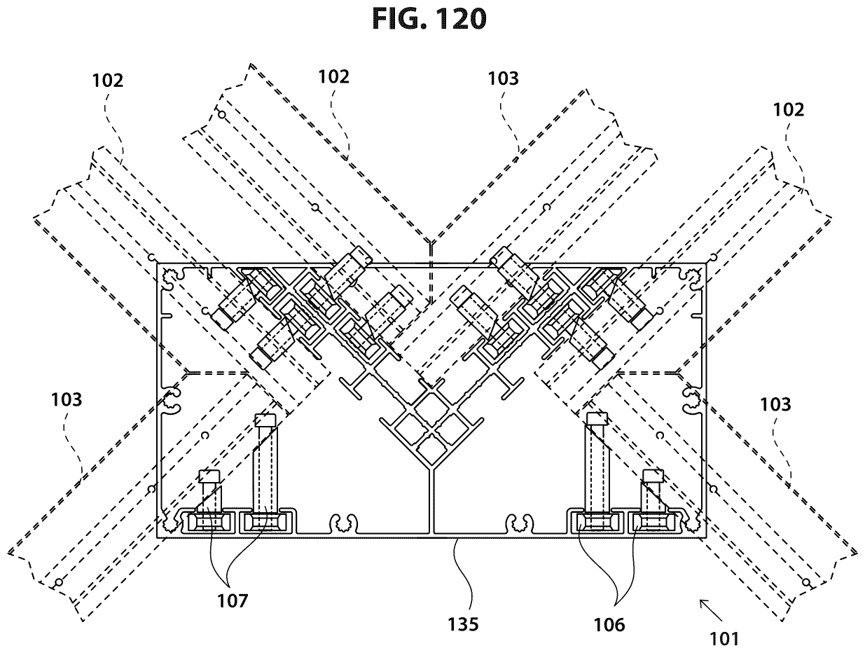

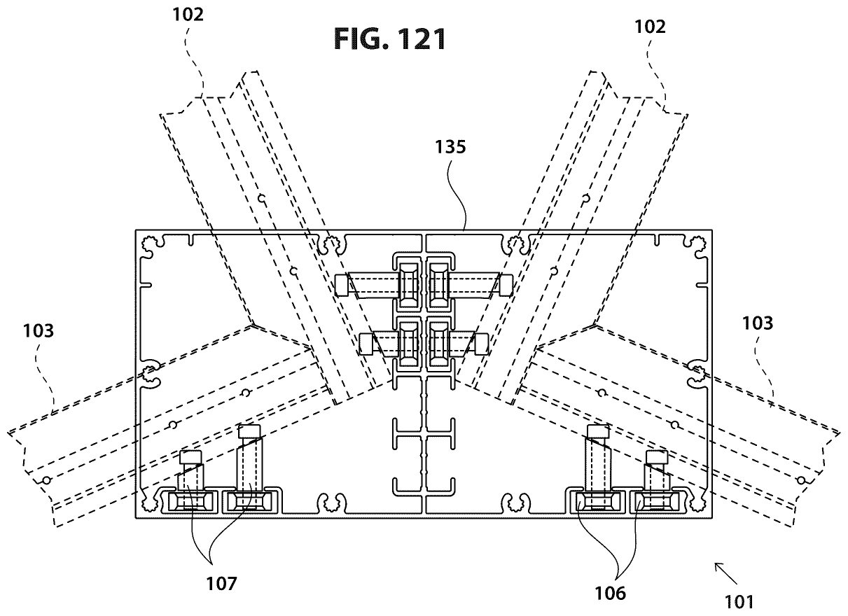

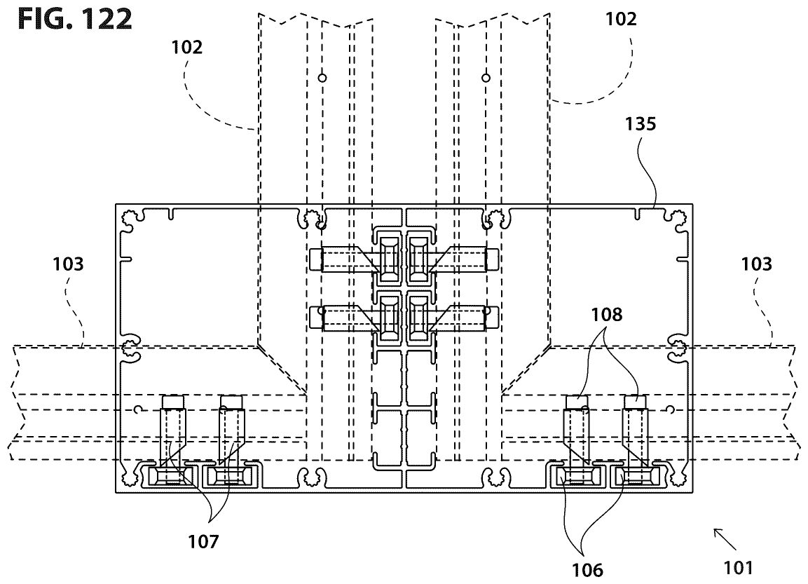

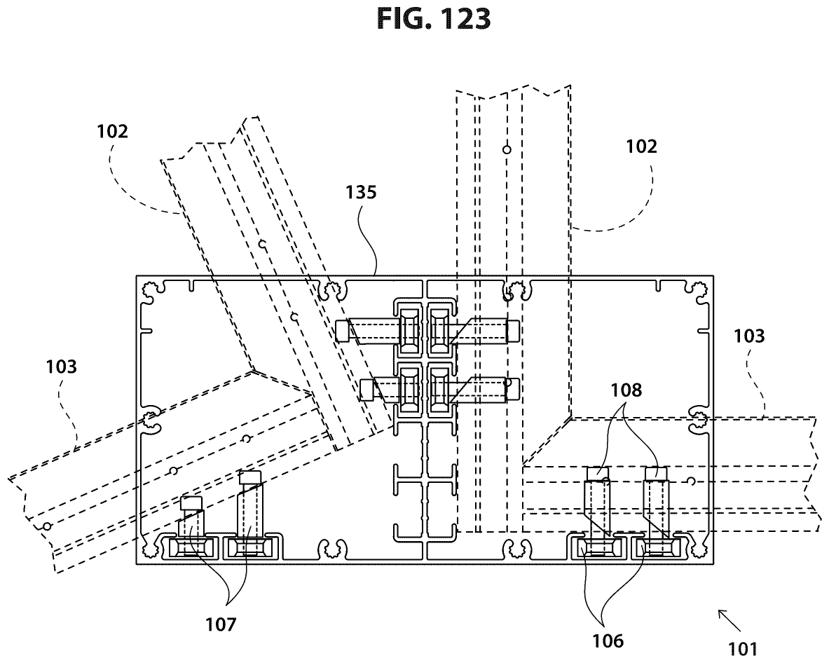

With reference to FIGS. 1-5, 114, and 118-123, the gazebo 1 can comprise the one or more end gutter beams 103. The end gutter beams can be robot assembled. The end gutter beams can be configured to direct the wind-flow, channel and drain the rainwater, and connect multiple gazebos 1. In this manner, the gazebo 1 can provide horizontal support for connecting gazebos (e.g., the first gazebo 1 to a second gazebo 1).

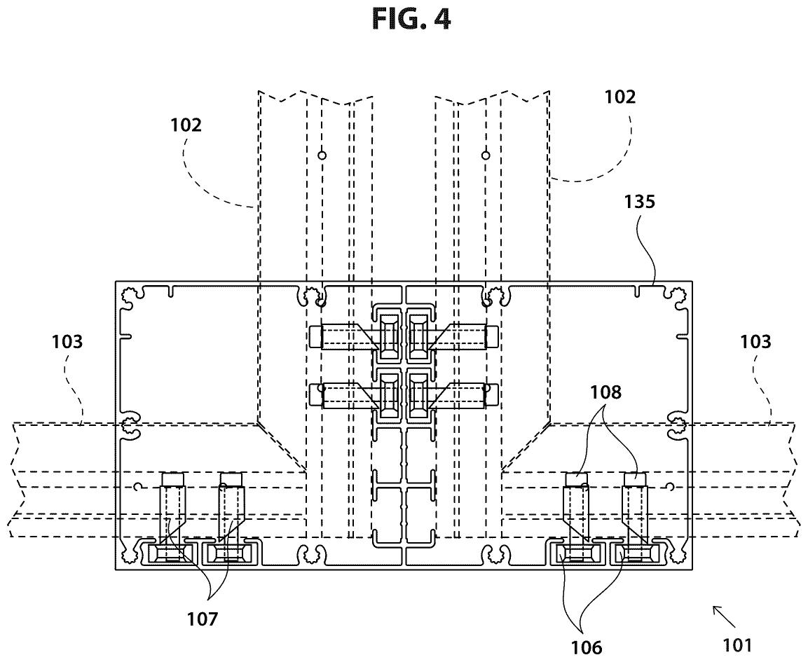

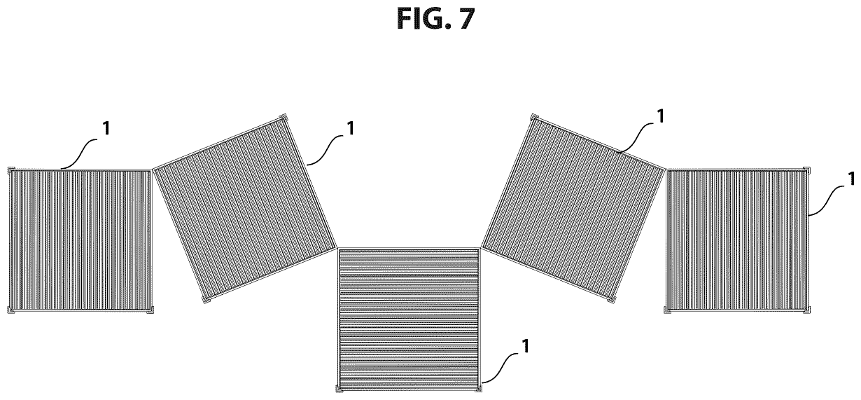

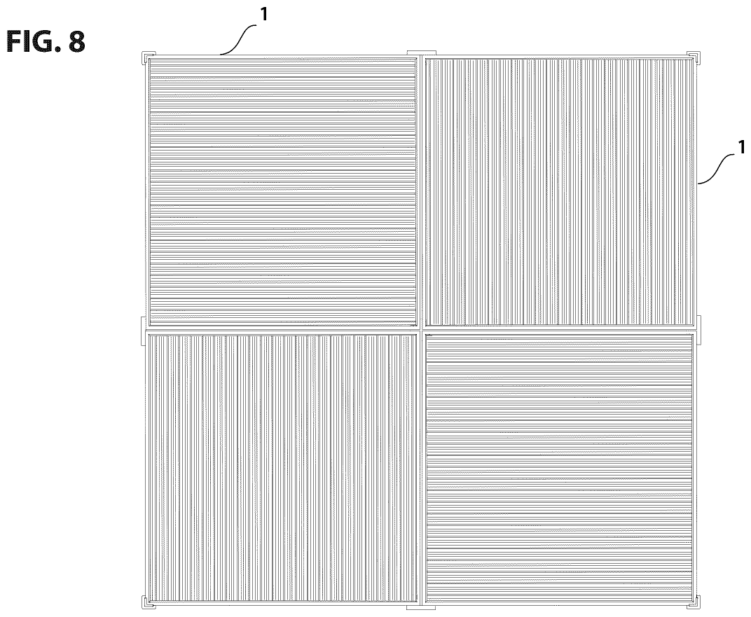

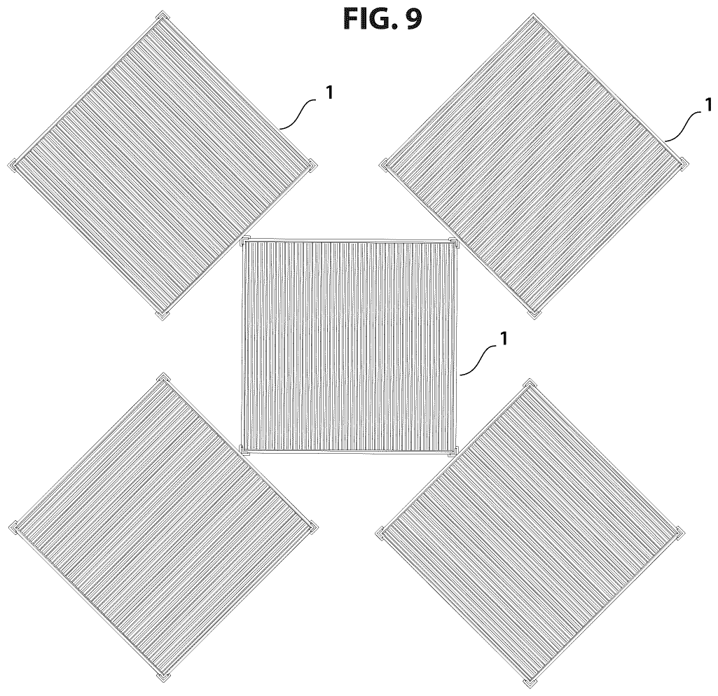

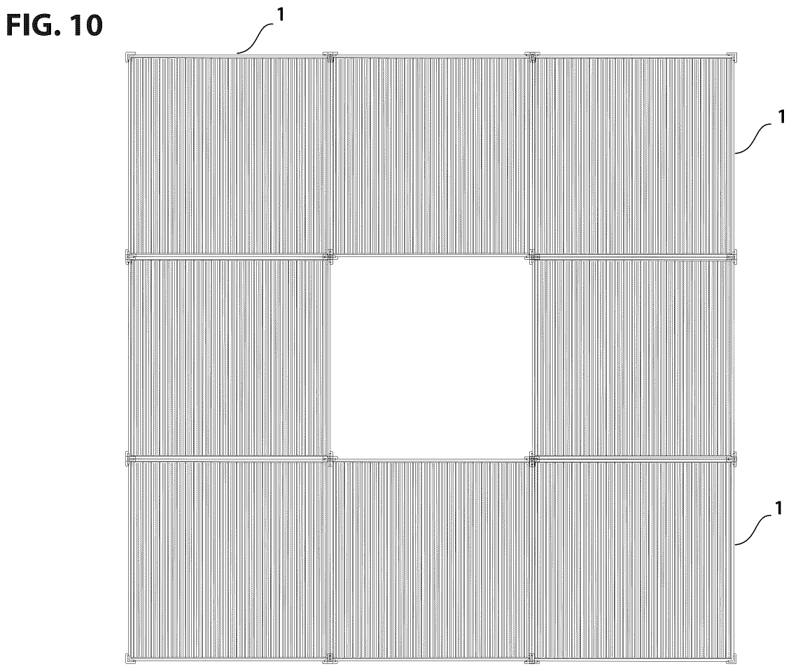

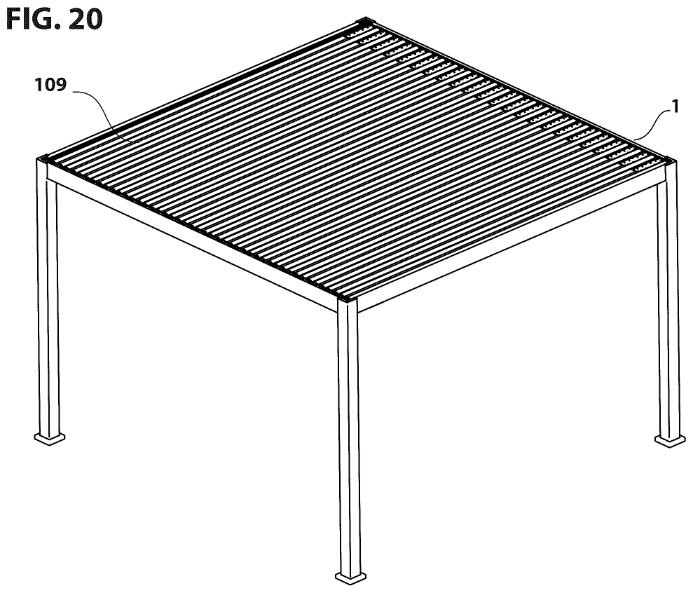

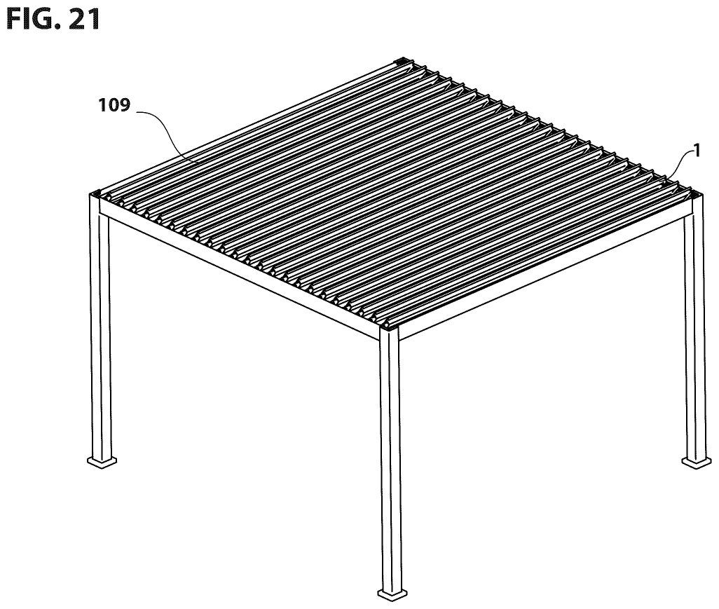

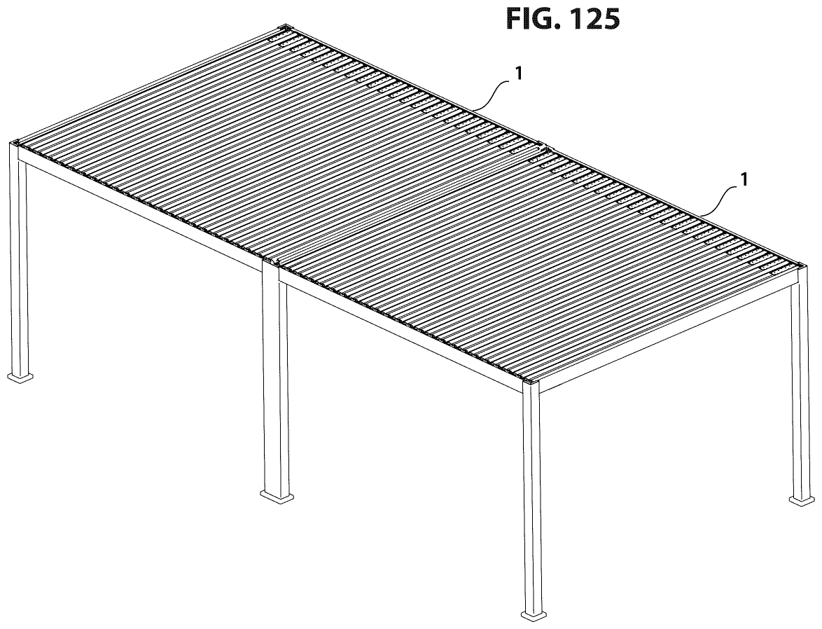

In some embodiments, the gazebo 1 can comprise a plurality of reversible spacers 107. In some embodiments, the reversible spacers 107 can be robot assembled and are configured to adjust the angles of the gutter beams 102, 103. In this manner, and because of the reversible spacedrs 107, the gazebo 1 is capable of connecting multiple gazebos 1 at multiple angles (see, e.g., FIGS. 1-12, 20, 119-123, and 125). Additionally, and with reference to FIGS. 4-12, 122, 123, and 125, in some embodiments, the gazebo 1 can connect to other gazebos 1 in a straight line fashion, in perpendicular configurations, and/or in a cluster formation.

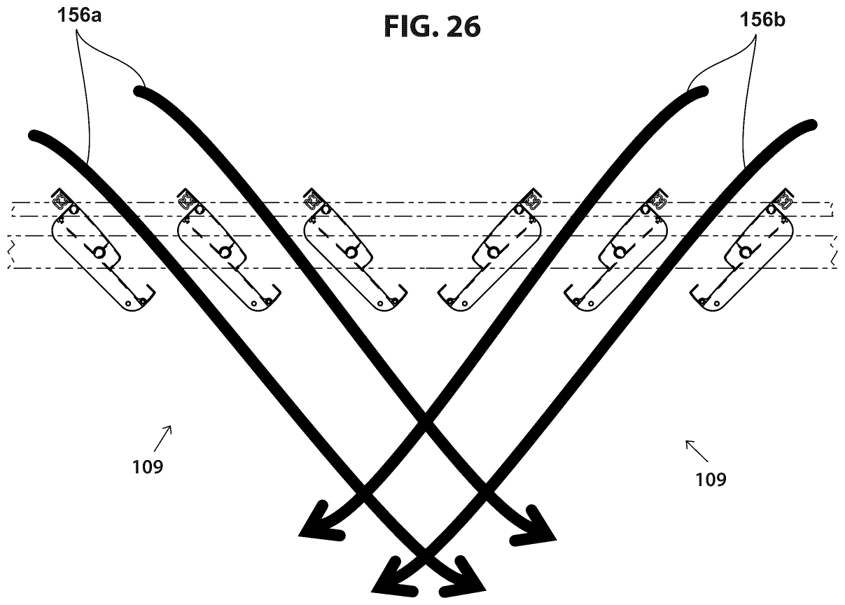

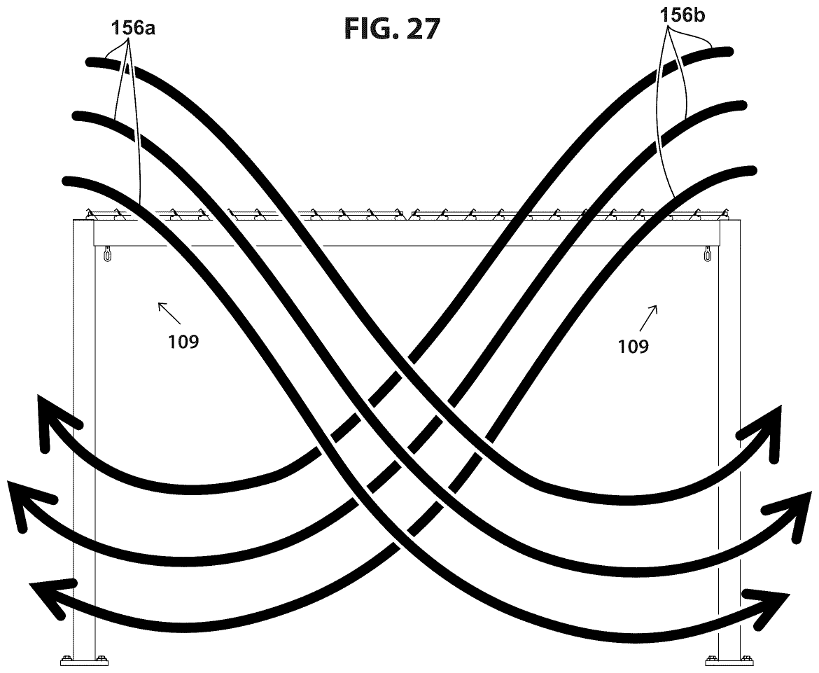

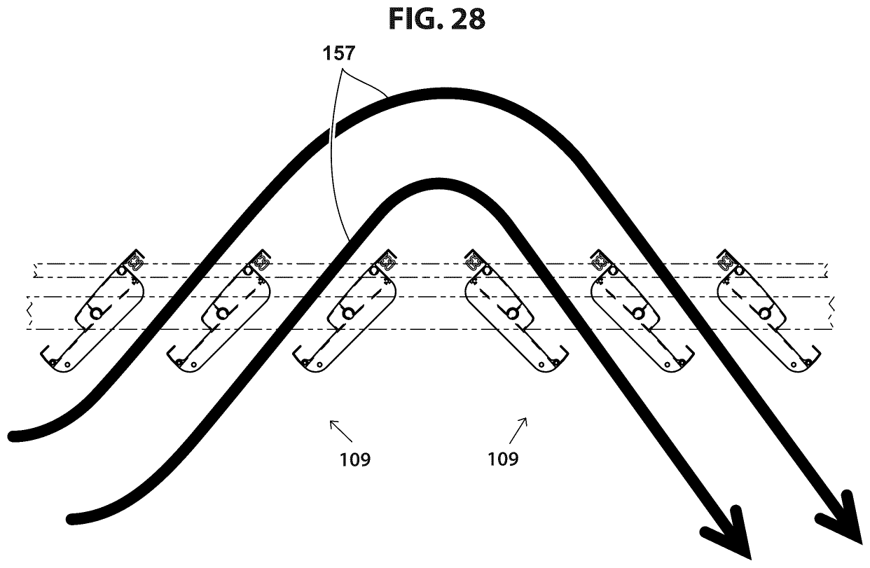

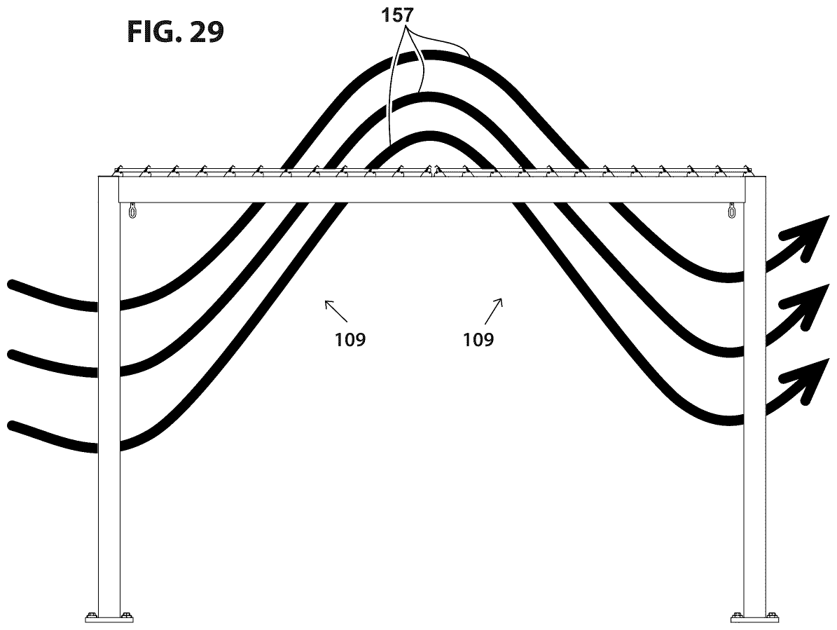

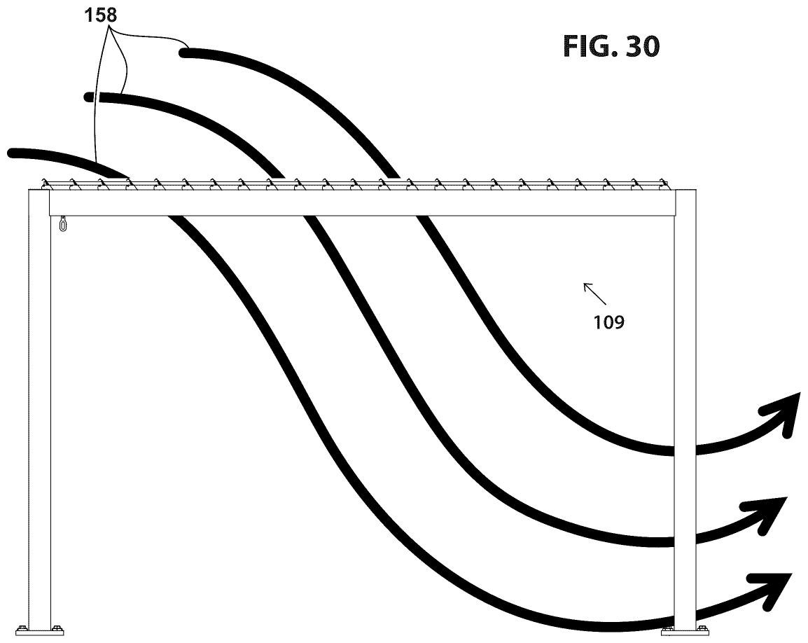

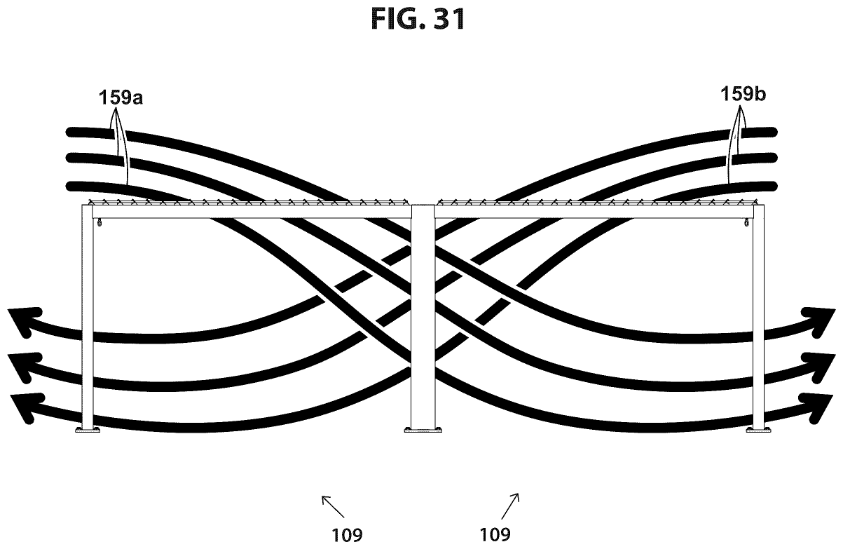

According to another aspect of the embodiments, the gazebo 1 can comprise a plurality of louver slats 110. Each of the plurality of louver slats 110 is configured to deploy and retract the awning 160. The louver slats 110 are further configured to channel and/or drain the rainwater. Specifically, in this regard, the gazebo 1 can direct rainwater flow to gutters 104. More specifically, the gazebo 1 can direct rainwater flow to gutters 104 in the directions or arrows 721a, 154a, 154b (see, e.g., FIGS. 115-118). Moreover, the louver slats 110 can be configured to direct the wind-flow. Specifically, in this manner, the gazebo 1 can be configured to direct and redirect the wind-flow in the directions of arrows 156a, 156b, 157, 158, 159a, and 159b (see, e.g., FIGS. 26-31). Moreover, and as best shown in FIG. 15, the leading edges 111 of the louver slats 110 can secure one or more projector screens 167a. In some embodiments, and as best shown in FIG. 95, one or more awnings 160 can hang from the leading edges 111, in the direction of arrows 179a, 179b. Further, the louver slats 110 can be robot-assembled. In some embodiments, a plurality of end caps 114 are secured onto the louver slats 110.

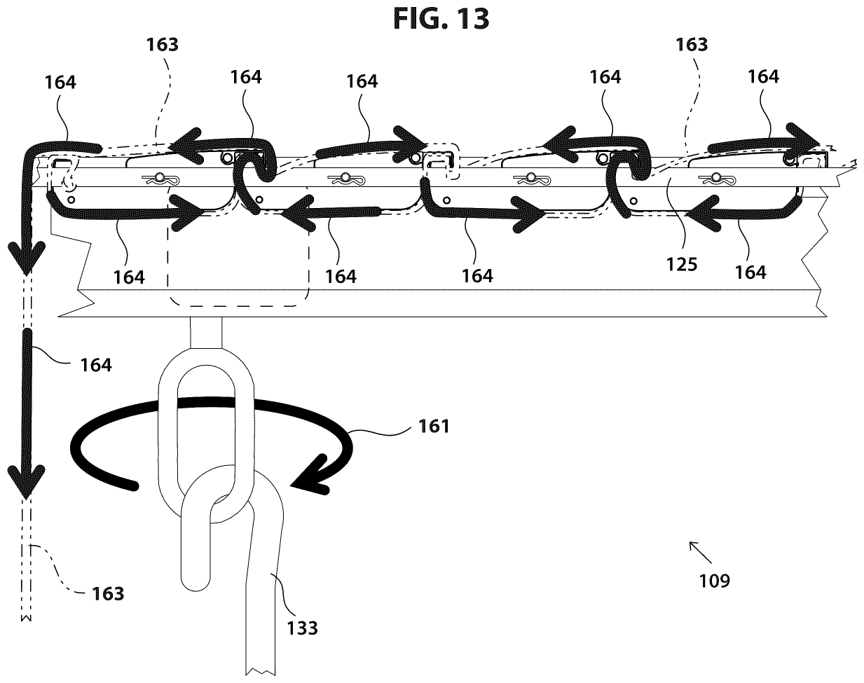

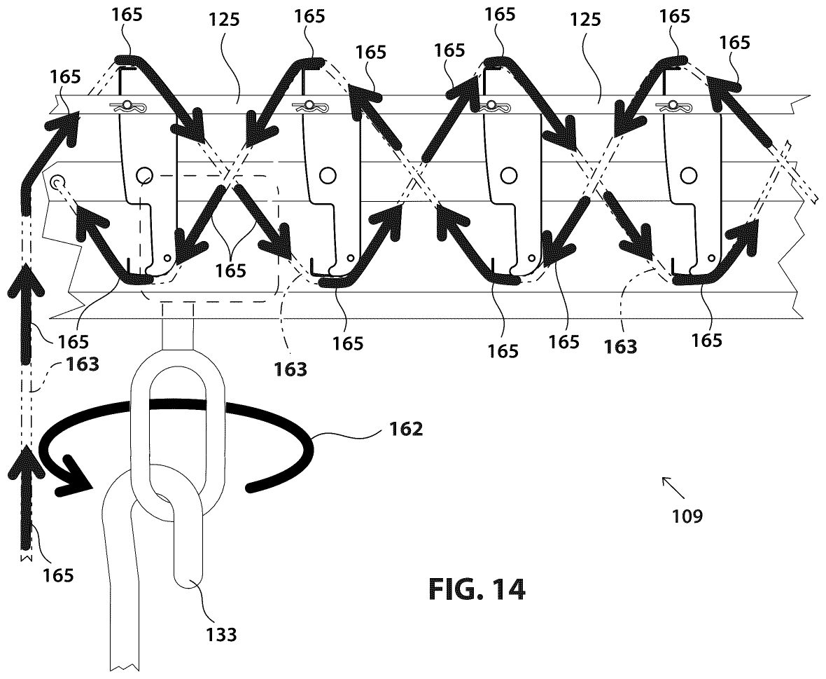

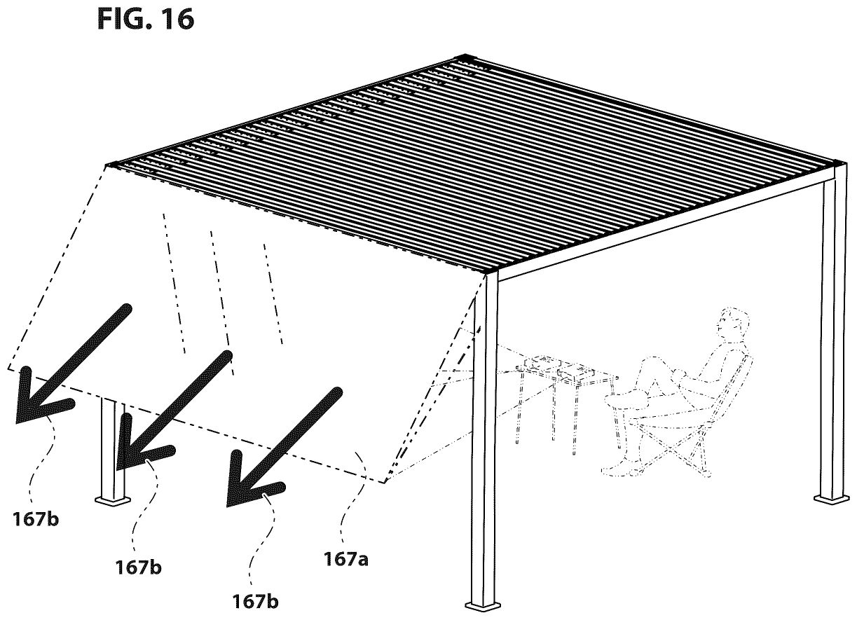

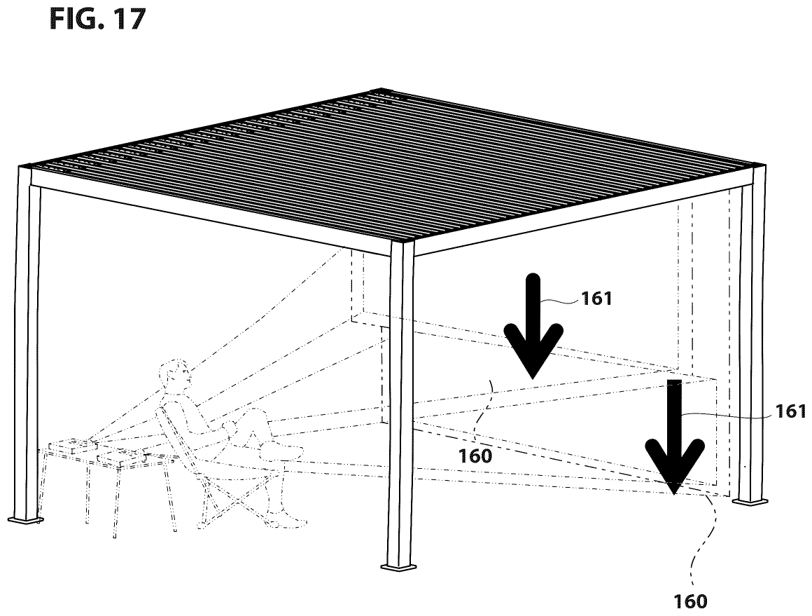

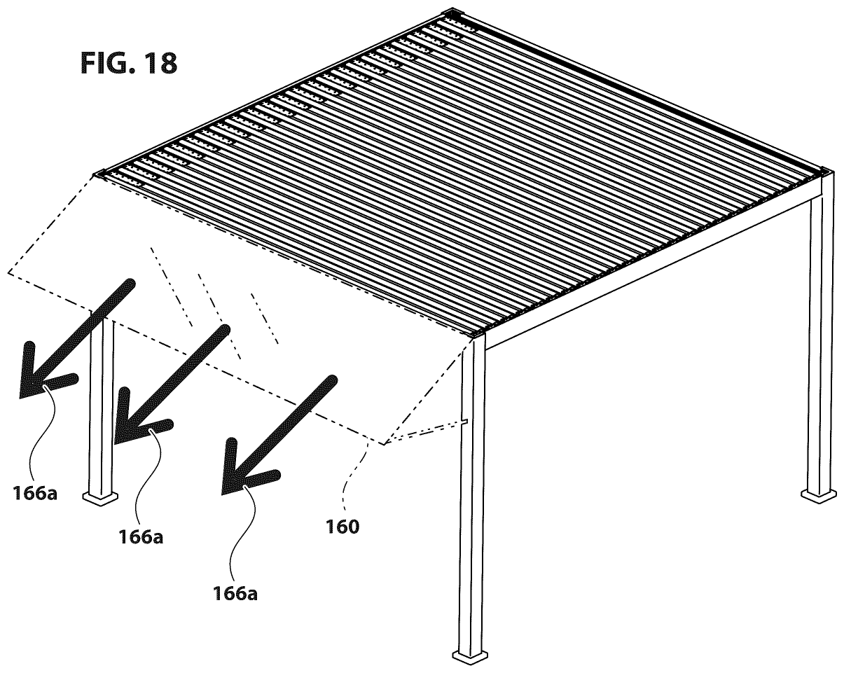

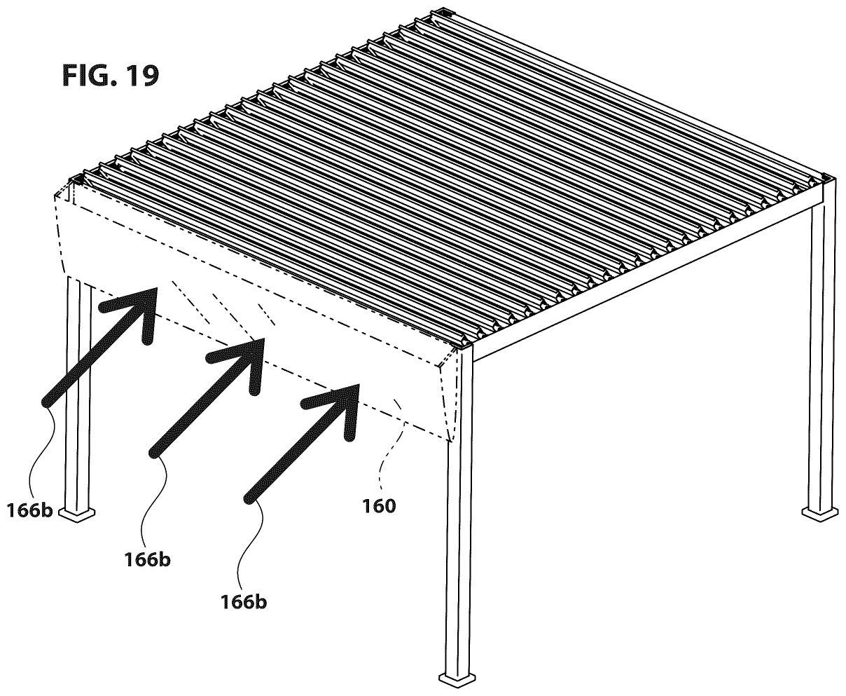

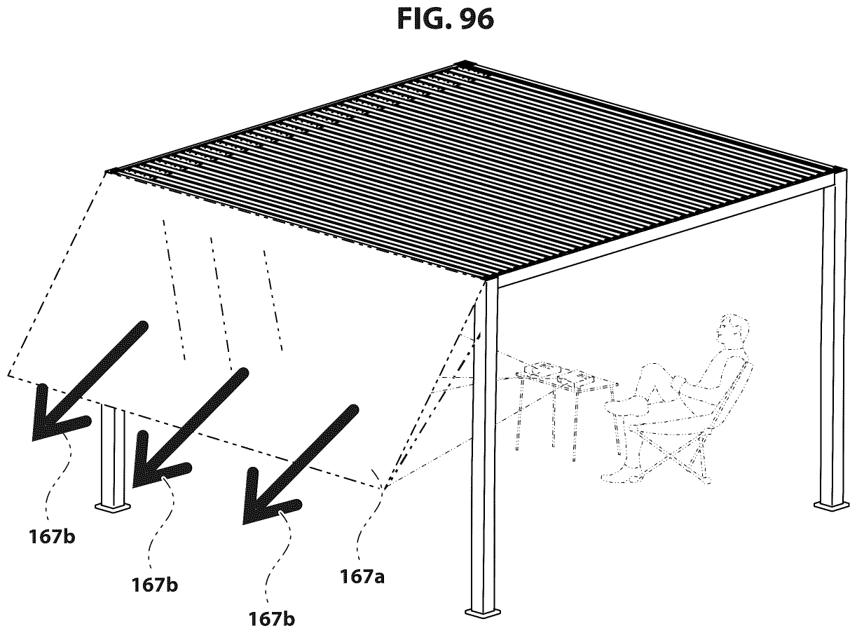

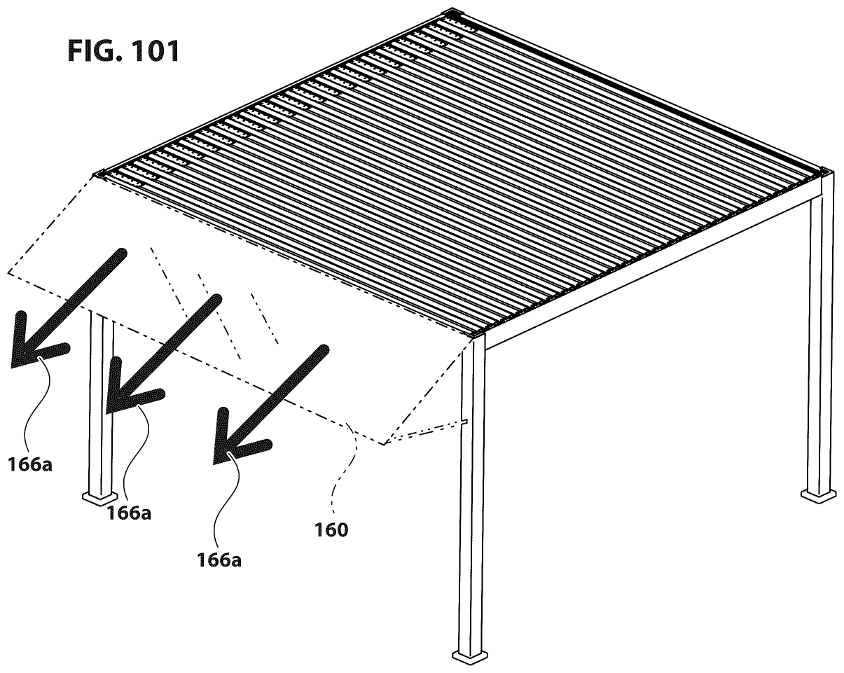

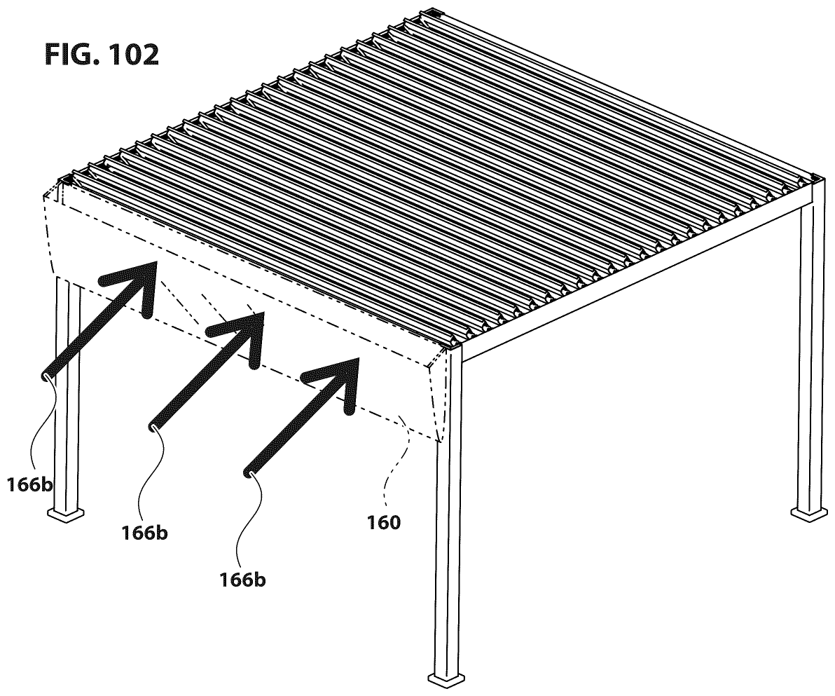

With reference to FIGS. 13, 14, 17-19, and 99-102, the gazebo 1 can be configured to deploy and/or retract the awning 160 by either turning crank tool 133 in the directions of arrows 161 or 162, pulling or relaxing cord 163 in the directions of arrows 164 or 165, or deploying and/or retracting the awning 160 in the directions of arrows 166a and 166b. In some embodiments, the gazebo 1 is configured to deploy and/or retract projector screens 167a in the direction of arrow 167b (see FIGS. 16 and 96).

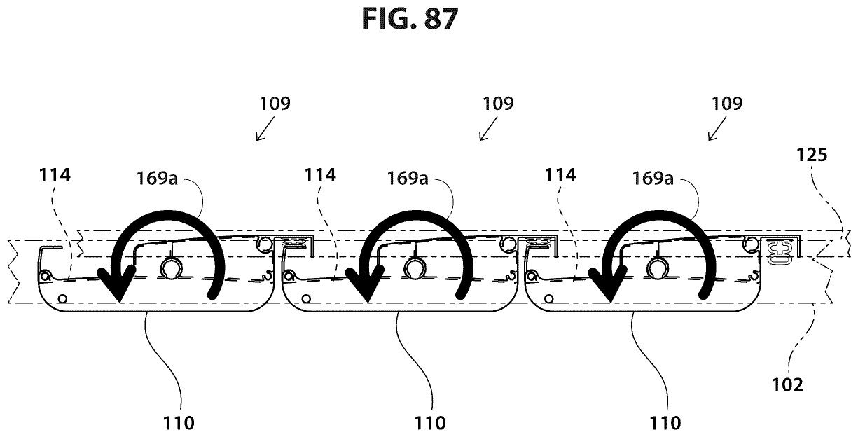

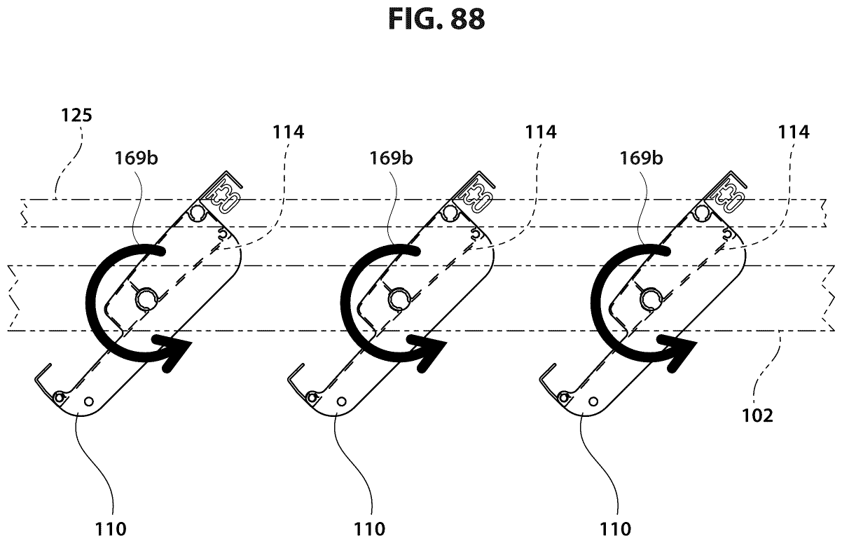

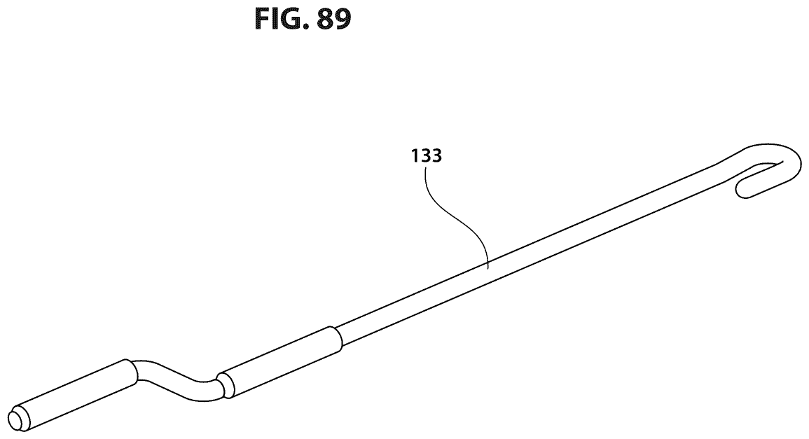

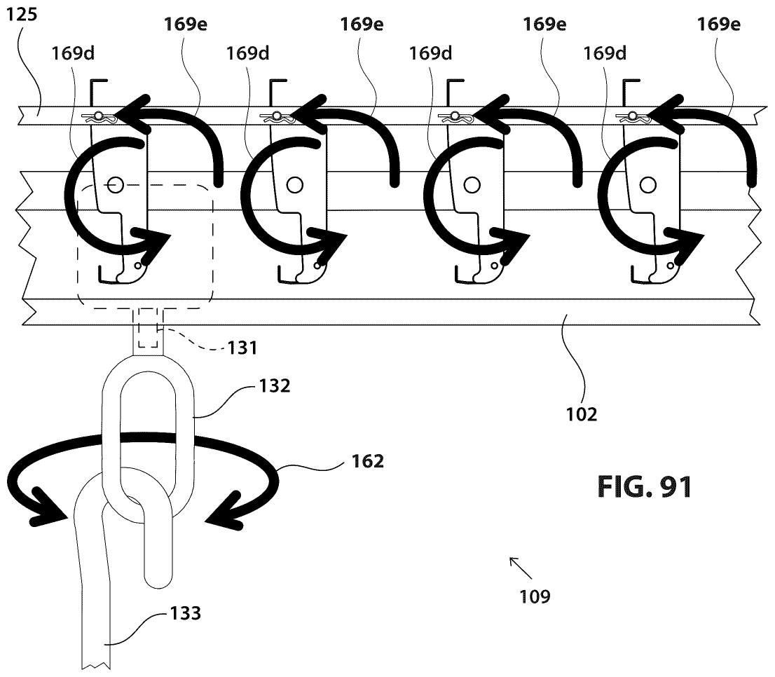

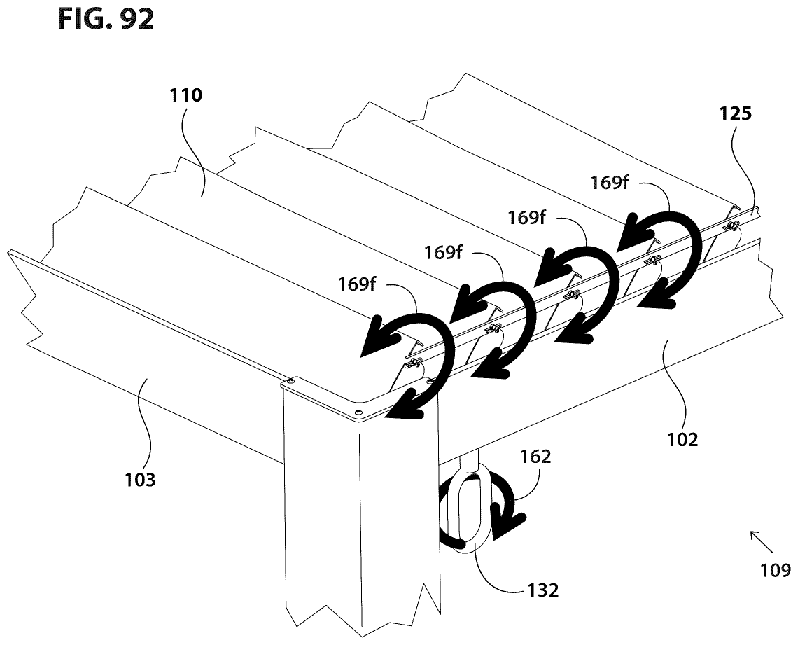

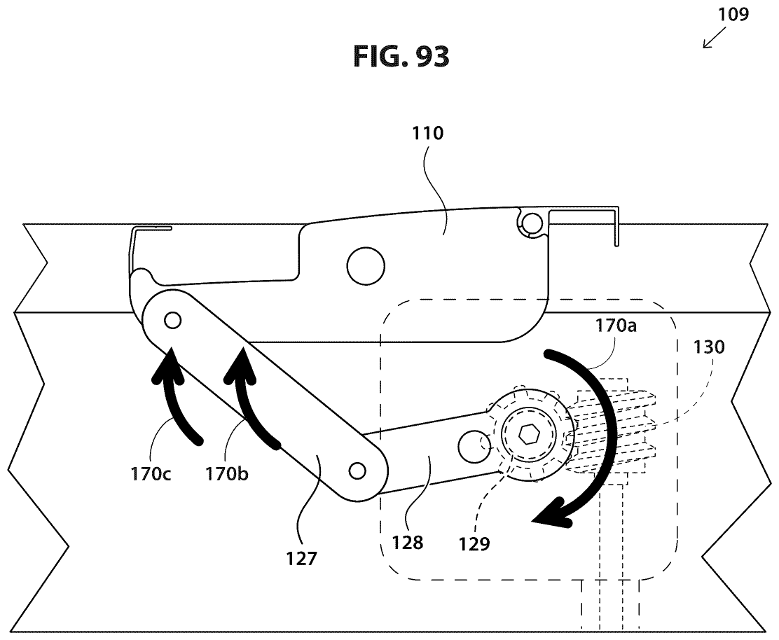

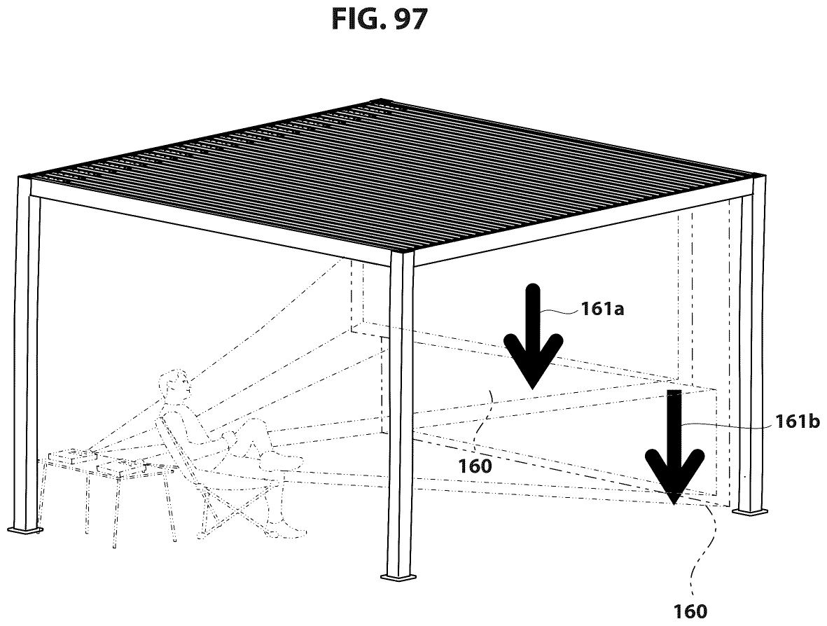

In some embodiments, projector screens 167a can hang from the gazebo 1 in the directions of arrows 159a, 159b, 161a, 161b, and/or 167b (see FIGS. 15, 16, and 97). In some embodiments, the gazebo 1 further comprises a multi-louver-slat-control bar 125 (also referred to as a “control bar 125”), which allows the gazebo 1 to control louver slats 110 so as to simultaneous open and close the louver slats 110 in the direction of arrows 161, 162, 169a, 169b, 169c, 169d, 169e, 169f, 170a, 170b, 170c, 170d, 170e, and 170f (see FIGS. 87-94). Specifically, and with reference to FIGS. 87-94, the gazebo 1 can cause the louver slats 110 to simultaneously close in the direction of arrows 161, 162, 169a, 169b, 169c, 169d, 169e, 169f, 170a, 170b, 170c, 170d, 170e, and 170f so as to protect the gazebo 1 from weather. More specifically, and still with reference to FIGS. 87-94, the gazebo 1 can cause the louver slats 110 to simultaneously open and close to direct and redirect wind in the direction of arrows 161, 162, 169a, 169b, 169c, 169d, 169e, 169f, 170a, 170b, 170c, 170d, 170e, and 170f. Further, the gazebo 1 can cause the louver slats 110 to simultaneously open and close so as to deploy and retract the awning 160 in the directions of arrows 166a and 166b (see FIGS. 13, 14, 18, 19, and 99-102).

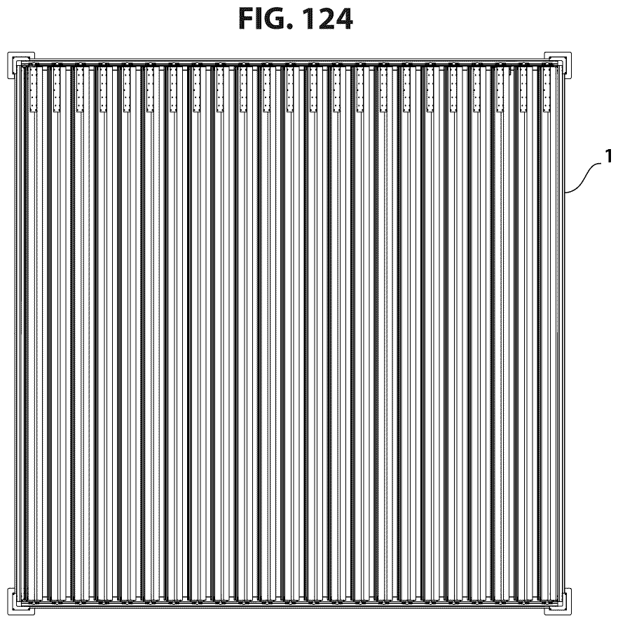

According to yet another aspect of the embodiments, the gazebo 1 can comprise a plurality of double-wide multi-gazebo-connecting multi-angle-allowing coupling posts 135. In this manner, the gazebo 1 can connect two or more gazebos 1 in multiple configurations (see FIGS. 1-12, 20, and 119-124, and 125) and/or at multiple angles (see, e.g., FIGS. 4-12, 20, 122-124, and 125).

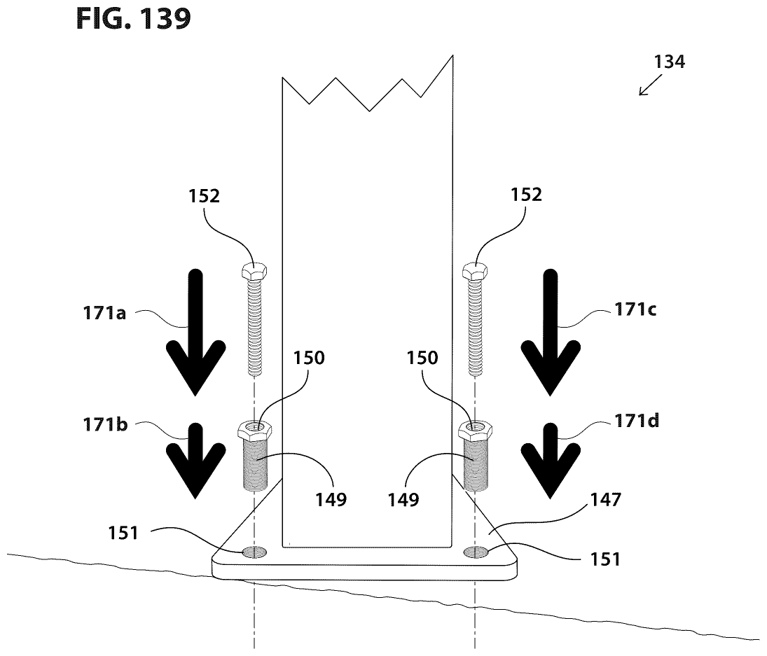

In some exemplar embodiments, the gazebo 1 can include a plurality of sleeve screws 149. The sleeve screws 149 can be configured so as to be adjust the height and/or angle of the gazebo 1, and can be internally and externally threaded. In this way, the gazebo 1 can be capable of leveling itself when on an uneven surface in the directions of arrows 171a, 171b, 171c, and 171d (see FIGS. 139-141). In some embodiments, the gazebo 1 can be capable of leveling itself when on a slanted surface in the directions of arrows 171a, 171b, 171c, and 171d. In some embodiments, the gazebo 1 can provide a means to interactively level itself once the gazebo 1 is deployed in the directions of arrows 171a, 171b, 171c, and 171d. In some embodiments, the gazebo 1 can be capable of leveling of each individual post for maximum control in the directions of arrows 171a, 171b, 171c, and 171d.

An example embodiment of the gazebo 1 can comprise one or more of the following: following: the gutter-beam system 101, the louver-slat system(s) 109, the control system 121, and a multi-angle-allowing-coupling-post post-leveling base system 134 that allows the height and/or angle of the gazebo to be adjusted.

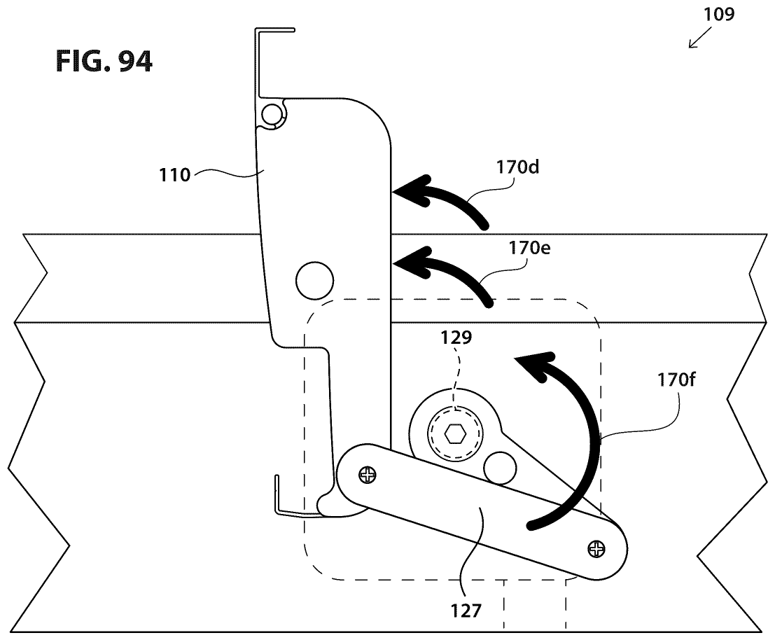

Referring to FIGS. 1-94, the gazebo 1 can include the gutter-beam system(s) 101 including one or more side gutter beams 102, one or more end gutter beams 103, one or more draining gutters 104, one or more ejecting tunnels 105 to channel and direct rainwater, gutter-beam-securing bars 106, reversible spacers 107, and gutter-beam connecting-and-securing screws 108, each of which can be robotically assembled.

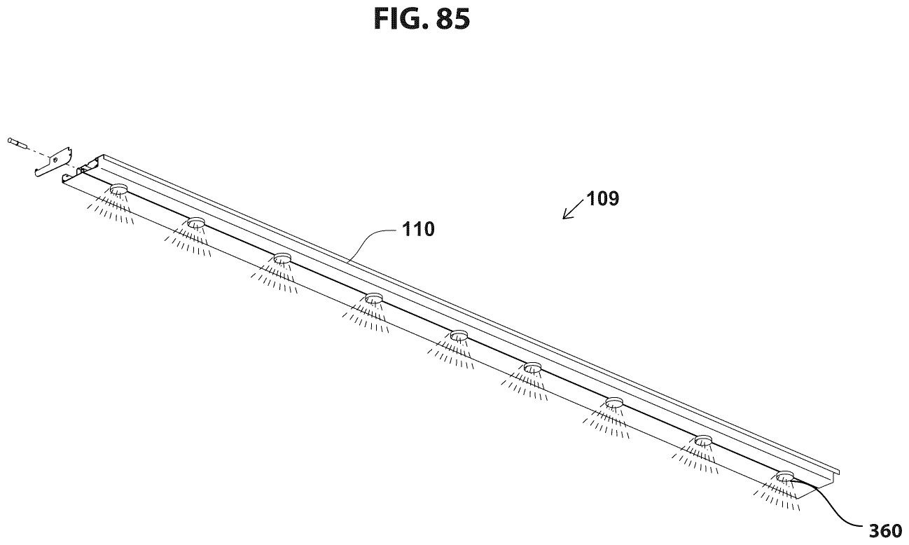

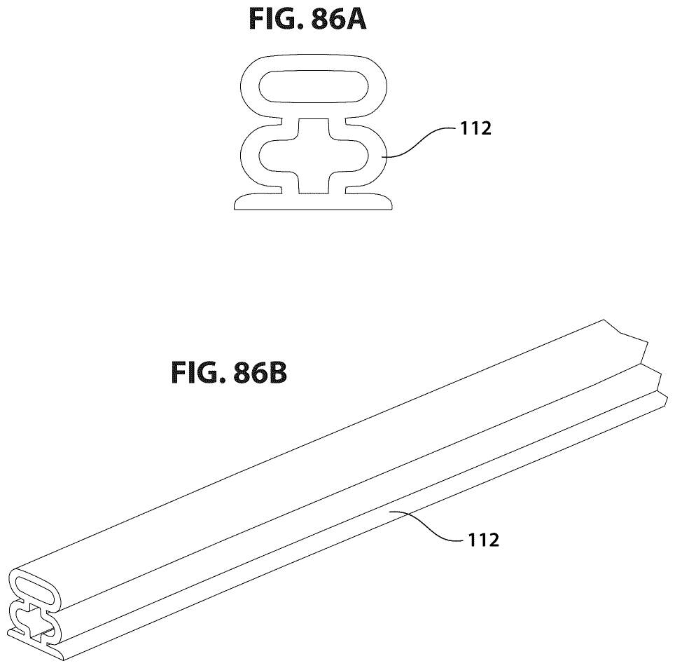

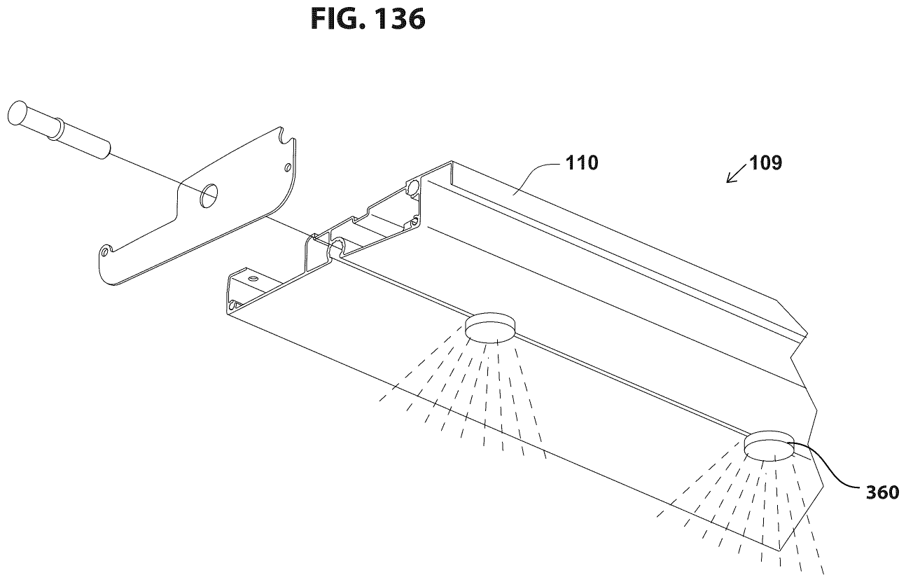

In some exemplar embodiments, the louver-slat system(s) 109 can include one or more of the following: louver slats 110; multi-screen-securing leading edges 111 configured to direct wind-flow and channel and/or drain rainwater; insulation strips 112 configured to seal against rainwater and wind and prevent rattling; louver-blade wind- and rainwater-channeling trailing edges 113; louver-slat end caps 114; louver-slat-supporting insertion axels 115; louver-slat-rotation receiving holes 116; louver-slat-rotation cradle axels 117; louver-slat-rotation open cradles 118; louver-slat-rotation-cradle caps 119; and, louver-slat-rotation closed cradles 120. In some embodiments, the louver-slat system can further include one or more light-emitting diode (LED) lights 360, as best shown in FIGS. 85 and 136.

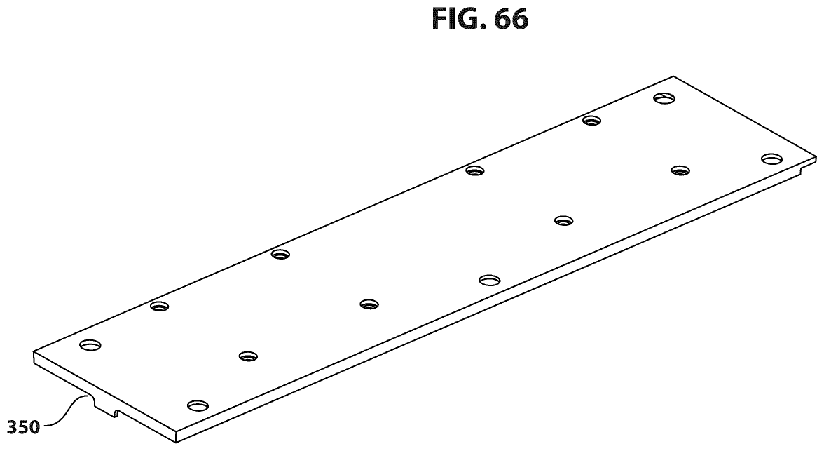

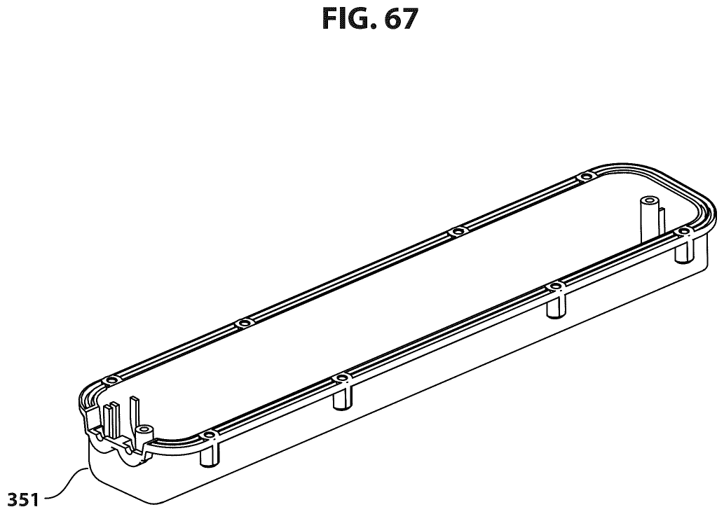

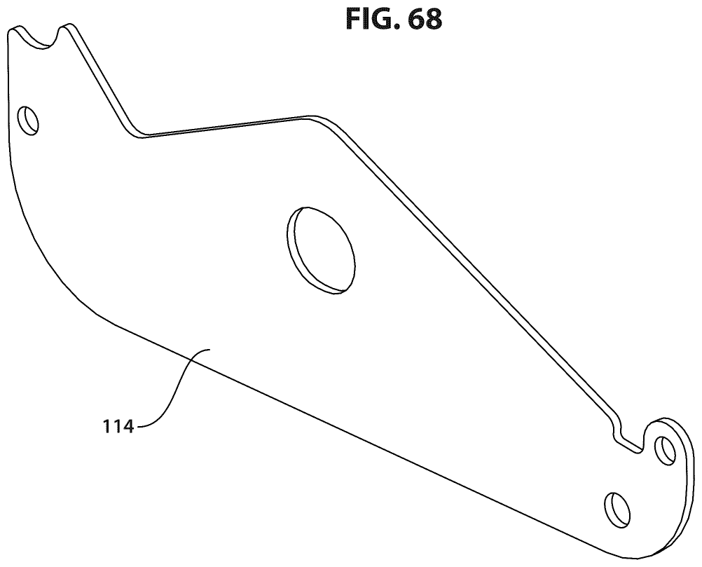

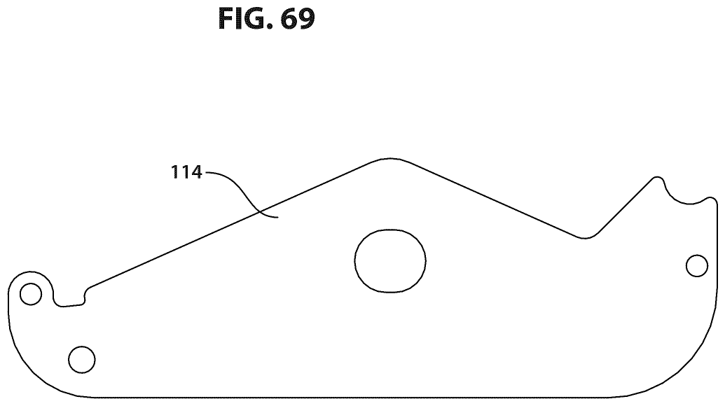

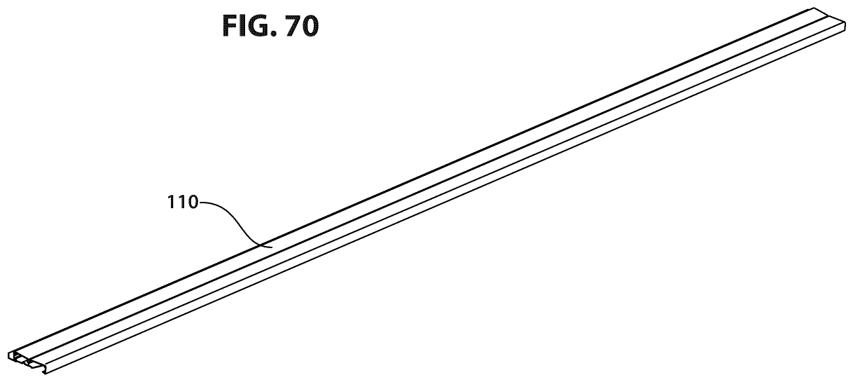

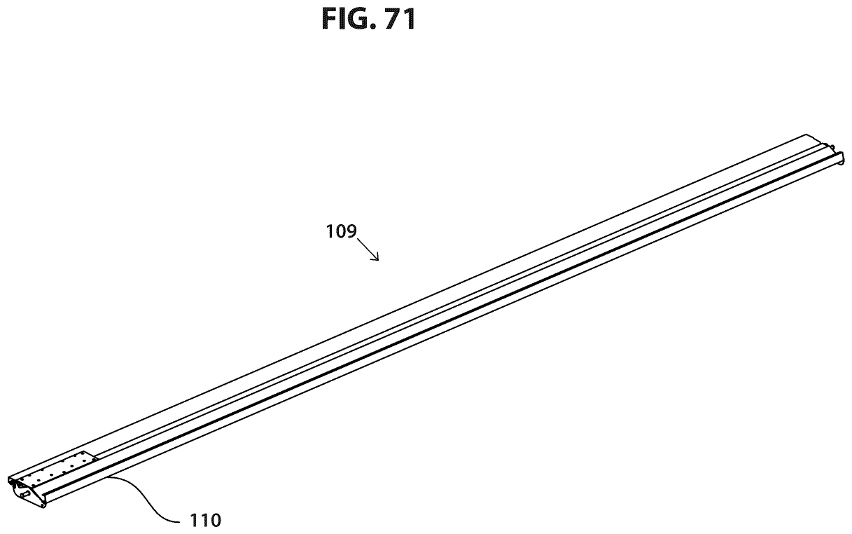

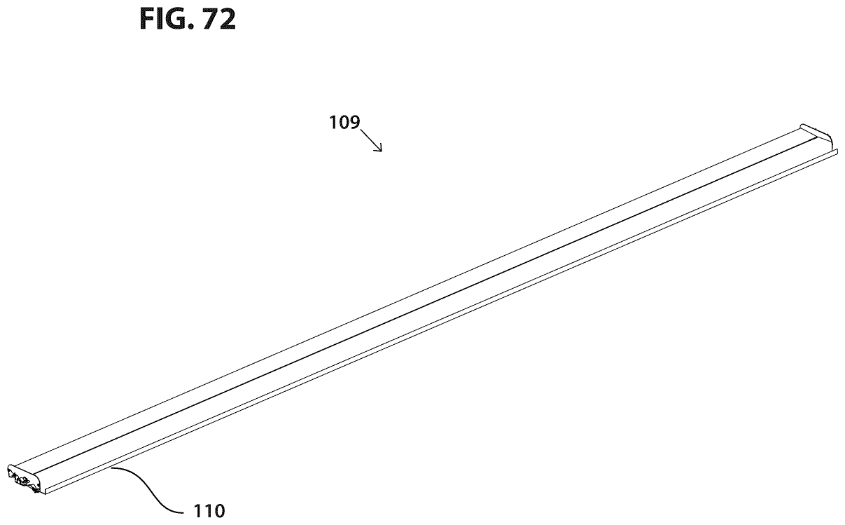

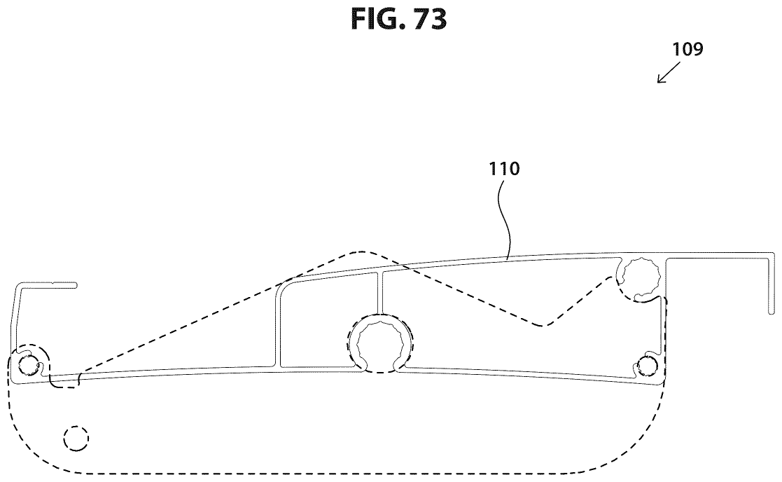

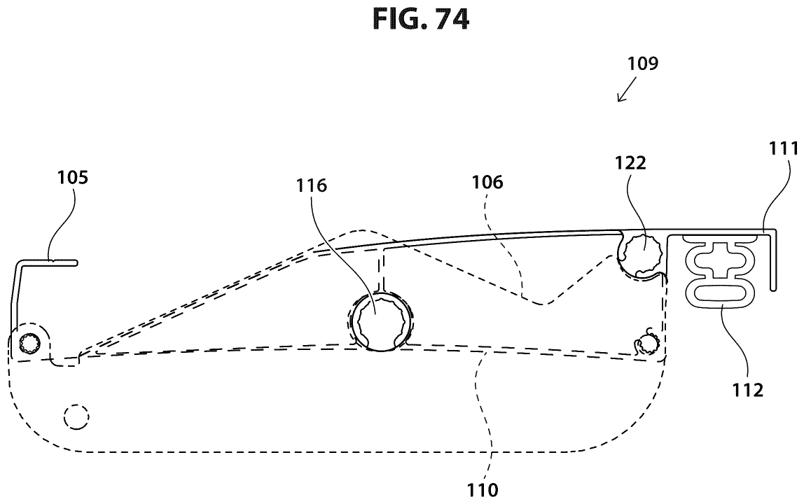

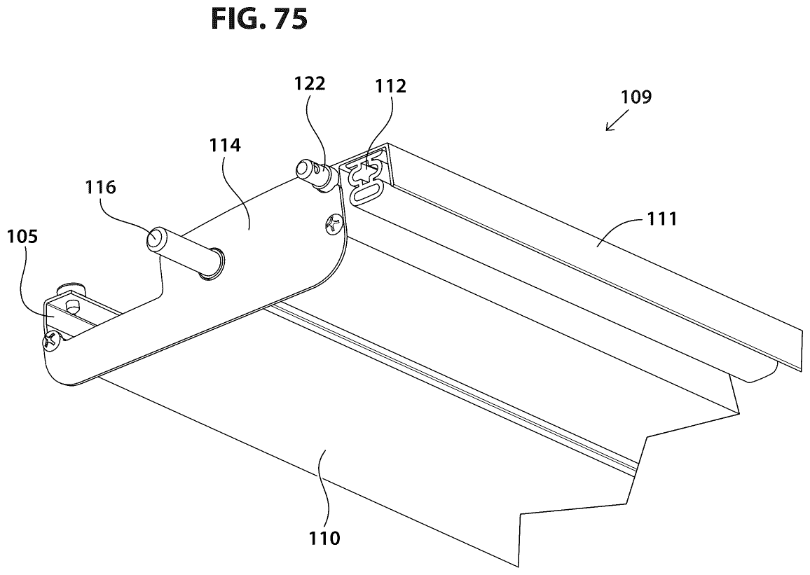

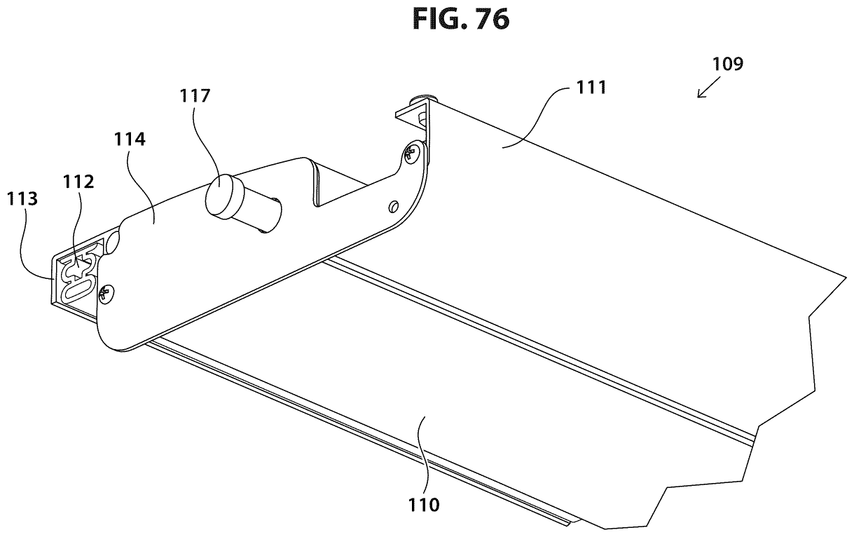

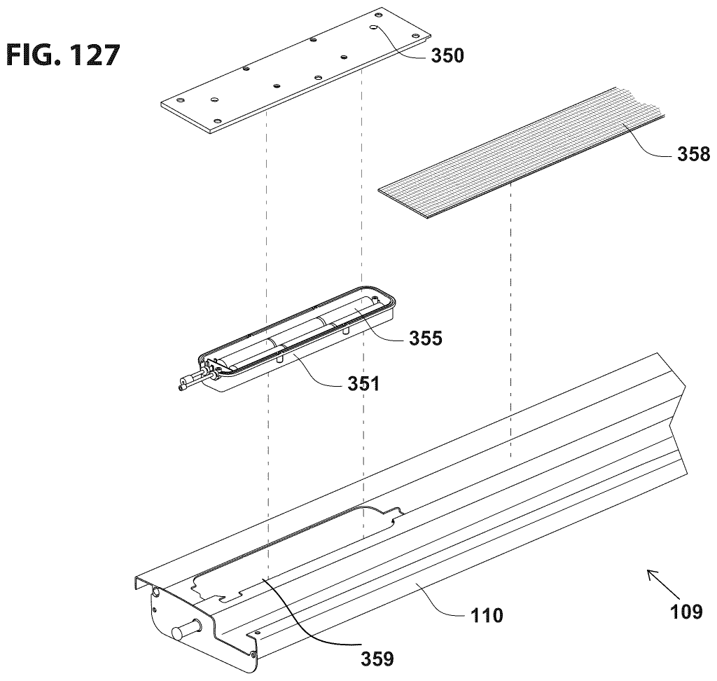

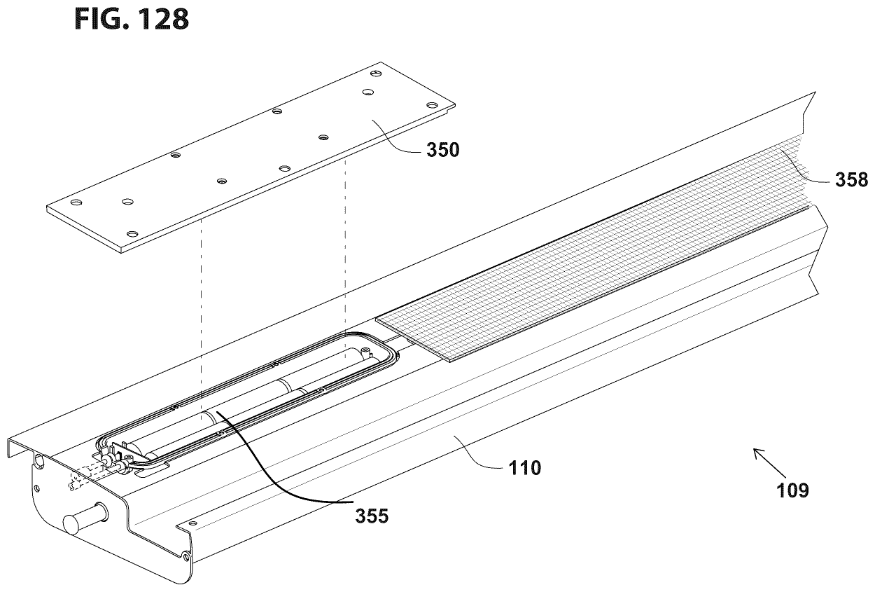

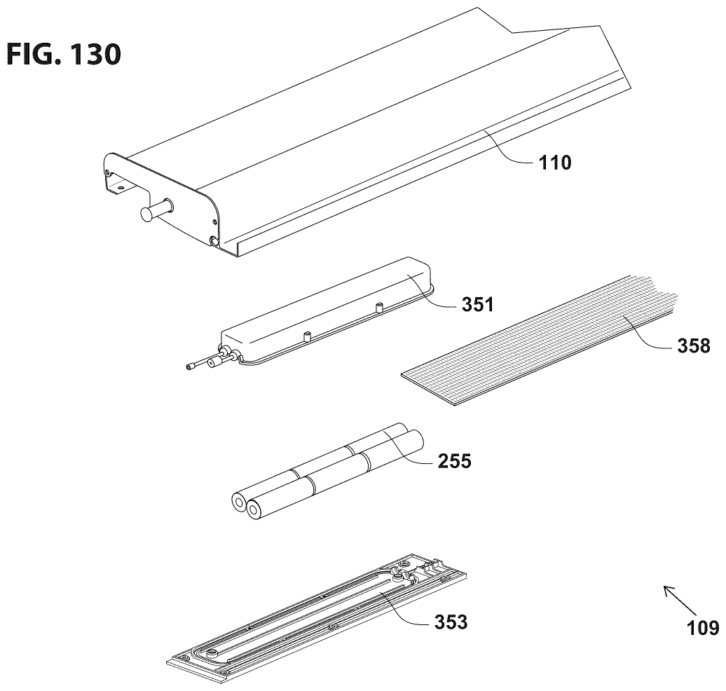

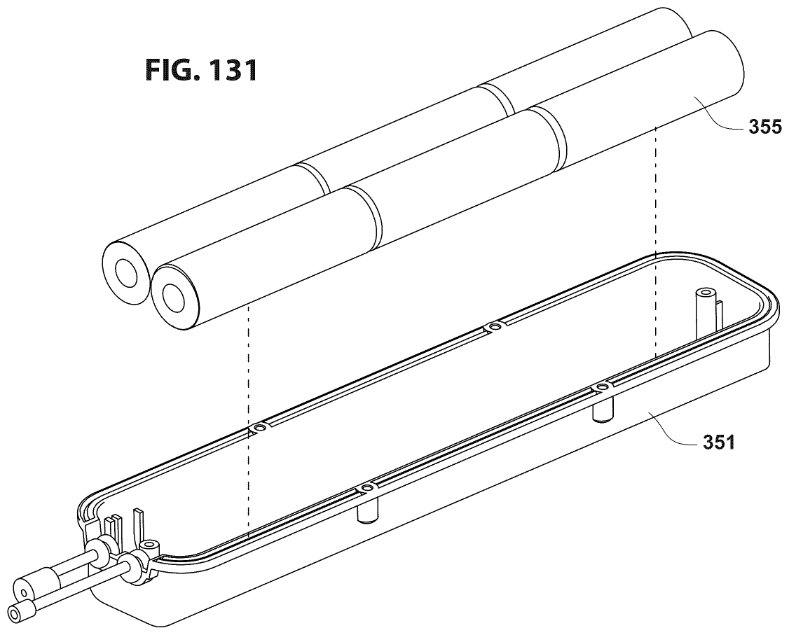

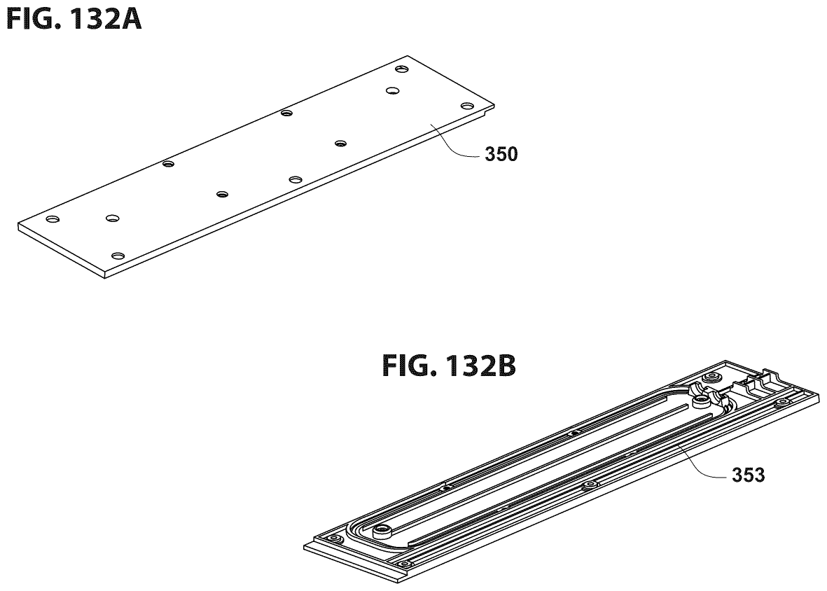

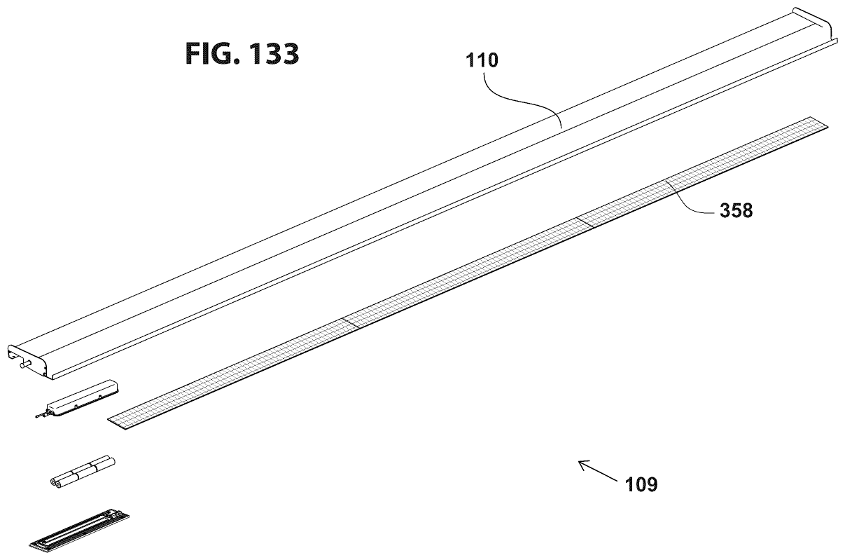

In some embodiments, and with reference to FIGS. 66, 67, and 126-133, the louver-slat system 109 can comprise one or more batteries 355. The one or more batteries 355 can be disposed within a battery compartment housing 351, as shown in FIGS. 67 and 131. Further a battery compartment cover 350 (FIGS. 66 and 132A) can mate with the battery compartment housing 351 so as to seal the one or more batteries from the external surroundings. In some embodiments, the battery compartment housing 351 can comprise a battery compartment bottom 353 (FIG. 132B) to further seal the batteries 355 disposed therein from the external surroundings.

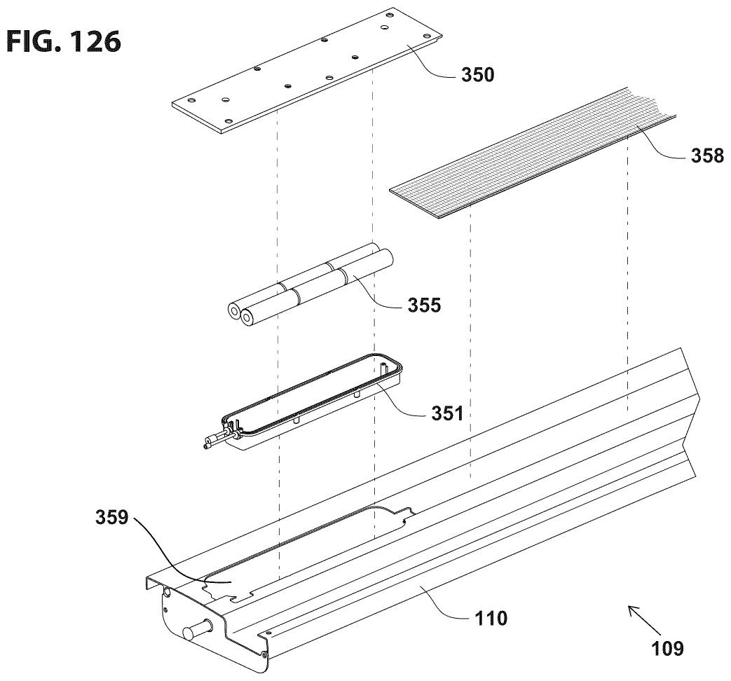

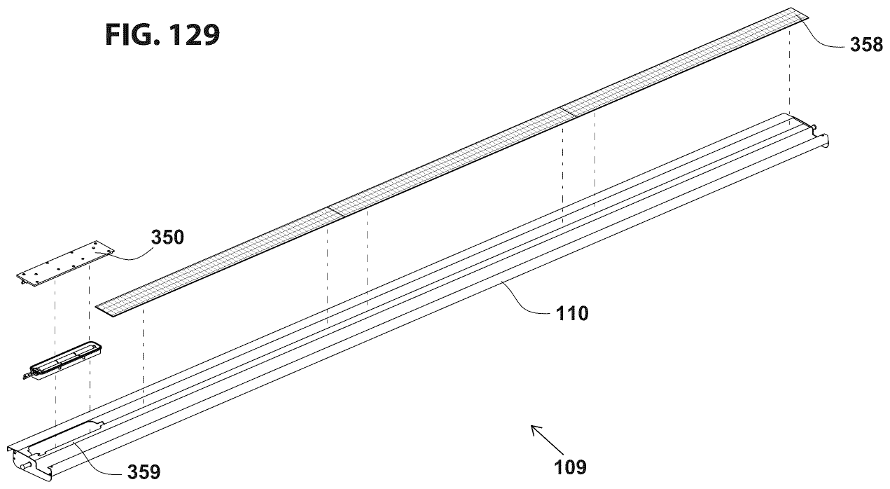

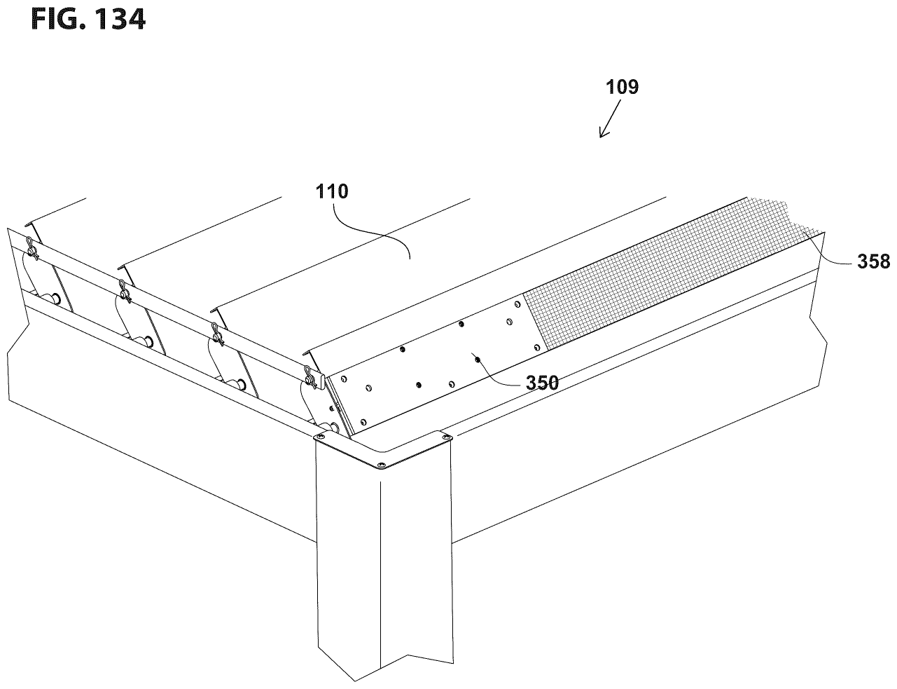

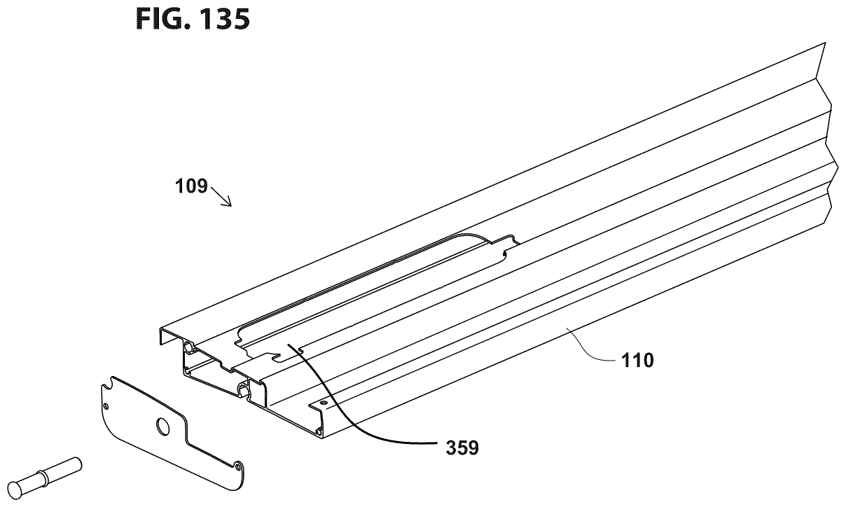

In some embodiments, the louver slats 110 can comprise a reservoir 359 configured to house the battery compartment housing 351 (best shown in FIGS. 126, 129, and 135). Further, and as shown in FIGS. 126-129, and 133-134, the louver-slat system 109 can include a solar panel. In some embodiments, the solar panel 358 is installed adjacent to the one or more batteries 355 on the louver slat 110. As best shown in FIG. 129, the solar panel 358 can extend to a first end of the louver slat 110.

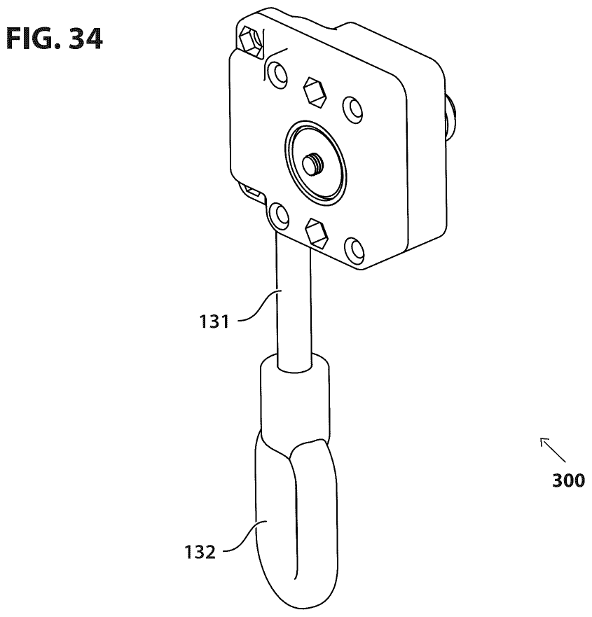

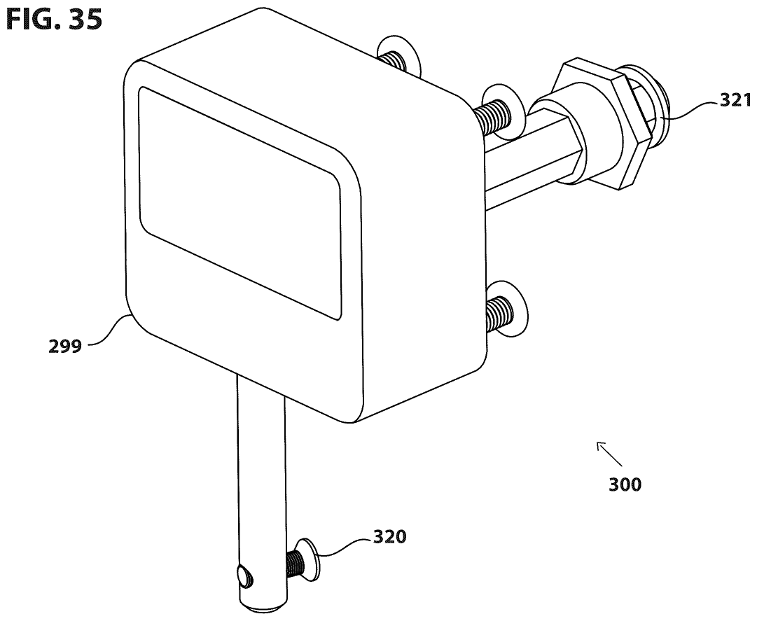

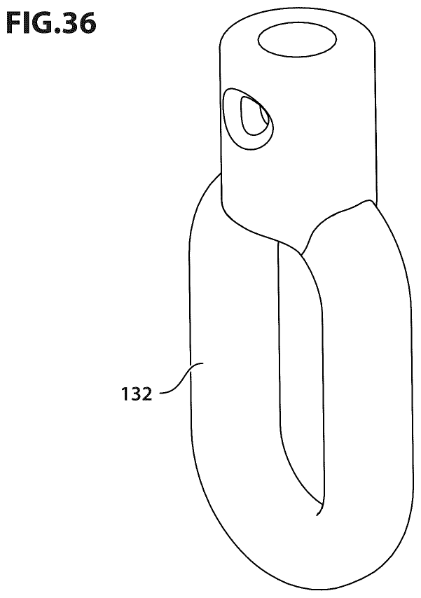

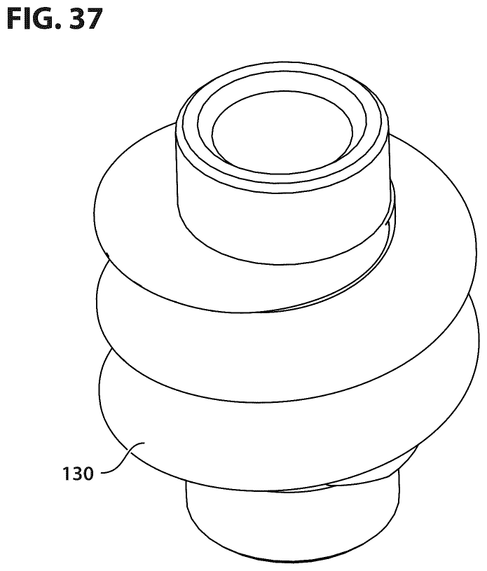

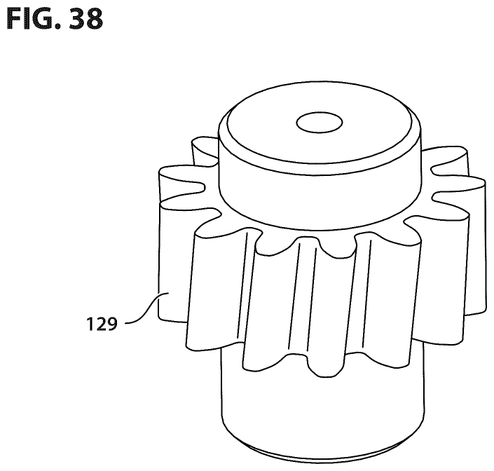

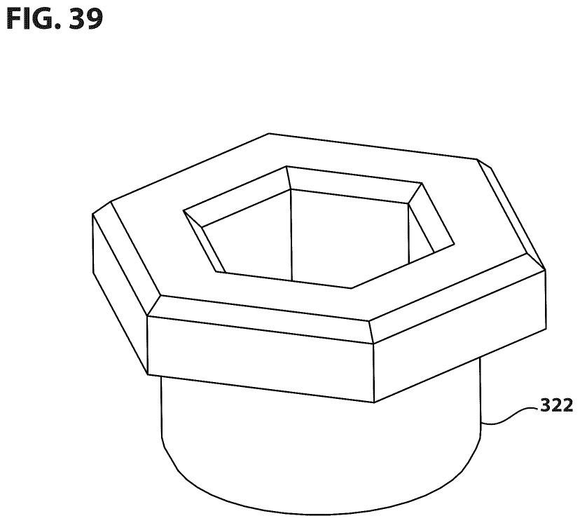

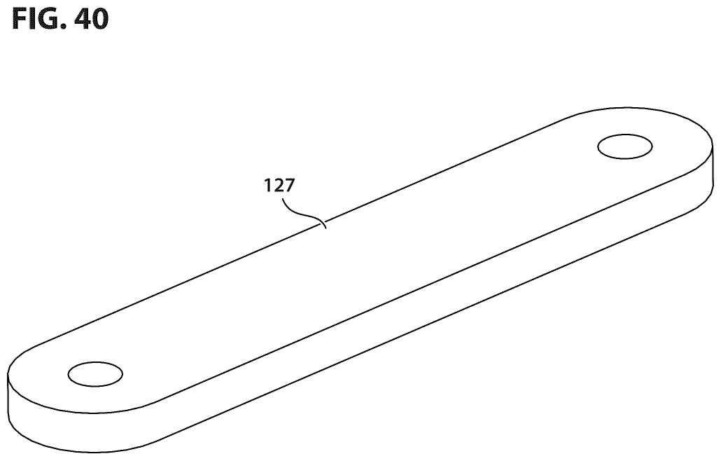

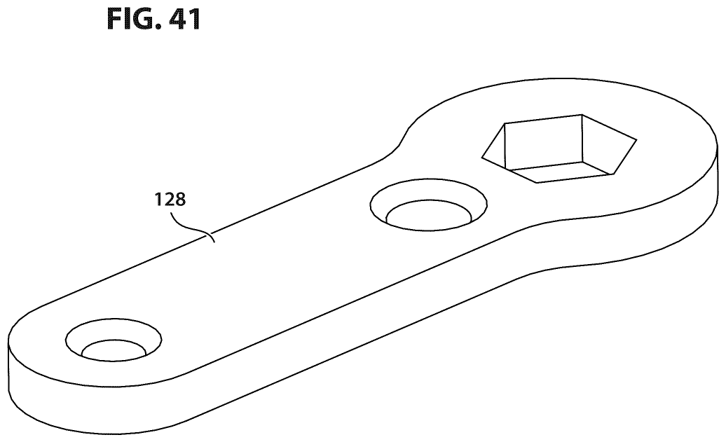

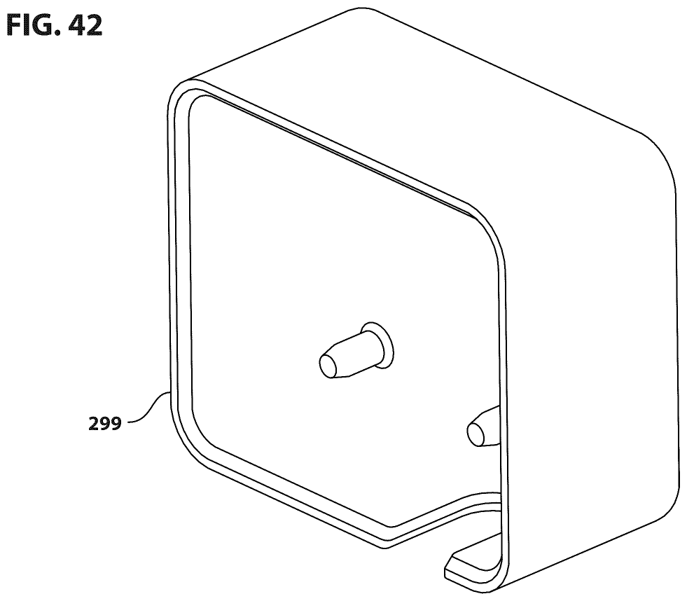

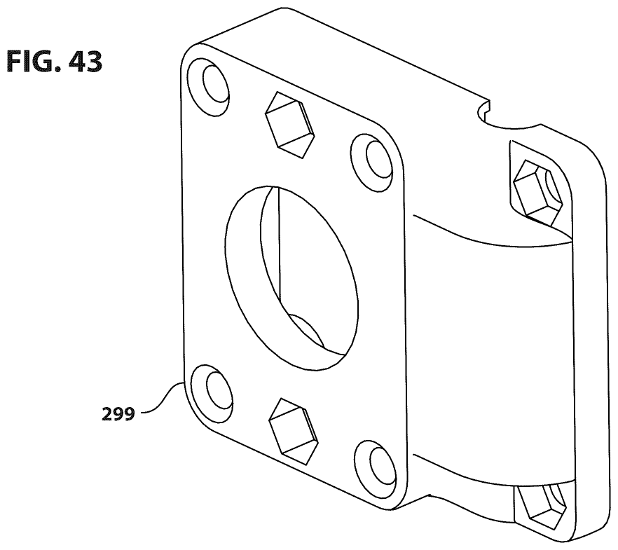

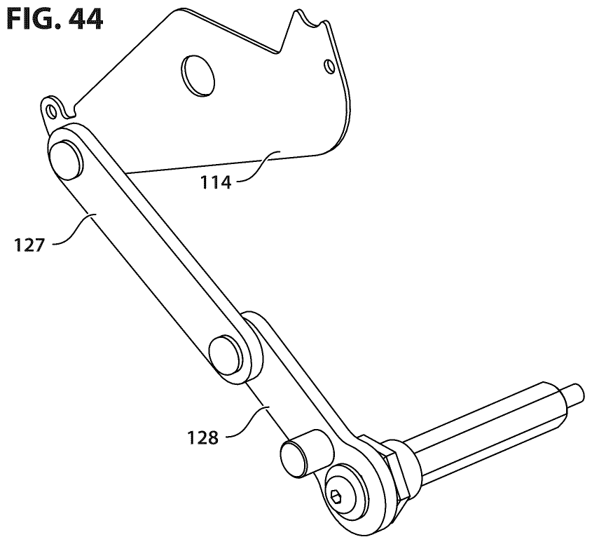

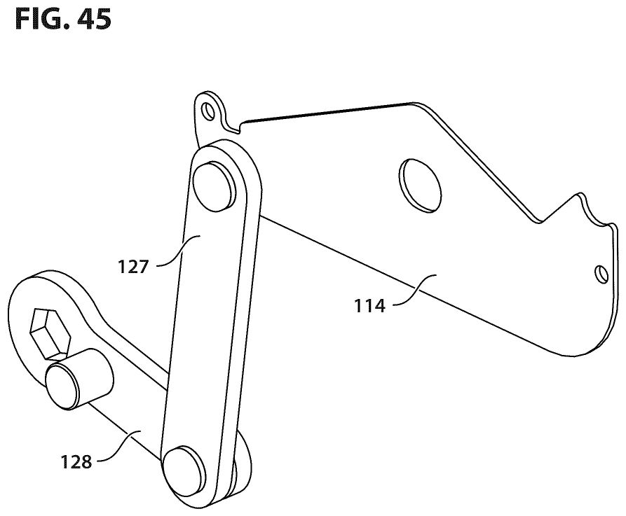

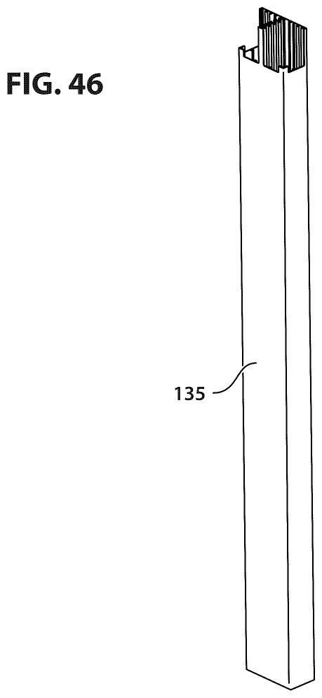

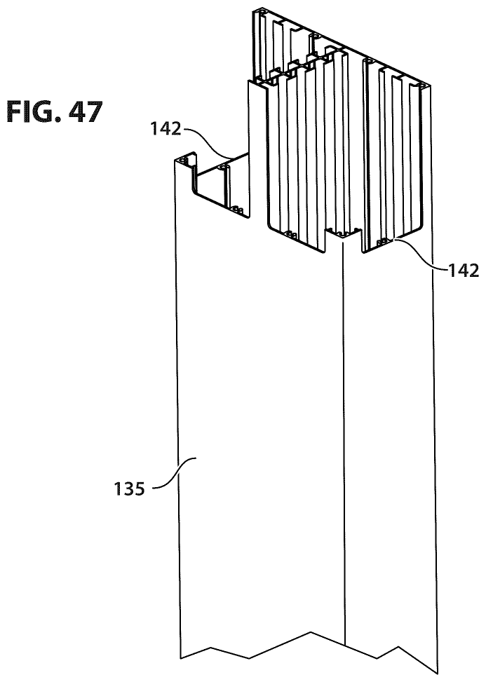

In some example embodiments, the control system(s) 121 can comprise the following: multi-louver-slat-control axels 122; multi-louver-slat-control-axel cotter-pins 123; multi-louver-slat-control-axels cotter-pin holes 124; a multi-louver-slat-control bar 125; multi-louver-slat-control-bar axel-insertion holes 126; a multi-louver-slat-control first linkage arm 127; a multi-louver-slat-control second linkage arm 128; a linkage-arm gear 129; a worm gear 130; a worm-gear axel 131; a multi-louver-slat-control adjustable coupling ring 132; and, a crank tool 133. The crank tool 133 is configured to be stowable, removable, raise and lower multiple screens 167a, and/or raise and lower multiple louver slats 110. Further the crank tool 133 can transition the awning 160 between the deployed configuration and the retracted configuration, e.g., automatically. Specifically, in some embodiments, and as best shown in FIG. 34, the control system 121 includes a cranking mechanism assembly 300 which comprises the worm-gear axel 131 and multi-louver-slat-control adjustable coupling ring 132. Further, and as best shown in FIGS. 35, 42, and 43, the cranking mechanism assembly 300 can comprise a cranking mechanism housing 299 configured to house a gear box system, actuator or the like (not depicted). Specifically, and as best depicted in FIG. 35, the cranking mechanism assembly 300 can have one or more screws 320 configured to connect with the crank tool 133 (not shown) and rotate so as to cause an axel 321 extending horizontally relative to the cranking mechanism housing 299 to rotate, as well. Upon the axel 321 rotating, the louver slats 110 are configured to open and/or close. FIG. 39 depicts a linkage component 322 that can be used with the cranking mechanism assembly 300 so as to open and/or close the louver slat(s) 110.

The multi-angle allowing-coupling-post post-leveling base system(s) 134 can comprise: one or more of the double-wide multi-gazebo-connecting multi-angle-allowing coupling posts 135; T-shaped coupling-post caps 136; corner posts 137; L-shaped corner-post caps 138; center posts 139; center-post caps 140; gutter-beam coupling caps 141; gutter-beam cradles 142; gutter-beam-securing-bar receivers 143; coupling-post base-plate covers 144; coupling-post base-plates 145; center-and-corner-post baseplate covers 146; corner-and-central-post base plates 147; discrete rainwater drains 148; sleeve screws 149; screw holes 150 configured to be height adjustable, angle adjustable, and internally and externally threaded; anchoring-screw holes 151; and, anchoring screws 152.

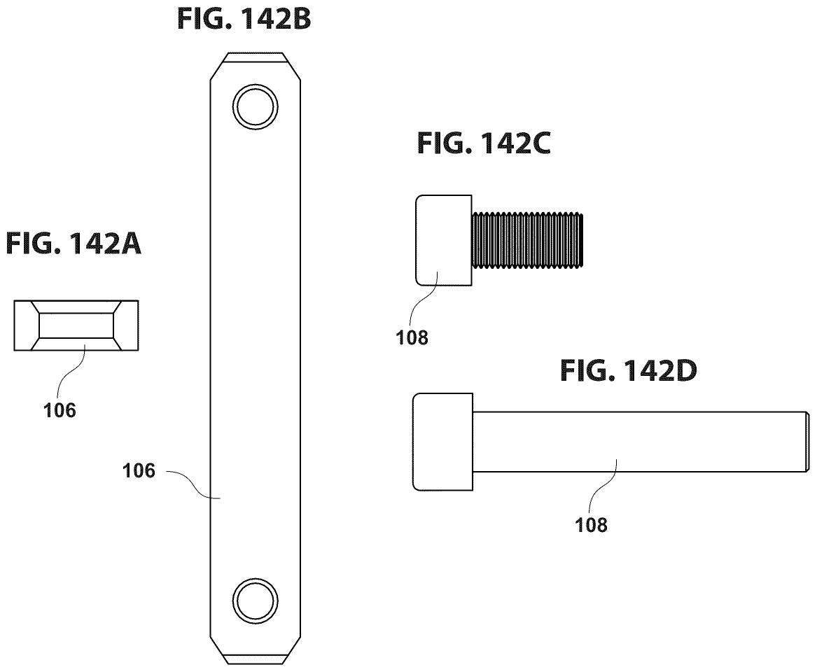

Referring to FIGS. 1-94, the gutter-beam system(s) 101 may be made of the combined materials of its components. In some embodiments, the side gutter beams 102 may be made of metal. In some embodiments, the end gutter beams 103 may be made of metal. In some embodiments the gutters 104 may be made of metal. In an example embodiment, the ejecting tunnels 105 may include empty space. In some embodiments, the gutter-beam-securing bars 106 (see, e.g., FIGS. 142A-142B) may be made of metal. The reversible spacers 107 may be made of metal or plastic. The installed screws 108 (see, e.g., FIGS. 142C-142D) may be made of metal.

In some embodiments, the louver-slat system(s) 109 may be made of the combined materials of its components. In some embodiments, the louver slats 110 may be made of metal. In some embodiments, the leading edges 111 may be made of metal. In some embodiments, the insulation strips 112 may be made of the material of rubber or plastic. In some embodiments, the trailing edges 113 may be made of metal. In some embodiments, the louver-slat end caps 114 may be made of metal. In some embodiments, the louver-slat-supporting insertion axels 115 may be made of metal. In some embodiments, the louver-slat-rotation receiving holes 116 may be made of the material of empty space. In some embodiments, the louver-slat-rotation cradle axels 117 may be made of metal. In some embodiments, the louver-slat-rotation open cradles 118 may be made of metal. In some embodiments, the louver-slat-rotation-cradle caps 119 may be made of metal. In some embodiments, the louver-slat-rotation closed cradles 120 may be made of metal.

According to some exemplar embodiments, the control system(s) 121 may be made of the combined materials of its components. In some embodiments, the multi-louver-slat-control axels 122 may be made of metal. In some embodiments, the multi-louver-slat-control-axel cotter-pins 123 may be made of metal. In some embodiments, the multi-louver-slat-control-axel cotter-pin holes 124 may be made of the material of empty space. In some embodiments, the multi-louver-slat-control bar 125 may be made of metal. In some embodiments, the multi-louver-slat-control-bar axel-insertion holes 126 may include empty space. In some embodiments, the multi-louver-slat-control first linkage arm 127 may be made of metal. In some embodiments, the multi-louver-slat-control second linkage arm 128 may be made of metal. In some embodiments, the linkage-arm gear 129 may be made of metal. In some embodiments, the worm gear 130 may be made of metal. In an example embodiment, the worm-gear axel 131 may be made of metal. In some embodiments, the coupling ring 132 may be made of metal. In an example embodiment, the crank tool 133 may be made of metal.

Further, in some exemplar embodiments, the multi-angle-allowing post-and-base-leveling system(s) 134 may be made of the combined materials of its components. In an example embodiment, the coupling posts 135 may be made of metal. In an example embodiment, T-shaped coupling-post caps 136 may be made of metal. In an example embodiment, corner posts 137 may be made of metal. In an example embodiment, L-shaped corner-post caps 138 may be made of metal. In an example embodiment, center posts 139 may be made of metal. In an example embodiment, center-post caps 140 may be made of metal. In an example embodiment, gutter-beam coupling caps 141 may be made of metal. In an example embodiment, gutter-beam cradles 142 may be made of metal. In an example embodiment, gutter-beam-securing-bar receivers 143 may be made of metal. In an example embodiment, coupling-post base-plate covers 144 may be made of metal. In an example embodiment, coupling-post base-plates 145 may be made of metal. In an example embodiment, center-and-corner-post base-plate covers 146 may be made of metal or plastic. In an example embodiment, corner-and-central-post base plates 147 may be made of metal. In an example embodiment, discrete rainwater drains 148 may be made of the material of empty space. In an example embodiment, sleeve screws 149 may be made of metal. In an example embodiment, screw holes 150 may be made of the material of empty space. In an example embodiment, anchoring-screw holes 151 may be made of the material of empty space. In an example embodiment, anchoring screws 152 may be made of metal. Those of skill in the art will recognize that other materials of the multi-angle-allowing post-and-base-leveling system(s) 134 components can be utilized without departing from the scope of the disclosure.

Referring to FIGS. 1-94, the gutter-beam system(s) 101 may be formed into the combined shapes of its components. In an example embodiment, the side gutter beams 102 may be formed into the shape of a rectangle. In an example embodiment, the end gutter beams 103 may be formed into the shape of a rectangle. In an example embodiment, gutters 104 may be formed into the shape of a “L.” In an example embodiment, ejecting tunnels 105 may be formed into the shape of a square. In an example embodiment, securing bars 106 may be formed into the shape of a rectangle. In an example embodiment, reversible spacers 107 may be formed into the shape of a cylinder. In an example embodiment, screws 108 may be formed into the shape of a screw. Those of skill in the art will recognize that other shapes of the gutter-beam system 101 components can be utilized without departing from the scope of the disclosure.

In some embodiments, the louver-slat system(s) 109 may be formed into the combined shapes of its components. In an example embodiment, the louver slats 110 may be formed into the shape of a blade. In an example embodiment, leading edges 111 may be formed into the shape of a blade. In an example embodiment, insulation strips 112 may be formed into the shape of a rectangle. In an example embodiment, trailing edges 113 may be formed into the shape of a blade. In an example embodiment, louver-slat end caps 114 may be formed into the shape of a flat-wedge. In an example embodiment, louver-slat-supporting insertion axels 115 may be formed into the shape of a cylinder. In an example embodiment, louver-slat-rotation receiving holes 116 may be formed into the shape of a circle. In an example embodiment, louver-slat-rotation cradle axels 117 may be formed into the shape of a cylinder. In an example embodiment, louver-slat-rotation open cradles 118 may be formed into the shape of a cradle. In an example embodiment, louver-slat-rotation-cradle caps 119 may be formed into the shape of a rectangle. In an example embodiment, louver-slat-rotation closed cradles 120 may be formed into the shape of a tube. Those of skill in the art will recognize that other shapes of the louver-slat system(s) 109 components can be utilized without departing from the scope of the disclosure.

In some embodiments, the control system(s) 121 may be formed into the combined shapes of its components. In an example embodiment, the control axels 122 may be formed into the shape of a cylinder. In an example embodiment, multi-louver-slat-control-axel cotter-pins 123 may be formed into the shape of a cotter-pin. In an example embodiment, multi-louver-slat-control-axel cotter-pin holes 124 may be formed into the shape of a circle. In an example embodiment, multi-louver-slat-control bar 125 may be formed into the shape of a rectangle. In an example embodiment, multi-louver-slat-control-bar axel-insertion holes 126 may be formed into the shape of a circle. In an example embodiment, multi-louver-slat-control first linkage arm 127 may be flat in shape. In an example embodiment, multi-louver-slat-control second linkage arm 128 may be formed into the shape of a cylinder. In an example embodiment, linkage-arm gear 129 may be formed into the shape of a gear. In an example embodiment, worm gear 130 may be formed into the shape of a gear. In an example embodiment, worm-gear axel 131 may be formed into the shape of a cylinder. In an example embodiment, the coupling ring 132 may be formed into the shape of an oval. In an example embodiment, the crank tool 133 may be formed into the shape of a hook. Those of skill in the art will recognize that other shapes of the control system(s) 121 components can be utilized without departing from the scope of the disclosure.

In some embodiments, the multi-angle-allowing post-and-base-leveling system(s) 134 may be formed into the combined shapes of its components. In an example embodiment, coupling posts 135 may be formed into the shape of a rectangle or box. In an example embodiment, T-shaped coupling-post caps 136 may be formed into the shape of a “T.” In an example embodiment, corner posts 137 may be formed into the shape of a square or box. In an example embodiment, L-shaped corner-post caps 138 may be formed into the shape of a “L.” In an example embodiment, center posts 139 may be formed into the shape of a square or box. In an example embodiment, center-post caps 140 may be formed into the shape of a flat rectangle. In an example embodiment, gutter-beam coupling caps 141 may be formed into the shape of a flat rectangle. In an example embodiment, gutter-beam cradles 142 may be formed into the shape of an “L.” In an example embodiment, gutter-beam-securing-bar receivers 143 may be formed into the shape of a semi-box. In an example embodiment, coupling-post base-plate covers 144 may be formed into the shape of a rectangle. In an example embodiment, coupling-post base-plates 145 may be formed into the shape of a flat rectangle. In an example embodiment, center-and-corner-post base-plate covers 146 may be formed into the shape of a square. In an example embodiment, corner-and-central-post base plates 147 may be formed into the shape of a square. In an example embodiment, discrete rainwater drains 148 may be formed into the shape of a horseshoe. In an example embodiment, sleeve screws 149 may be formed into a tubular shape. In an example embodiment, the screw holes 150 may be formed into the shape of a circle. In an example embodiment, anchoring-screw holes 151 may be formed into the shape of a circle. In an example embodiment, anchoring screws 152 may be formed into the shape of a cylinder. Those of skill in the art will recognize that other shapes of the multi-angle-allowing post-and-base-leveling system(s) 134 components can be utilized without departing from the scope of the disclosure.

Referring to FIGS. 1-94, the gutter-beam system(s) 101 is (or, are, respectively) connected by the combined connections of its components. In an example embodiment, side gutter beams 102 are secured to corner posts 137. In an example embodiment, end gutter beams 103 are secured to corner posts 137. In an example embodiment, gutters 104 are connected to or integrated with side gutter beams 102 and end gutter beams 103. In an example embodiment, ejecting tunnels 105 are connected to or integrated with corner posts 137. In an example embodiment, gutter-beam-securing bars 106 are slidably inserted into gutter-beam-securing-bar receivers 143 and screwed to corner posts 137. In an example embodiment, reversible spacers 107 are configured to slide screws 108. In an example embodiment, screws 108 are inserted through reversible spacers 107 and into coupling posts 135, corner posts 137, and/or center posts 139.

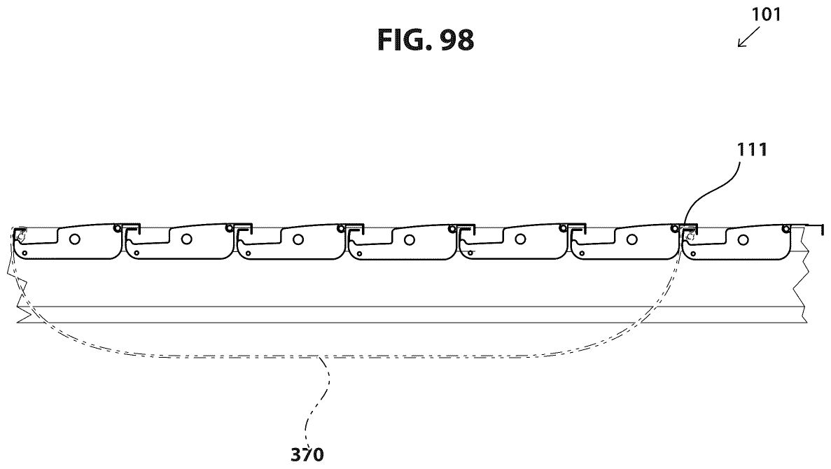

In some embodiments, the louver-slat system(s) 109 is (or, are, respectively) connected by the combined connections of its components. In an example embodiment, louver slats 110 are secured between two louver-slat end caps 114. In an example embodiment, leading edges 111 are connected to or integrated with louver slats 110. In some embodiments, and as best illustrated in FIG. 98, the leading edges 111 are connected to a canopy 370. Specifically, the canopy 370 can be secured to multiple leading edges 111. In an example embodiment, insulation strips 112 are secured to leading edges 111. In an example embodiment, trailing edges 113 are connected to or integrated with louver slats 110. In an example embodiment, louver-slat end caps 114 are secured to louver slats 110. In an example embodiment, louver-slat-supporting insertion axels 115 are inserted into louver slats 110. In an example embodiment, receiving holes 116 are formed into louver-slat-rotation closed cradles 120. In an example embodiment, louver-slat-rotation cradle axels 117 are rotatably attached between louver-slat-rotation open cradles 118 and louver-slat-rotation-cradle caps 119. In an example embodiment, louver-slat-rotation open cradles 118 are secured to side gutter beams 102. In an example embodiment, louver-slat-rotation-cradle caps 119 are secured to louver-slat-rotation open cradles 118. In an example embodiment, louver-slat-rotation closed cradles 120 are secured to side gutter beams 102.

In some embodiments, the control system(s) 121 is (or, are, respectively) connected by the combined connections of its components. Multi-louver-slat-control axels 122 are secured to louver slats 110 and rotatably inserted into insertion holes 126. In an example embodiment, multi-louver-slat-control-axel cotter-pins 123 are inserted into multi-louver-slat-control-axel cotter-pin holes 124. In an example embodiment, multi-louver-slat-control-axel cotter-pin holes 124 are drilled into multi-louver-slat-control axels 122.

In an example embodiment, multi-louver-slat-control bar 125 are connected to multi-louver-slat-control axels 122. In an example embodiment, multi-louver-slat-control-bar axel-insertion holes 126 are drilled into multi-louver-slat-control bar 125. In an example embodiment, the multi-louver-slat-control first linkage arm 127 is rotatably secured to louver slats 110. In an example embodiment, multi-louver-slat-control second linkage arm 128 are rotatably secured to multi-louver-slat-control first linkage arm 127. In an example embodiment, linkage-arm gear 129 is secured to multi-louver-slat-control second linkage arm 128. In an example embodiment, worm gear 130 is (secured to linkage-arm gear 129. In an example embodiment, worm-gear axel 131 is rotatably secured to worm gear 130. In an example embodiment, coupling ring 132 is secured to worm-gear axel 131. In an example embodiment, the crank tool 133 is removably hooked to coupling ring 132.

In some embodiments, the multi-angle-allowing post-and-base-leveling system(s) 134 is (or, are, respectively) connected by the combined connections of its components. In an example embodiment, the coupling posts 135 are secured to side gutter beams 102. In an example embodiment, T-shaped coupling-post caps 136 are secured to coupling posts 135. In an example embodiment, corner posts 137 are secured to side gutter beams 102 and end gutter beams 103. In an example embodiment, L-shaped corner-post caps 138 are secured to corner posts 137. In an example embodiment, center posts 139 are secured between at least two side gutter beams 102, or at least two end gutter beams 103. In an example embodiment, center-post caps 140 are secured to center posts 139. In an example embodiment, gutter-beam coupling caps 141 are secured between at least two side gutter beams 102, or at least two end gutter beams 103. In an example embodiment, gutter-beam cradles 142 support side gutter beams 102 or end gutter beams 103.

In an example embodiment, gutter-beam-securing-bar receivers 143 slidably surround multi-louver-slat-control bar 125. In an example embodiment, coupling-post base-plate covers 144 are slidably installed around coupling posts 135. In an example embodiment, coupling-post base-plates 145 are secured to coupling posts 135. In an example embodiment, center-and-corner-post base-plate covers 146 are slidably installed around corner posts 137 or center posts 139. In an example embodiment, corner-and-central-post base plates 147 are secured to corner post 137 or center post 139. In an example embodiment, discrete rainwater drains 148 are formed into corner post 137 or center post 139. In an example embodiment, sleeve screws 149 are threadedly inserted into coupling-post base-plates 145, corner post 137, or center post 139. In an example embodiment, screw holes 150 are drilled into coupling-post base-plates 145, corner post 137, or center post 139. In an example embodiment, anchoring-screw holes 151 are formed into sleeve screws 149. In an example embodiment, anchoring screws 152 are threadedly inserted into anchoring-screw holes 151.

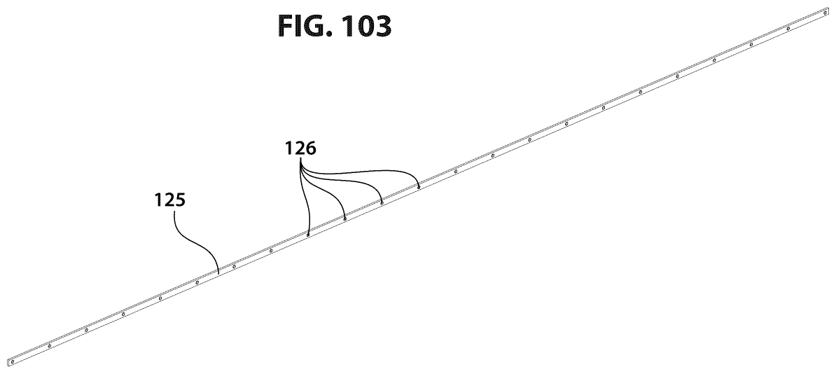

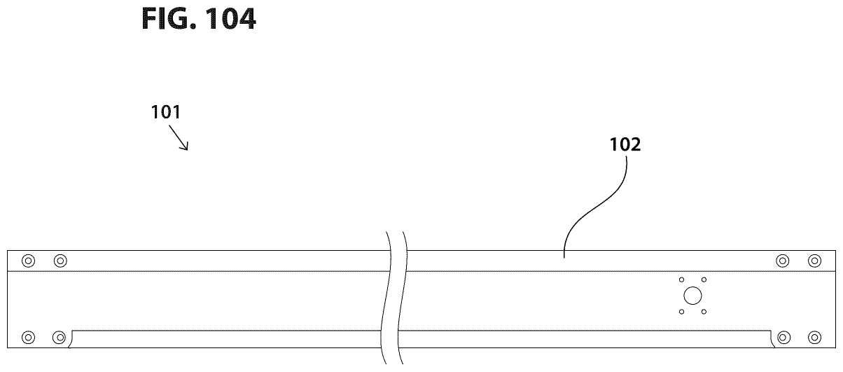

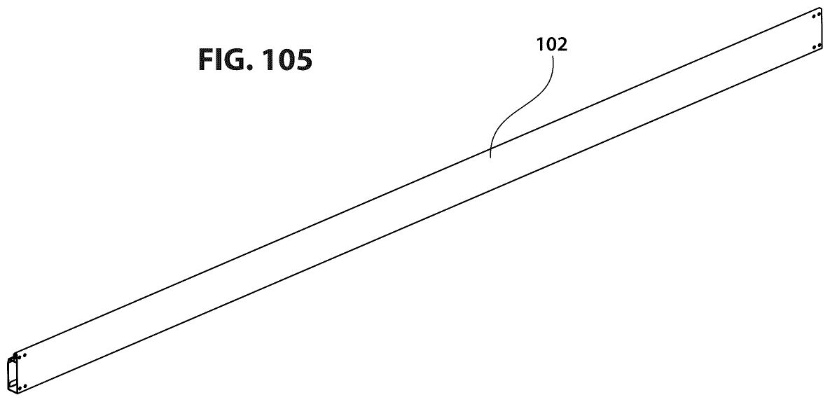

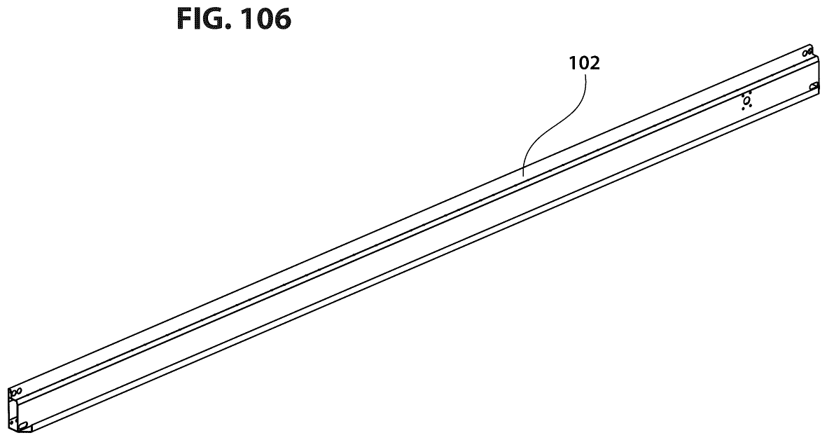

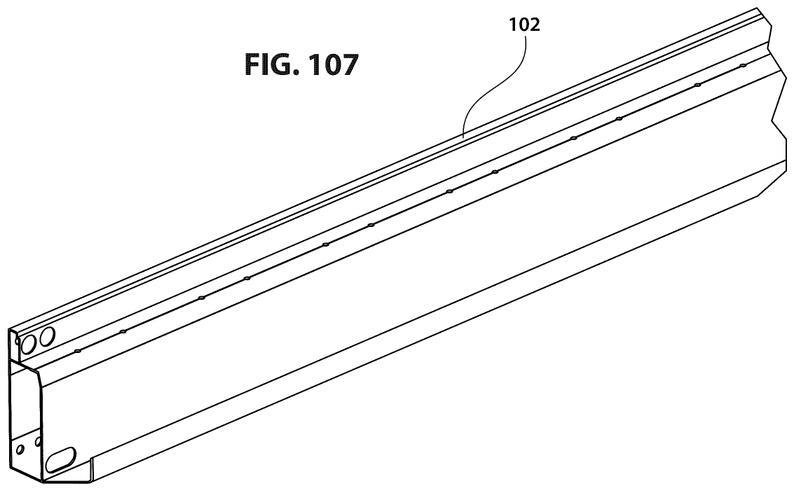

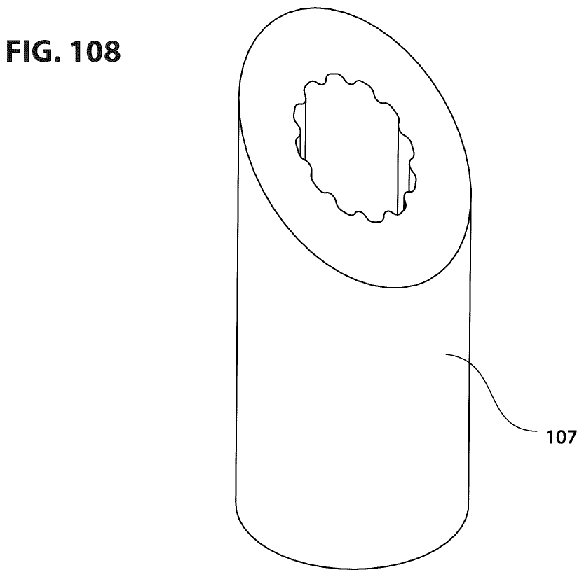

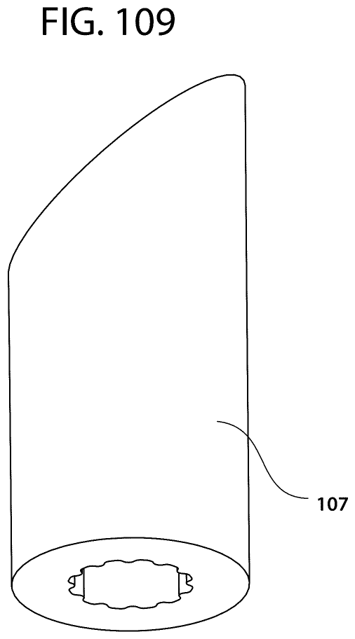

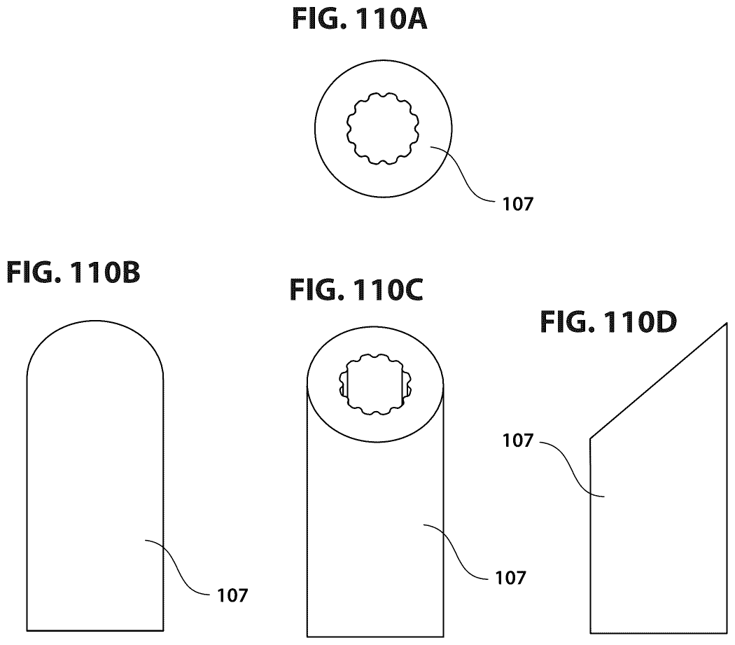

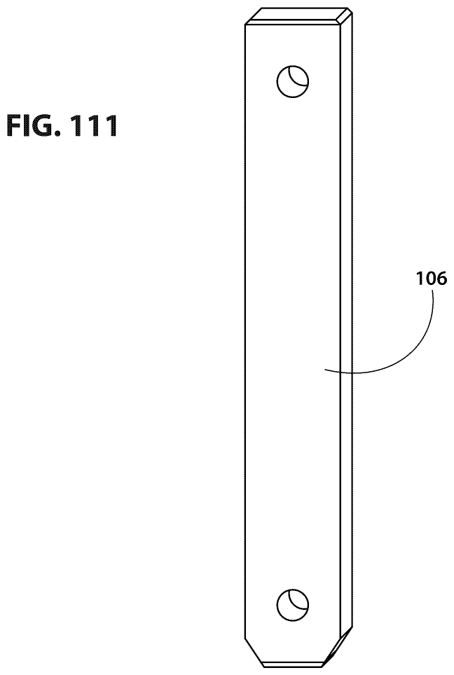

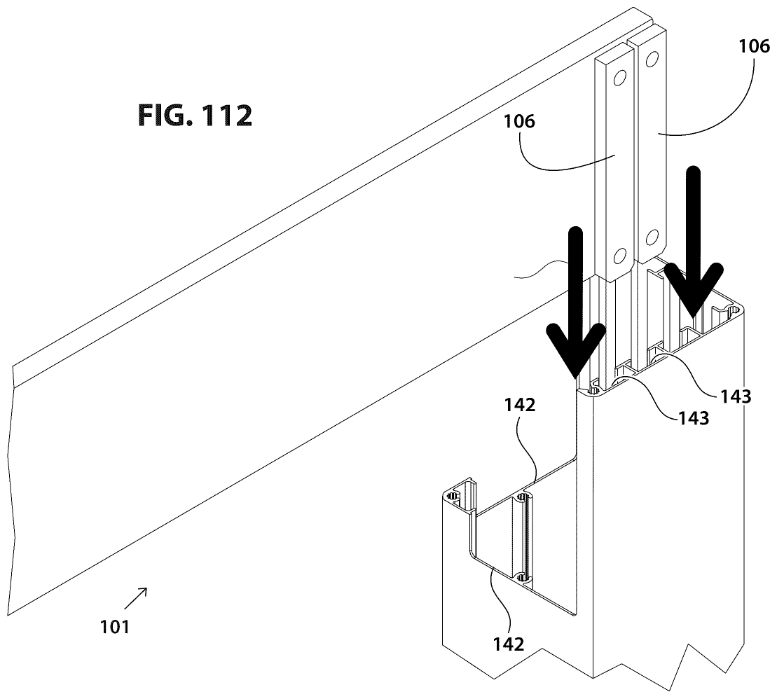

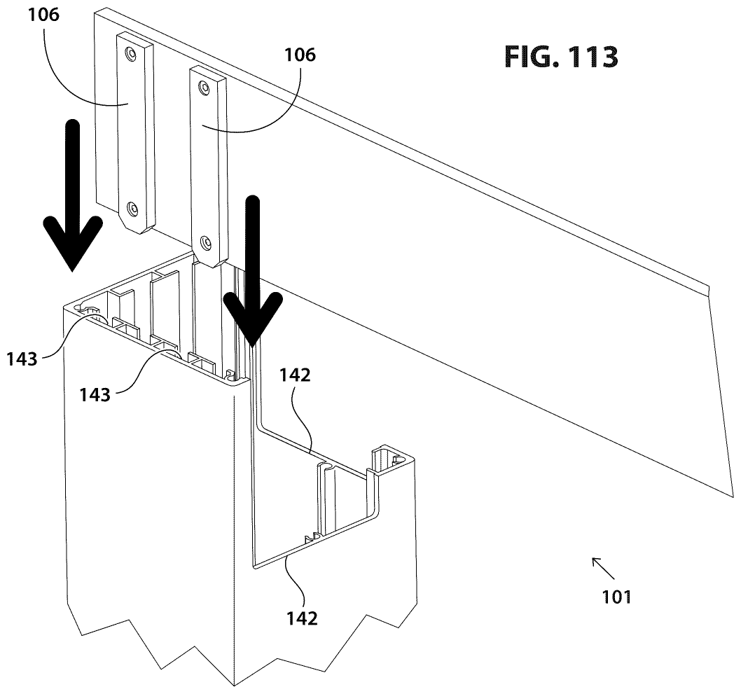

Referring to FIGS. 95-141, the gutter-beam system(s) 101 is (or, are, respectively) are configured to perform the combined functions of its components. In an example embodiment, side gutter beams 102 are configured to provide horizontal support for connecting gazebos 1, support for the gutters 104 in the directions or arrows 721a, 154a, and 154b (see FIGS. 115-118 louver-slat system(s) 109, and horizontal support between two corner posts 137. The side gutter beams 102 can be robotically assembled to save production time and costs. With reference to FIGS. 23-25, The side gutter beams 102 may be configured for providing robotically installed screws 108, in the directions of arrows 155a and 155b, automatically creating friction heat, cutting threads in the direction of arrows 155c, 155d, expanding screw-tip on impact, in the direction of arrows 155e, 155f, and 155g, to lock in place when thread-walls cool and contract.

In some embodiments, the end gutter beams 103 can be configured to provide horizontal support for connecting multiple gazebos 1, hide gutters 104 in the directions or arrows 721a, 154a, 154b (see FIGS. 115-118), support louver-slat system(s) 109, and provide horizontal support between two corner posts 137. The end gutter beams 103 may be robotically assembled to save production time and costs. The end gutter beams 103 may be configured for providing robotically installed screws 108, in the directions of arrows 155a and 155b, automatically creating friction heat, cutting threads in the direction of arrows 155c, 155d, expanding screw-tip on impact, in the direction of arrows 155e, 155f, and 155g, to lock in place when thread-walls cool and contract (see FIGS. 23-25). In some embodiments, the gutters 104 may be configured to discretely direct louver slats 110 to ejecting tunnels 105. In some embodiments, the ejecting tunnels 105 may be configured to discreetly direct rainwater from gutters 104 to discreet rainwater drains 148. In some embodiments, gutter-beam-securing bars 106 may be configured to provide rigidity for securely connecting: side gutter beams 102 to coupling posts 135, side gutter beams 102 to corner posts 137, and/or side gutter beams 102 to center posts 139.

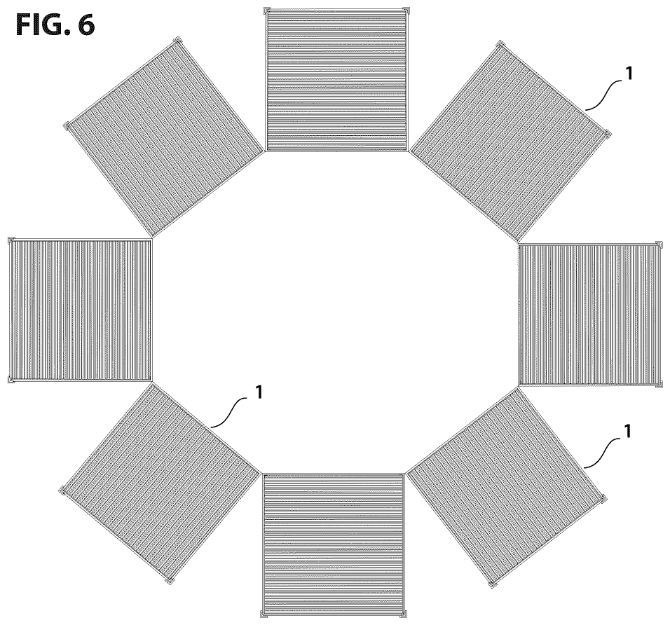

In some embodiments, the reversible spacers 107 may be configured to connect multiple gazebos at multiple angles (see FIGS. 1-12, 20, 119-124, and 125) and/or in a cluster formation (see FIGS. 6-12). In some embodiments, the screws 108 may be configured to secure reversible spacers 107 to gutter-beam-securing bars 106.

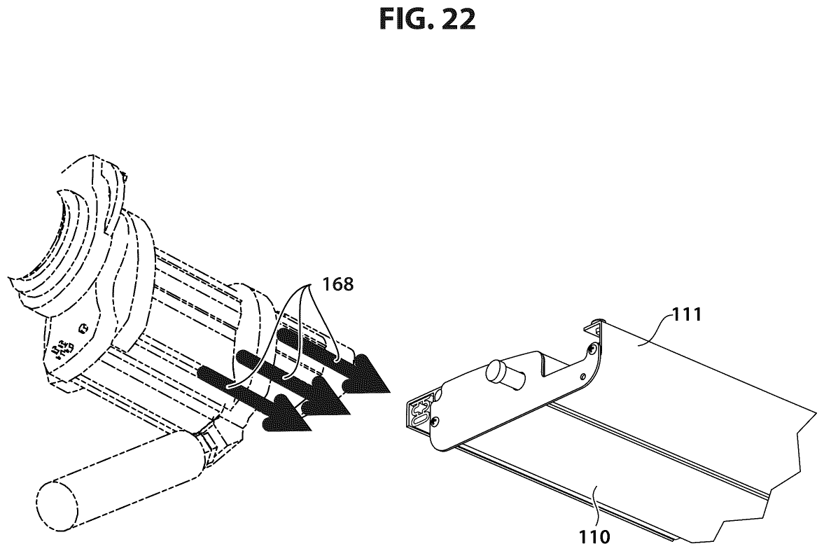

In some embodiments, the louver-slat system(s) 109 may be configured for performing the combined functions of its components. The louver slats 110 may be configured to direct and redirect the wind-flow in the directions of arrows 156a, 156b, 157, 158, 159a, and 159b (see FIGS. 26-31); direct rainwater flow to gutters 104 in the directions or arrows 721a, 154a, and 154b (see FIGS. 115-118); and, automatically deploy and retract the awning 160 by turning crank tool 133, in the directions of arrows 161 or 162, by pulling or relaxing cord 163 in the directions of arrows 164 or 165, or by deploying or retracting the awning 160 in the directions of arrows 166a and 166b (see FIGS. 13, 14, 17, 18, 19, and 90-92, 97, 99-102). In some embodiments, the louver slats 110 may be configured to deploy and retract projector screen 167a in the direction of arrow 167b (see FIGS. 16 and 96). In some embodiments, the louver slats 110 may be configured to hang projector screens 167a in the directions of arrows 167b (see FIGS. 16, and 96). The louver slats 110 can be robotically assembled to save production time and costs. In some embodiments, the louver slats 110 may be configured for providing robotically installed screws 108, in the directions of arrows 168 and 155b, automatically creating friction heat, cutting threads in the direction of arrows 155c, 155d, expanding screw-tip on impact, in the direction of arrows 155e, 155f, and 155g, to lock in place when thread-walls cool and contract (see FIGS. 22, 24, and 25).

In some embodiments, the leading edges 111 may be configured to provide overlapping rainwater-protection, overlapping wind-protection, overlapping structure rigidity, and/or a house one or more insulation strips 112. In some embodiments, the insulation strips 112 may be configured to provide rainwater-preventing insulation, wind-protecting insulation, noise-cancellation, and/or damage-preventing cushion. According to an aspect of the embodiments, the trailing edges 113 may be configured to direct rainwater to gutters 104, provide underlapping rainwater-protection, provide underlapping wind-protection, and/or provide underlapping structure rigidity.

Further, in some embodiments, the louver-slat end caps 114 may be configured to provide protection from rainwater from entering the louver slats 110. Insertion axels 115 can be configured to allow louver slats 110 to be rotated. Louver-slat-rotation receiving holes 116 can be configured to provide hole(s) for which to the insertion axels 115.

In some exemplar embodiments, the louver-slat-rotation cradle axels 117 may be configured to provide a lockable axel for rotating the louver slats 110. In some exemplar embodiments, the louver-slat-rotation open cradles 118 may be configured to provide a locking cradle to insert louver-slat-rotation cradle axels 117. The louver-slat-rotation-cradle caps 119 may be configured to secure louver-slat-rotation cradle axels 117 within louver-slat-rotation open cradles 118. Further, the louver-slat-rotation closed cradles 120 may be configured to house louver-slat-rotation receiving holes 116.

In some embodiments, the control system(s) 121 may be configured to perform the combined functions of its components. An example embodiment of the multi-louver-slat-control axels 122 may be configured to connect each louver slat 110 to the multi-louver-slat-control bar 125. Further, the multi-louver-slat-control-axel cotter-pins 123 may be configured to secure each multi-louver-slat-control axel 122 to the multi-louver-slat-control bar 125.

According to another aspect of the embodiments, the multi-louver-slat-control-axel cotter-pin holes 124 may be configured to lock multi-louver-slat-control-axel cotter-pins 123 to each multi-louver-slat-control axels 122. In some embodiments, the multi-louver-slat-control bar 125 may be configured to control the louver slats 110 for simultaneous opening and closing in the direction of arrows 161, 162, 169a, 169b, 169c, 169d, 169e, 169f, 170a, 170b, 170c, 170d, 170e, and 170f (see FIGS. 87, 88, and 90-94). Further, the multi-louver-slat-control bar 125 may be configured to allow the louver slats 110 to be simultaneously closed to protect from weather in the direction of arrows 161, 162, 169a, 169b, 169c, 169d, 169e, 169f, 170a, 170b, 170c, 170d, 170e, and 170f (see FIGS. 87-94). The multi-louver-slat-control bar 125 may be configured to allow the louver slats 110 to be simultaneously opened and closed to direct and redirect wind in the direction of arrows 161, 162, 169a, 169b, 169c, 169d, 169e, 169f, 170a, 170b, 170c, 170d, 170e, and 170f (see FIGS. 87-94). The multi-louver-slat-control bar 125 may be configured to allow the louver slats 110 to be simultaneously opened and closed to deploy and retract an awning 160 in the directions of arrows 166a and 166b (see FIGS. 13, 14, 18, 19, and 99-102).

In some embodiments, the insertion holes 126 may be configured to receive multiple multi-louver-slat-control axels 122. Further, the multi-louver-slat-control first linkage arm 127 may be configured to hingeably connect the louver slats 110 to the multi-louver-slat-control second linkage arm 128. In some embodiments, the multi-louver-slat-control second linkage arm 128 may be configured to hingeably connect linkage-arm gear 129 to the multi-louver-slat-control first linkage arm 127. The linkage-arm gear 129 may be configured to rotatably connect the worm gear 130 to the multi-louver-slat-control second linkage arm 128. The worm gear 130 may be configured to rotatably connect the worm-gear axel 131 to the linkage-arm gear 129. In some embodiments, the worm-gear axel 131 may be configured to rotatably connect the coupling ring 132 to the worm gear 130. Further, the coupling ring 132 may be configured to rotatably provide a location for the crank tool 133 to be hooked and rotated. According to an aspect of the embodiments, the crank tool 133 may be configured to rotatably deploy and retract the louver-slat system(s) 109.

In some embodiments, the multi-angle-allowing post-and-base-leveling system(s) 134 may be configured to perform the combined functions of its components. An example embodiment of the coupling posts 135 may be configured to connect multiple gazebos 1 at multiple angles (see FIGS. 1-12, 20, and 119-124, and 125), in a straight line orientation (see FIGS. 4-12, 20, and 122-124, and 133), in perpendicular configurations (see FIGS. 4, 6-12, and 122), or in a cluster formation (see FIGS. 6-12).

An example embodiment of the T-shaped coupling-post caps 136 may be configured to protect the coupling posts 135 from rainwater or insects from entering the interior of the gazebo 1. An example embodiment of the corner posts 137 may be configured to connect two or more side gutter beams 102 or end gutter beams 103 at, e.g., a ninety-degree angle. Further, an example embodiment of the L-shaped corner-post caps 138 may be configured to protect the side gutter beams 102 from rainwater or insects from entering the interior of the gazebo 1. An example embodiment of the center posts 139 may be configured to provide central support when one or more side gutter beams 102 or one or more end gutter beams 103 are connected. An example embodiment of the center-post caps 140 may be configured to protect center posts 139 from rainwater or insects from entering the interior of the gazebo 1.

In some embodiments, the gutter-beam coupling caps 141 may be configured to provide a seal for rainwater when two or more gazebos are connected. Further, the gutter beam coupling caps 141 may be configured to connect two or more side gutter beams 102 or two or more end gutter beams. An example embodiment of the gutter-beam cradles 142 may be configured to horizontally support the side gutter beams 102 and end gutter beams 103. An example embodiment of the gutter-beam-securing-bar receivers 143 may be configured to provide a secure location for gutter-beam-securing bars 106 to be installed. According to an aspect of the embodiments, the coupling-post base-plate covers 144 may be configured to provide a slidable protective covering for coupling-post base-plates 145 and a slidable covering for the rainwater drains 148. An example embodiment of the coupling-post base-plates 145 may be configured to provide a secure base for attaching the gazebo 1 to a ground surface.

According to another aspect of the embodiments, the center-and-corner-post base-plate covers 146 may be configured to provide a slidable protective covering for the corner-and-central-post base plates 147. In some exemplar embodiments, the corner-and-central-post base plates 147 may be configured to provide a secure base for attaching corner post 137 or center post 139. An example embodiment for the rainwater drains 148 may be configured to drain rainwater from the gazebo. The sleeve screws 149 may be configured to level the gazebo when the gazebo is on an uneven surface in, e.g., the directions of arrows 171a, 171b, 171c, and 171d (see FIGS. 139-141) or a slanted surface in, e.g., the directions of arrows 171a, 171b, 171c, and 171d (see FIGS. 139-141). Further, the sleeve screws 149 can be configured to provide a means to interactively level the gazebo once the gazebo is deployed in, e.g., the directions of arrows 171a, 171b, 171c, and 171d (see FIGS. 139-141). The sleeve screws 149 can be configured to allow leveling of each individual post for maximum control in, e.g., the directions of arrows 171a, 171b, 171c, and 171d (see FIGS. 139-141).

In some embodiments, the sleeve-screw holes 150 can provide a hole for the sleeve screws 149 to be installed and adjusted. Further, anchoring-screw holes 151 may be configured to provide a hole for anchoring screws 152 to be installed and adjusted. The anchoring screws 152 may be configured to secure the sleeve screws 149 so as to lock level-adjustment in place.

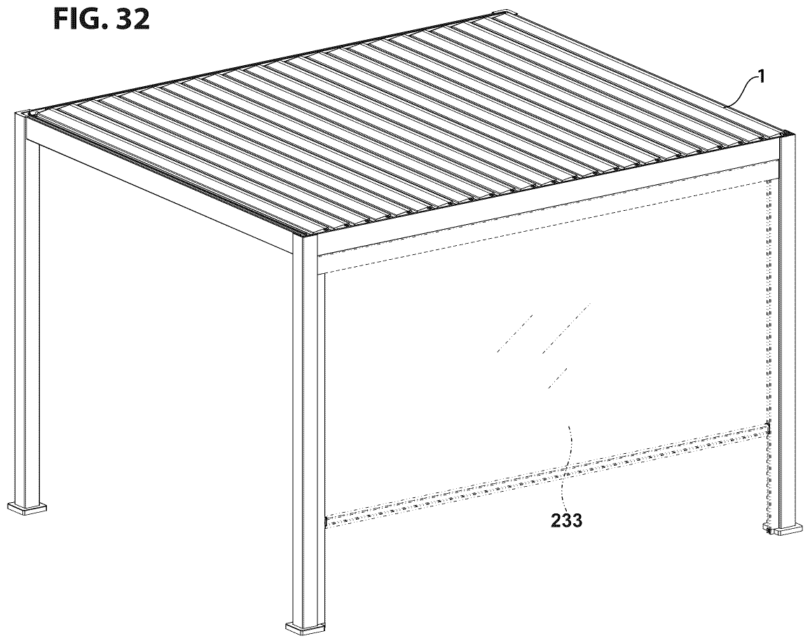

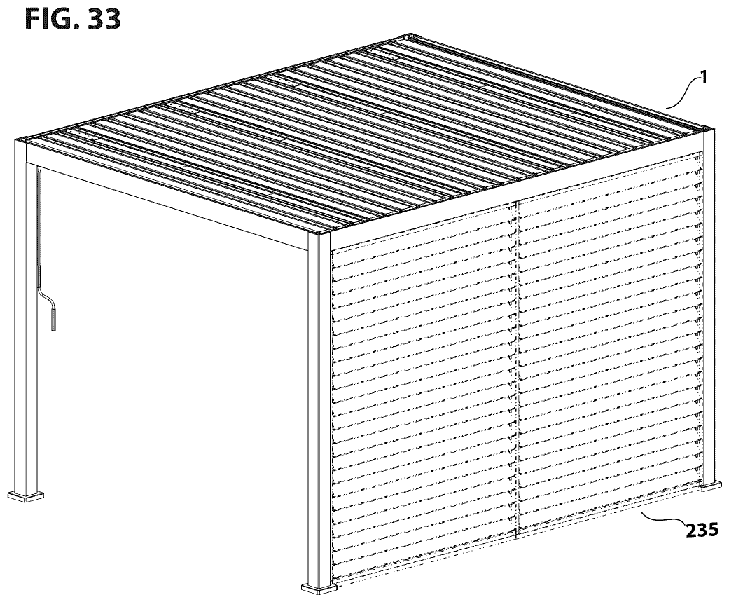

In some embodiments, and as shown in FIG. 32, a door 233 can be installed on the gazebo 1. The door 233 can be configured to be slidable and/or retractable. In some embodiments, a wall 235 (FIG. 33) can be installed on the gazebo. The wall 235 can be a louvered wall 235.

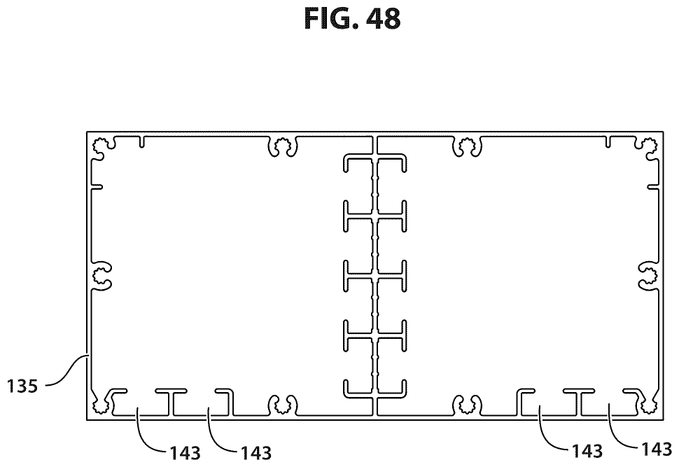

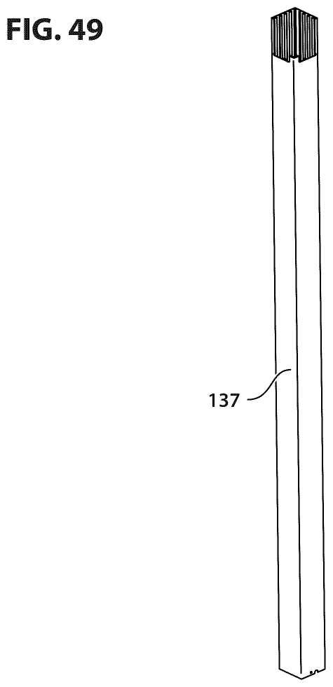

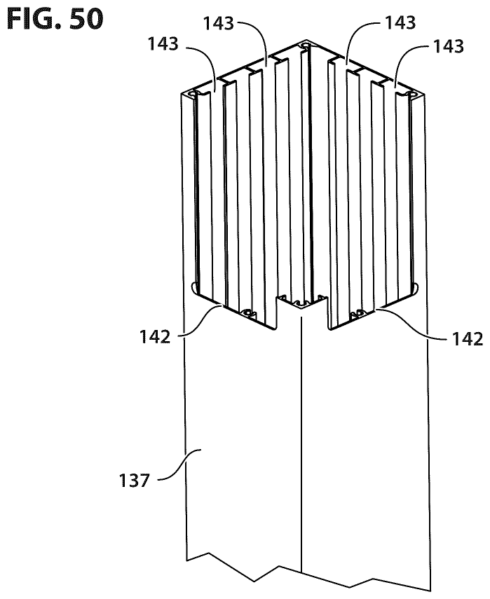

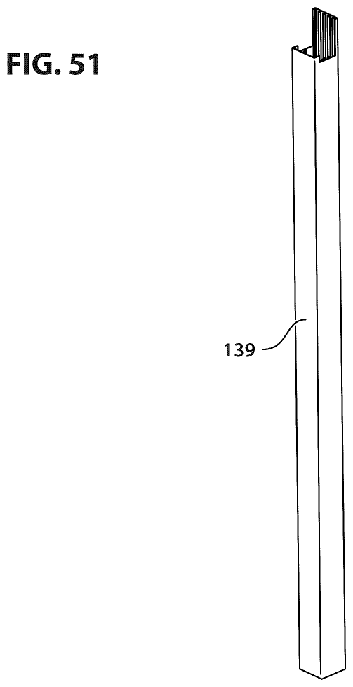

With reference to FIGS. 33, 33, 48, 52, and 142A-149B, the gazebo 1 and any components thereof can have any shape and size. Further, the gazebo 1 and any of its components can be made of any material(s).

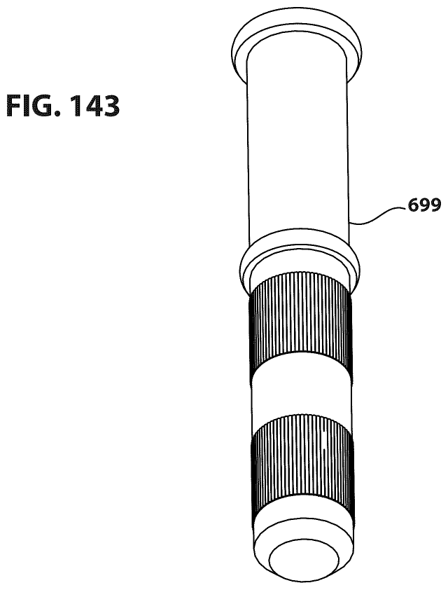

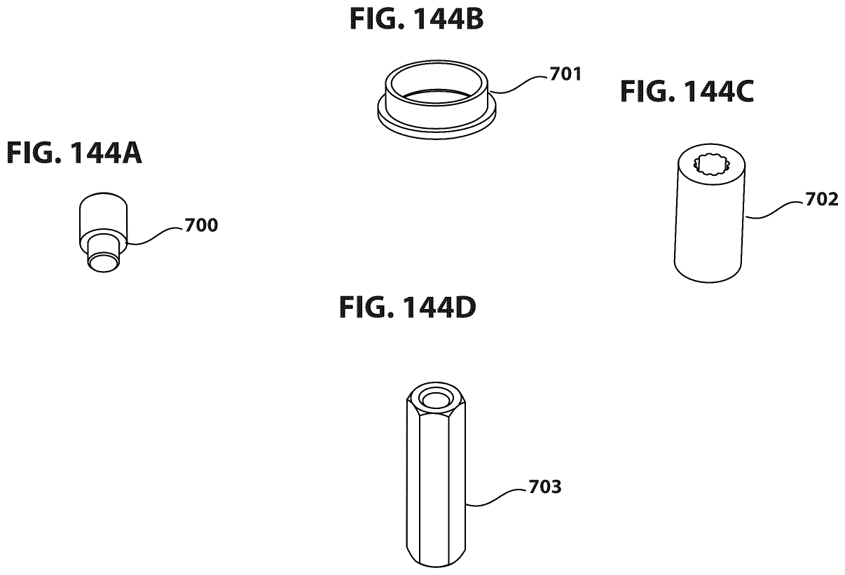

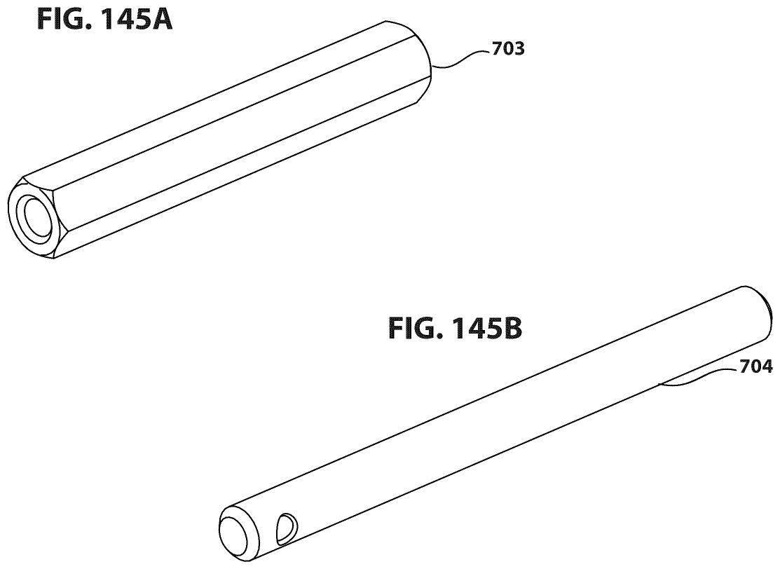

FIGS. 143, 144A-145B, 147A-147C, 148A, and 148B, are perspective views of components which can be utilized to assembly the gazebo 1 or components thereof. Specifically, FIG. 143 is a louver mounting shaft 699 that can be utilized with the louver-slat system 109. FIG. 144A depicts a positioning pin 700. FIG. 144B depicts a spacer ring 701. In some embodiments, the spacer ring 701 is made of plastic. FIG. 144C depicts a press-fit spacer 702. In some embodiments the press-fit spacer 702 is metallic. FIG. 144D depicts a threaded spacer 703. In some embodiments, and as shown in FIG. 144D, the threaded spacer 703 is hexagonal in shape. FIG. 145A depicts an exemplar embodiment of a threaded spacer 703. In this embodiment, the threaded spacer 703 is also hexagonal in shape.

FIG. 145B illustrates a gearbox activation rod 704. The gearbox activation rod 704 can be used with the cranking mechanism assembly 300 (see, e.g., FIGS. 34, 35, 42, and 43) so as to open and/or close the louver slats 110.

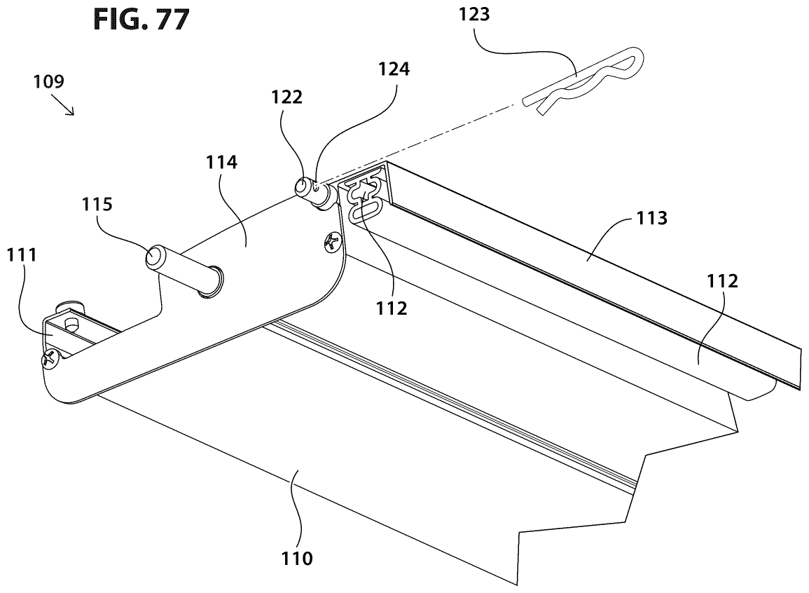

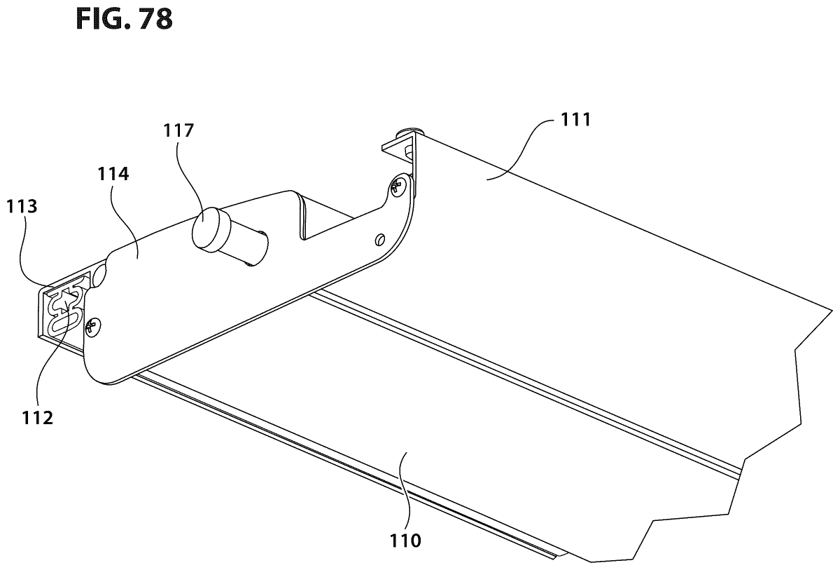

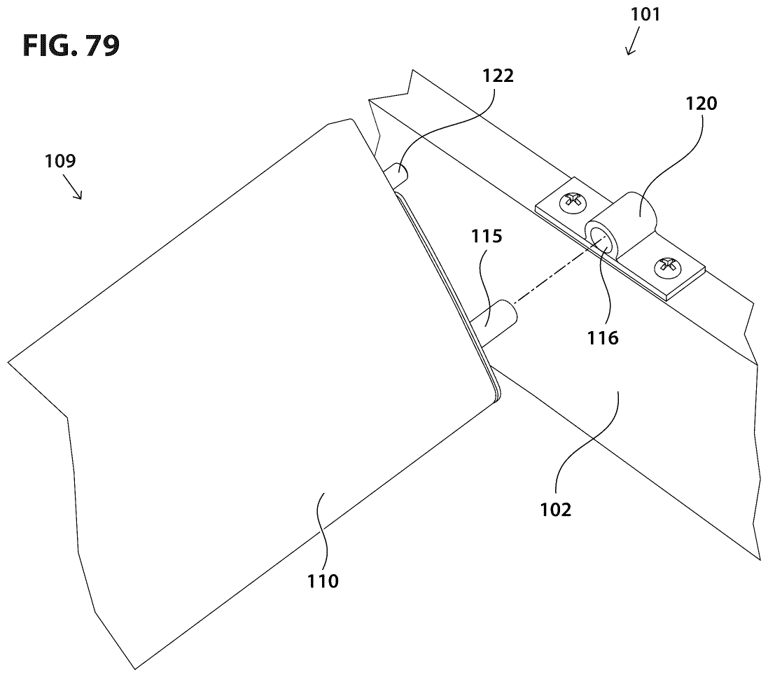

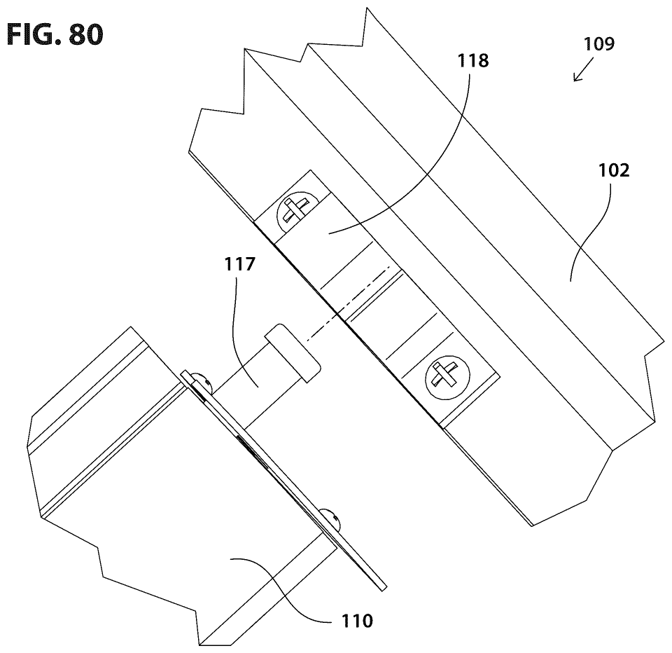

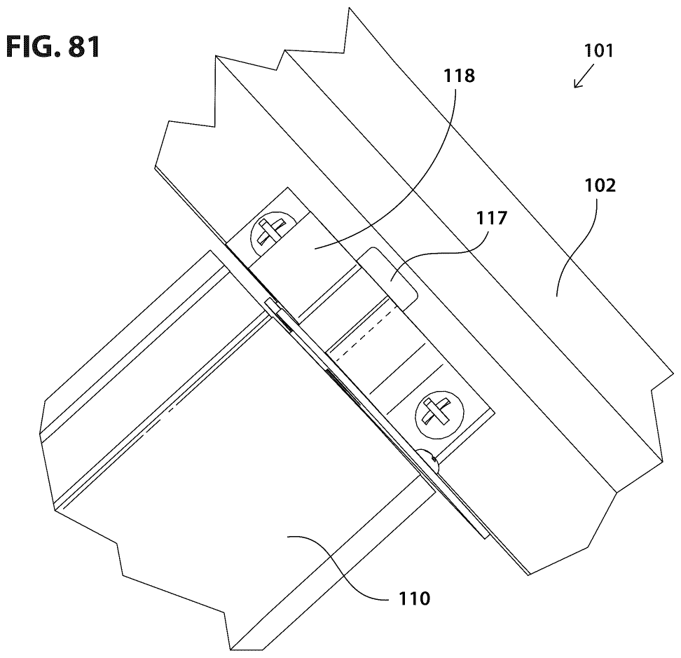

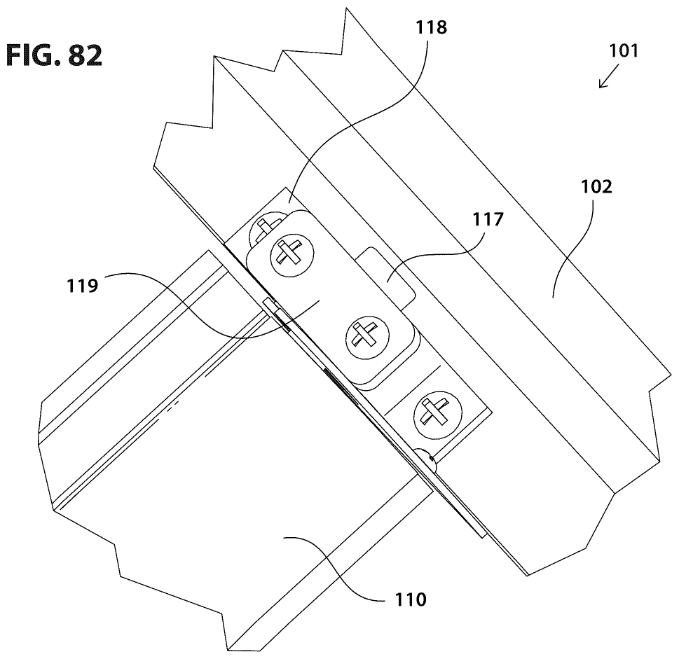

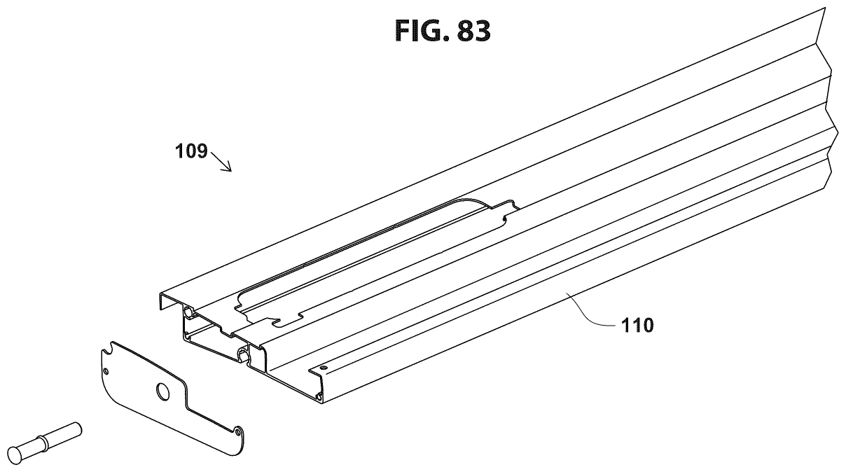

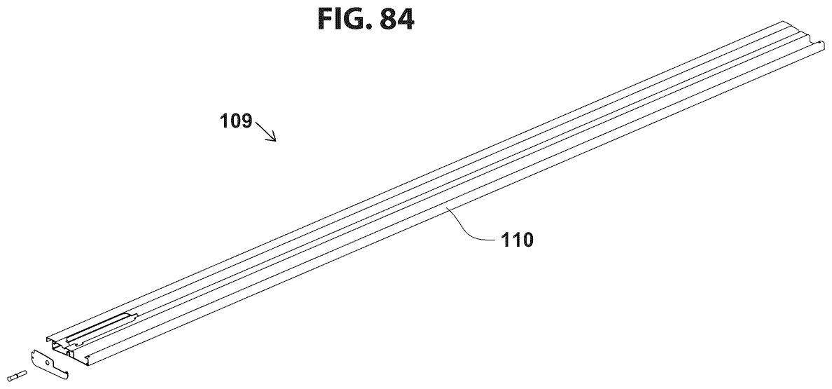

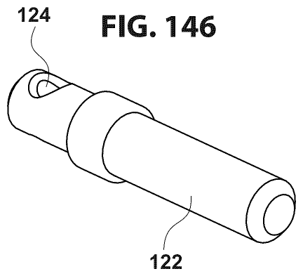

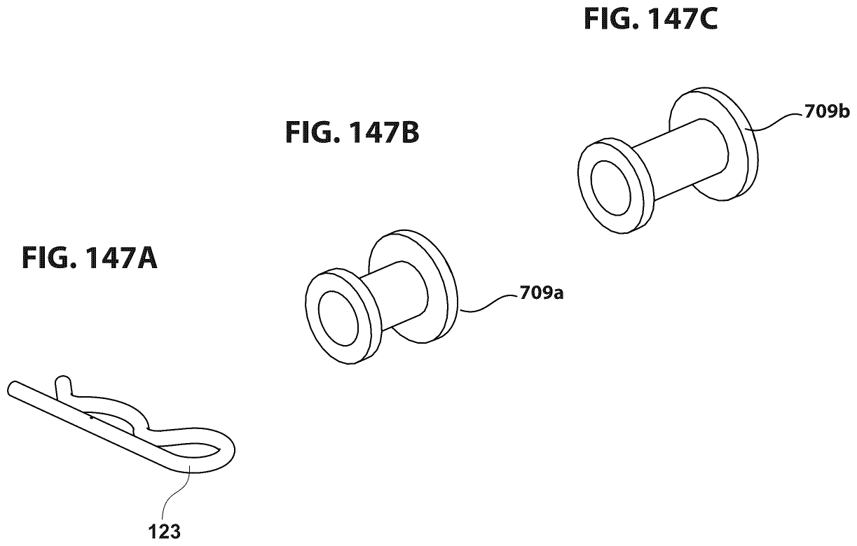

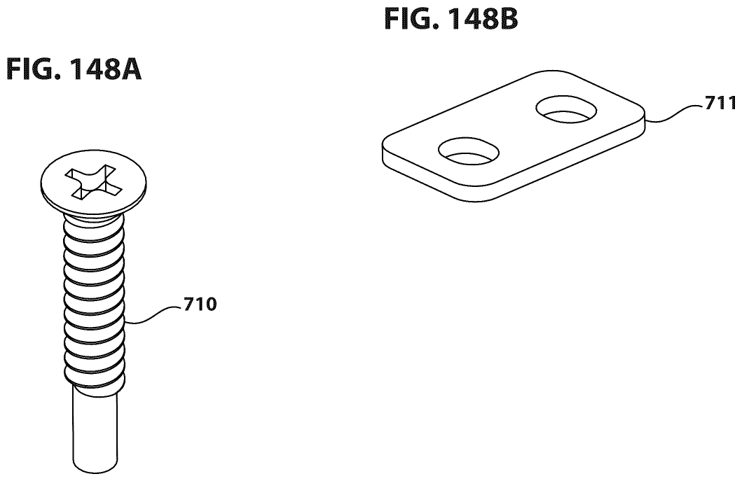

FIG. 146 depicts the multi-louver-slat control axel 122 comprising a cotter-pin hole, which was shown assembled onto the louver-slat system 109 in FIG. 77. FIG. 147A depicts a cotter-pin 123 that can be installed into a cotter-pin hole 124 (as shown in, e.g., FIGS. 77 and 146). FIGS. 147B-147C depict exemplar embodiments of rivets 709a, 709b, respectively, that can be utilized with the louver-slat system 109. FIGS. 148A and 148B depict exemplar embodiments of a self-positioning fastener 710 and a spacer plate washer 711, respectively, that can be utilized in the assembly of the gazebo 1 and/or components thereof.

One or more elements or aspects or steps, or any portion(s) thereof, from one or more of any of the systems and methods described herein may be combined with one or more elements or aspects or steps, or any portion(s) thereof, from one or more of any of the other systems and methods described herein and combinations thereof, to form one or more additional implementations and/or claims of the present disclosure.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A gazebo system, comprising:
a first gazebo;
a gutter beam system configured to direct wind-flow, channel rainwater, and drain rainwater, the gutter beam system comprising one or more side gutter beams and one or more end gutter beams, wherein the one or more side gutter beams and one or more end gutter beams are configured to provide horizontal support for connecting the first gazebo to a second gazebo; and
a louver-slat system configured to seal the gazebo from rainwater, wherein the louver-slat system comprises a plurality of louver slats configured to transition between an open configuration and closed configuration;
wherein the gazebo system is configured to be robot-assembled.

2. The gazebo system of claim 1, further comprising an awning, wherein the louver-slat system is configured to deploy and retract the awning.

3. The gazebo system of claim 2, wherein the awning is configured to deploy in an automatic fashion, and wherein the awning is further configured to retract in an automatic fashion.

4. The gazebo system of claim 1, further comprising a post-leveling base system, wherein a height of the gazebo is configured to be adjusted by the post-leveling base system, and wherein an angle of the gazebo is configured to be adjusted by the post-leveling base system.

5. The gazebo system of claim 1, further comprising one or more projector screens configured to deploy and retract, wherein the plurality of louver slats are further configured to deploy and retract one or more projector screens.

6. The gazebo system of claim 5, wherein each of the one or more projector screens is configured to raise and lower in an automatic fashion.

7. The gazebo system of claim 1, wherein the gazebo system is configured for use in all seasons.

8. The gazebo system of claim 1, further comprising a plurality of reversible spacers configured to adjust an angle of the one or more side gutter beams and an angle of the one or more end gutter beams so as to allow the first gazebo and the second gazebo to connect at multiple angles.

9. The gazebo system of claim 1, further comprising a third gazebo and a fourth gazebo, wherein the first gazebo, the second gazebo, the third gazebo, and the fourth gazebo are each connected to one another in a straight-line fashion.

10. The gazebo system of claim 1, further comprising a third gazebo and a fourth gazebo, wherein the first gazebo, the second gazebo, the third gazebo, and the fourth gazebo are each connected to one another in a perpendicular configuration.

11. The gazebo system of claim 1, further comprising a third gazebo and a fourth gazebo, wherein the first gazebo, the second gazebo, the third gazebo, and the fourth gazebo are each connected to one another in a cluster formation.

12. The gazebo system of claim 1, further comprising one or more coupling posts, wherein each of the one or more coupling posts is configured to connect two or more gazebos in multiple configurations.

13. The gazebo system of claim 1, further comprising a canopy connected to the gazebo system.

14. The gazebo system of claim 1, further comprising a control bar configured to control each of the plurality of louver slats, wherein the control bar is further configured to allow each of the plurality of louver slats to transition between the open configuration and the closed configuration.

15. The gazebo system of claim 1, wherein the louver-slat system further comprises one or more batteries, wherein the one or more batteries are disposed within a battery compartment housing, wherein the battery compartment housing is housed within a reservoir in one of the plurality of louver slats.

16. The gazebo system of claim 1, further comprising a control system and an awning configured to transition between a deployed configuration and a retracted configuration, wherein the control system comprises a crank tool, wherein the crank tool is configured to transition the awning between the deployed configuration and the retracted configuration.

17. The gazebo system of claim 1, wherein each of the plurality of louver slats comprises a leading edge, wherein the leading edge is configured to provide rainwater protection, wind-protection, and structural rigidity for the gazebo system.

18. The gazebo system of claim 17, wherein the leading edge comprises an insulation strip configured to provide insulation from rainwater, wind, and noise.

19. The gazebo system of claim 1, wherein the louver-slat system further comprises a solar panel, wherein the solar panel is installed adjacent to one or more batteries housed on one of the plurality of louver slats.
